(19) United States
(12) Patent Application Publication
(10) Pub. No.: US 2026/0204692 A1
(43) Pub. Date: Jul. 16, 2026

(54) VEHICLE INTERIOR DEVICE

(71) Applicant: TS TECH CO., LTD., Asaka-shi (JP)

(72) Inventors: Jinichi TANABE, Tochigi (JP); Takayoshi ITO, Tochigi (JP)

(21) Appl. No.: 19/563,585

(22) Filed: Mar. 11, 2026

Related U.S. Application Data
(63) Continuation of application No. 18/692,579, filed on Sep. 16, 2022.
(60) Provisional application No. 63/245,234, filed on Sep. 17, 2021.
(60) Provisional application No. 63/245,237, filed on Sep. 17, 2021.
(60) Provisional application No. 63/261,879, filed on Sep. 30, 2021.

(30) Foreign Application Priority Data
Sep. 29, 2021 (JP) 2021-159072
Sep. 30, 2021 (JP) 2021-160597
Mar. 10, 2022 (JP) 2022-036854
Mar. 16, 2022 (JP) 2022-041156
Mar. 28, 2022 (JP) 2022-051003
Mar. 28, 2022 (JP) 2022-051005

(51) Int. Cl. H01M 14/00; B60N 2/90; H02N 11/00

(52) U.S. Cl. CPC H01M 14/00; B60N 2/90; H02N 11/002

(57) ABSTRACT

A vehicle interior device that is provided inside a vehicle includes a humidity power generation element that generates electric power via changes in humidity. In prior-art power generation schemes, it has been easy to cause restrictions on the installation location and versatility has been low, but the humidity power generation element does not have any restrictions on the installation location as long as there are humidity changes, and has high versatility. In addition, changes in humidity occur spontaneously and have no other uses, and energy can therefore be saved by effectively utilizing unnecessary energy. Humidity increases and decreases as passengers enter and exit the vehicle; therefore, the humidity power generation element can efficiently generate power in particular.

### CROSS-REFERENCE TO RELATED APPLICATIONS

This application is a continuation of U.S. patent application Ser. No. 18/692,579, filed on Mar. 15, 2024, which is the U.S. National Stage entry of International Application No. PCT/JP2022/034676, filed on Sep. 16, 2022, which, in turn, claims priority to U.S. Provisional Patent Application No. 63/245,234, filed on Sep. 17, 2021; U.S. Provisional Patent Application No. 63/245,237, filed on Sep. 17, 2021; Japanese Patent Application No. 2021-159072, filed on Sep. 29, 2021; Japanese Patent Application No. 2021-160597, filed on Sep. 30, 2021; U.S. Provisional Patent Application No. 63/261,879, filed on Sep. 30, 2021; Japanese Patent Application No. 2022-036854, filed on Mar. 10, 2022; Japanese Patent Application No. 2022-041156, filed on Mar. 16, 2022; Japanese Patent Application No. 2022-051003, filed on Mar. 28, 2022; and Japanese Patent Application No. 2022-051005, filed on Mar. 28, 2022, all of which are hereby incorporated herein by reference in their entireties for all purposes.

### TECHNICAL FIELD

The present invention relates to a vehicle interior device.

### BACKGROUND ART

A power generation device that includes thermoelectric conversion elements constituting Peltier elements woven into coverings of seats of a vehicle, and generates power using the temperature difference, has been proposed (for example, see Patent Document 1).

### CITATION LIST

### Patent Literature

Patent Document 1: JP 2017-50958A

### SUMMARY OF INVENTION

### Technical Problem

Unfortunately, the conventional art described above has the structure where the thermoelectric conversion elements are woven into the coverings of the seats of the vehicle. Accordingly, there is a problem that application locations in the vehicle are limited, and the versatility is low.

The present invention has been made in view of the situations described above, and is to improve the versatility of the vehicle interior device.

### Solution to Problem

To solve the problem described above, the invention according to aspect 1 is a vehicle interior device, including
a hygroelectric generation element that is provided in a vehicle, and generates electric power through humidity variation.

The invention as recited in aspect 2 is the vehicle interior device according to aspect 1,
wherein the hygroelectric generation element is provided at a position where humidity variation occurs depending on presence or absence of an occupant.

The invention as recited in aspect 3 is the vehicle interior device according to aspect 2,
wherein the hygroelectric generation element is provided at a position communicating with a surface with which the occupant is in contact.

The invention as recited in aspect 4 is the vehicle interior device according to aspect 2 or 3,
wherein the hygroelectric generation element is provided in a seat for the occupant.

The invention as recited in aspect 5 is the vehicle interior device according to any one of aspects 1 to 4,
wherein the hygroelectric generation element includes:
an open cell that is atmospherically opened; a closed cell that is sealed; an ion-exchange membrane that partitions the open cell and the closed cell from each other; a deliquescent inorganic salt aqueous solution residing in the open cell and the closed cell; and electrodes respectively stored in the open cell and the closed cell, and generates electric power through moisture absorption and emission to and from the open cell.

The invention as recited in aspect 6 is the vehicle interior device according to any one of aspects 1 to 5,
wherein the hygroelectric generation element supplies electric power to an electric component provided in the vehicle.

The invention as recited in aspect 7 is the vehicle interior device according to aspect 6, further including
a first battery that is charged by the hygroelectric generation element,
wherein the electric component is supplied with electric power by the first battery.

The invention as recited in aspect 8 is the vehicle interior device according to aspect 7, further including
another power generation element that generates electric power from energy other than power of humidity,
wherein the first battery is charged also by the other power generation element.

The invention as recited in aspect 9 is the vehicle interior device according to any one of aspects 1 to 8, further including:
another power generation element that generates electric power from energy other than power of humidity; and
a first cooperative controller that performs cooperative control of causing the other power generation element to make up for a shortage of electric power supplied by the hygroelectric generation element.

The invention as recited in aspect 10 is the vehicle interior device according to aspect 7 or 8, further including
a second cooperative controller that performs cooperative control of causing a second battery to make up for a shortage of electric power supplied by the first battery, the second battery being configured to supply electric power to each component of the vehicle.

### Advantageous Effects of Invention

The invention according to aspect 1 includes the hygroelectric generation element that generates electric power through humidity variation. Consequently, the vehicle interior device that can be installed in a flexible manner, and has high versatility can be provided.

The invention according to aspect 2 allows the hygroelectric generation element to efficiently generate power in accordance with humidity variation due to presence or absence of an occupant.

The invention according to aspect 3 is provided with the hygroelectric generation element at the position communicating with the surface with which an occupant is in contact, thereby allowing more efficient power generation.

The invention according to aspect 4 enables the hygroelectric generation element provided in the seat to efficiently generate power through more significant humidity variation.

The invention according to aspect 5 uses ion movement based on variation in concentration of the deliquescent inorganic salt aqueous solution due to the ambient humidity. Consequently, favorable power generation with a larger current value can be achieved.

The invention according to aspect 6 allows the hygroelectric generation element to supply power to the electric component provided in the vehicle, which can facilitate easily securing power supply to the electric component, and negating the wiring.

The invention according to aspect 7 accumulates electric power obtained by power generation, in the first battery. Consequently, generated electric power can be highly efficiently used.

The invention according to aspect 8 allows the first battery to be charged also by the other power generation element. Consequently, much electric power can be secured.

The invention according to aspect 9 includes the first cooperative controller that performs cooperative control of causing the other power generation element to make up for a shortage of electric power supplied by the hygroelectric generation element. Consequently, more stable operation of the electric component can be achieved.

The invention according to aspect 10 allows the second battery to make up for the shortage of electric power supplied by the first battery. Consequently, more stable operation of the electric component can be secured.

### BRIEF DESCRIPTION OF DRAWINGS

FIG. 1 This is a block diagram showing a schematic configuration of a vehicle interior device.

FIG. 2 This is a schematic sectional view of a hygroelectric generation element.

FIG. 3 This is a perspective view of a seat.

FIG. 4 This is a perspective view of a door.

FIG. 5 This is a perspective view around the seat as a driver seat in a vehicle cabin.

FIG. 6 This is a sectional view of the inside of the seat in a case where the hygroelectric generation element is installed at each of various positions in the seat.

FIG. 7 This is a sectional view of the inside of the seat in a case where the hygroelectric generation element is installed at each of various positions in the seat.

FIG. 8 This is a sectional view of the inside of the seat in a case where the hygroelectric generation element is installed at each of various positions in the seat.

FIG. 9 This is a sectional view of the inside of the seat in a case where the hygroelectric generation element is installed at each of various positions in the seat.

FIG. 10 This is a block diagram showing a schematic configuration of a seat state adjustment system.

FIG. 11 This is a diagram showing an overview of the seat state adjustment system provided for a wheeled vehicle.

FIG. 12 This is an overview of a seat provided with seating sensors and a range sensor.

FIG. 13 This is a block diagram showing a schematic configuration of a seat adjustment mechanism, sensors and the like.

FIG. 14 This is a flowchart showing an example of control of adjusting a state of the seat.

FIG. 15 This is a block diagram showing a schematic configuration of a seat state adjustment system provided with a trigger input receiver.

FIG. 16 This is a time chart showing an example of seat control upon input of a trigger input.

FIG. 17 This is a block diagram showing a schematic configuration of a seat state adjustment system provided with an automatic restorer.

FIG. 18 This is a block diagram showing a schematic configuration of an occupant awakening system of a first embodiment among embodiments about an occupant awakening system.

FIG. 19 This is a diagram showing an overview of a seat provided with a seat awakener.

FIG. 20 This is a diagram showing an overview of an interior member provided with an interior awakener.

FIG. 21 This is a flowchart showing a flow of a driver monitoring process of the first embodiment among embodiments about the occupant awakening system.

FIG. 22 This is a flowchart showing a flow of a driver monitoring process of a modified example of the first embodiment among embodiments about the occupant awakening system.

FIG. 23 This is a block diagram showing a schematic configuration of an occupant awakening system of a second embodiment among embodiments about the occupant awakening system.

FIG. 24 This is a diagram showing an overview of a seat provided with a biometric sensor device.

FIG. 25 This is a flowchart showing a flow of a driver monitoring process of the second embodiment among embodiments about the occupant awakening system.

FIG. 26 This is a block diagram showing a schematic configuration of an occupant awakening system of a third embodiment among embodiments about the occupant awakening system.

FIG. 27 This is a flowchart showing a flow of a driver monitoring process of the third embodiment among embodiments about the occupant awakening system.

FIG. 28 This is a block diagram showing a schematic configuration of an occupant awakening system of a fourth embodiment among embodiments about the occupant awakening system.

FIG. 29 This is a flowchart showing a flow of a driver monitoring process of the fourth embodiment among embodiments about the occupant awakening system.

FIG. 30 This is a block diagram showing a schematic configuration of a seat transformation system.

FIG. 31 This is a diagram showing an overview of the seat transformation system provided for the wheeled vehicle.

FIG. 32 This is a diagram showing an overview of a seat provided with proximity sensors and pressure sensors.

FIG. 33 This is a block diagram showing a schematic configuration of a seat transformation mechanism, sensors and the like.

FIG. 34A This is a diagram showing an example of an overview of the proximity sensor and the pressure sensor.

FIG. 34B This is a diagram showing an example of an overview of the proximity sensor and the pressure sensor.

FIG. 34C This is a diagram showing an example of an overview of the proximity sensor and the pressure sensor.

FIG. 34D This is a diagram showing an example of an overview of the proximity sensor and the pressure sensor.

FIG. 35 This is a flowchart showing a flow of a seat transformation process.

FIG. 36 This is a diagram showing an overview of long rails of Modified Example 1.

FIG. 37 This is a block diagram showing a schematic configuration of a seat transformation mechanism, sensors and the like of Modified Example 1.

FIG. 38 This is a block diagram showing a schematic configuration of a seat transformation mechanism, sensors and the like of Modified Example 2.

FIG. 39 This is a block diagram showing a schematic configuration of a vehicle interior device.

FIG. 40 This is a schematic sectional view of the hygroelectric generation element.

FIG. 41 This is a perspective view of a seat.

FIG. 42 This is an exploded perspective view of part of a configuration of a seat cushion viewed from diagonally above.

FIG. 43 This is an exploded perspective view of part of the configuration of the seat cushion viewed from diagonally below.

FIG. 44 This is a sectional view showing part of a groove of a pad taken along frontward/rearward and upward/downward directions, with a seat occupant being seated.

FIG. 45 This is a sectional view showing part of the groove of the pad taken along the frontward/rearward and upward/downward directions, with the seat occupant being away.

FIG. 46 This is a block diagram showing a schematic configuration of a vehicle interior device.

FIG. 47 This is a schematic sectional view of the hygroelectric generation element.

FIG. 48 This is a perspective view of a vehicle interior material viewed from the outside of the vehicle cabin.

FIG. 49 This is an exploded perspective view of an upper rear part of the vehicle interior material.

FIG. 50 This is a perspective view of the upper rear part of the vehicle interior material with the components shown in the exploded manner in FIG. 49 being integrally assembled.

### DESCRIPTION OF EMBODIMENTS

### (1) Embodiment (1) about Vehicle Interior Device

Hereinafter, referring to the drawings, Embodiment (1) about the vehicle interior device is described. Although various limitations technically preferable to implement the present invention are imposed on embodiments described below, the technical scope of the present invention is not limited to the following embodiments and illustrated examples.

The following embodiments of the invention are vehicle interior devices that supply electric power through hygroelectric generation elements generating power by humidity variation, and allow various electric components to operate, and can be installed at various positions in the vehicle.

Vehicles to which the following vehicle interior devices are applied include any vehicles, such as vessels, aircraft, and wheeled vehicles, which travel with people being aboard. With the present embodiment, examples of applying a vehicle interior device 1 to a wheeled vehicle, in particular, an automobile are described.

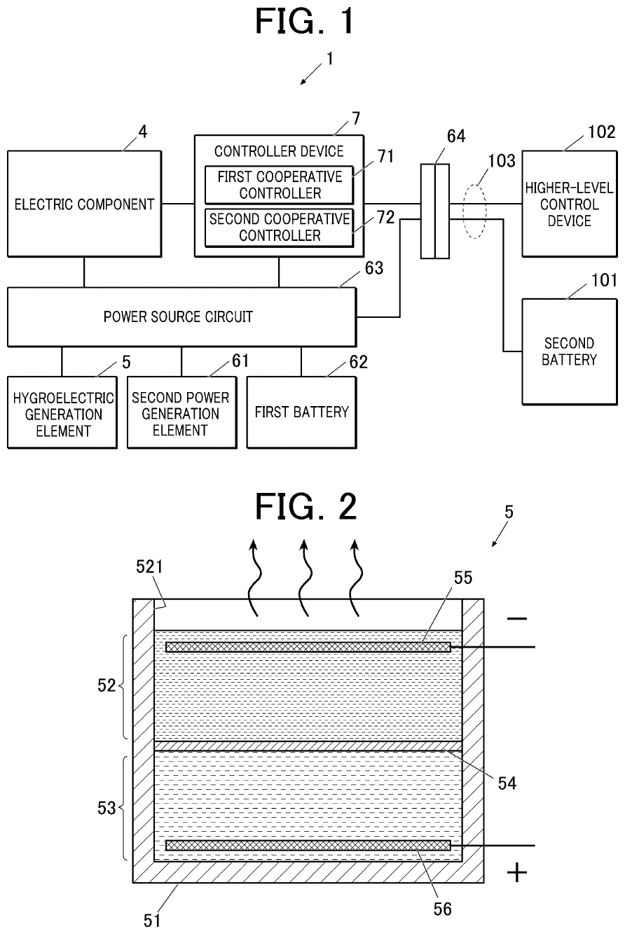

FIG. 1 is a block diagram showing a schematic configuration of the vehicle interior device 1. As shown in FIG. 1, the vehicle interior device 1 includes an electric component 4 used mainly in a vehicle, a hygroelectric generation element 5 that generates power through humidity variation, a second power generation element 61 that generates power using energy other than that of humidity, a first battery 62 that is charged through power generation by the hygroelectric generation element 5 and the second power generation element 61, a power source circuit 63 that controls power supply to the electric component 4, a controller device 7 that controls each component of the vehicle interior device 1, and a connector 64 that connects a harness 103.

The vehicle interior device 1 is connected, via the harness 103, to a second battery 101 (a vehicle-mounted battery of an automobile) that is an external component, and a higher-level control device 102 (e.g., an ECU: electronic control unit etc., that is an overall control device of the automobile) that performs main control of each component of the automobile.

Note that the vehicle interior device 1 may have a configuration that obtains power from a plurality of hygroelectric generation elements 5 or a configuration that supplies power to a plurality of electric components 4, or both of them.

### (Hygroelectric Generation Element)

The hygroelectric generation element 5 is not specifically limited only if it generates power through humidity variation. However, in view of performances of the generated current amount and the power generation efficiency, it is preferable to use a humidity variation battery that includes a combination of a deliquescent material and salinity gradient power generation, and has been developed by National Institute of Advanced Industrial Science and Technology. The humidity variation battery is described in detail in https://www.aist.go.jp/aist_j/press release/pr2021/pr20210602/pr20210602.html.

FIG. 2 is a schematic sectional view of the hygroelectric generation element 5 made up of the humidity variation battery. As shown in the diagram, the hygroelectric generation element 5 includes a main body container 51 that includes an open cell 52 open to the outside at an opening 521, and a closed cell 53 sealed to the outside. The open cell 52 and the closed cell 53 are partitioned from each other by an ion-exchange membrane 54.

The open cell 52 and the closed cell 53 are filled with an electrolyte containing water and a lithium salt having deliquescence, as a deliquescent inorganic salt aqueous solution. Electrodes 55 and 56 are arranged respectively in the open cell 52 and the closed cell 53.

According to the configuration described above, when the hygroelectric generation element 5 is exposed to a low-humidity environment, moisture is evaporated from the open cell 52, and the concentration increases while the concentration in the closed cell 53 is not changed because the closed cell 53 is sealed. Accordingly, the concentration in the open cell 52 becomes higher than that in the closed cell 53, and ion movement occurs through the ion-exchange membrane 54, thus causing a voltage between the electrodes 55 and 56.

When the hygroelectric generation element 5 is exposed to a high-humidity environment, the aqueous solution in the open cell 52 absorbs moisture in the air because of the deliquescence of the lithium salt, and the concentration decreases. Accordingly, the concentration in the open cell 52 becomes lower than that in the closed cell 53, and ion movement occurs in a direction opposite the aforementioned direction through the ion-exchange membrane 54, thus causing an opposite polarity voltage.

The state of occurrence of the voltage due to ambient humidity variation continues for a certain time period. Accordingly, by arranging the hygroelectric generation element 5 in an environment other than that at a place where the humidity is always kept constant, preferably, in an environment where the humidity can change in a day, power can be generated both through increase in humidity and decrease in humidity.

Note that the opening 521 of the open cell 52 may be covered with a polymer membrane or a hollow fiber membrane that is permeable to water vapor but impermeable to liquid, in order to prevent the electrolyte from leaking.

### (Hygroelectric Generation Element Installation Example (1): Seat)

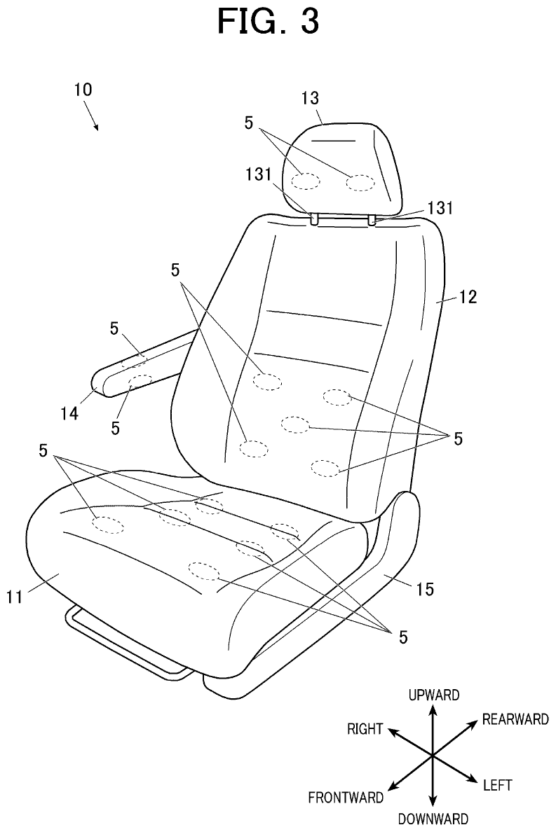

A preferable installation example of the hygroelectric generation element 5 is described. FIG. 3 is a perspective view of a seat 10. As shown in FIG. 3, the seat 10 includes: a seat cushion 11 that supports the buttocks and thighs of a person; a seat back 12 that is supported at its lower end by the seat cushion 11, and serves as a backrest; a headrest 13 that is provided at an upper end of the seat back 12, and supports the head of the person; and an armrest 14 provided at a side end of the seat back 12.

The seat cushion 11 mainly includes: a seat cushion frame serving as a framework; a cushion pad provided on the seat cushion frame; and a covering that covers the seat cushion frame and the cushion pad. At right and left ends of the seat cushion 11, bulges exaggerated to improve the capability of holding a seat occupant are respectively formed.

The seat back 12 mainly includes: a seat back frame serving as a framework; a cushion pad provided on the seat back frame; and a covering that covers the seat back frame and the cushion pad. At right and left ends of the seat back 12, bulges exaggerated to improve the capability of holding a seat occupant are respectively formed.

The headrest 13 includes: head rest pillars 131 that protrude downward and are inserted in and supported by an upper end of the seat back 12; a cushion pad provided around upper ends of the head rest pillars 131; and a covering that covers the upper ends of the head rest pillars 131 and the cushion pad.

At a bottom of the seat 10, a base that includes a slide mechanism for sliding the seat cushion 11 in a frontward/rearward direction and is not shown is provided. On both the right and left sides of the base, side covers 15 made of resin are respectively provided (only left one is shown).

Preferably, in a case where the hygroelectric generation elements 5 are installed in the seat 10, installation locations are positions that are on a surface where an occupant seated in the seat 10 is in contact or in close contact, or communicate with the surface. For example, in a case of the headrest 13, the locations are around a front surface and in a range allowing the head of an occupant to be in contact. In a case of providing a plurality of hygroelectric generation elements 5, the elements may be arranged vertically or laterally. The hygroelectric generation element 5 may be arranged at the center of the front surface.

In a case in the seat back 12, the location is in a range which is around the front surface and with which the back to hips of an occupant are in contact. Likewise, in a case of providing a plurality of hygroelectric generation elements 5, the elements may be arranged vertically or laterally. The hygroelectric generation element 5 may be arranged at the center of the front surface.

In a case in the seat cushion 11, the location is in a range which is around the upper surface and with which the buttocks to thighs of an occupant are in contact. Likewise, in a case of providing a plurality of hygroelectric generation elements 5, the elements may be arranged in the front-rear or lateral direction. The hygroelectric generation element 5 may be arranged at the center of the upper surface.

In a case of the armrest 14, the location is in a range which is around its upper surface or lower surface and with which an arm or a hand is in contact.

At each of these installation locations, a humidity difference tends to occur between day and night or between a driving case (in use) and a parking case (not in use). The locations are expected to allow efficient power generation by the hygroelectric generation elements 5.

### (Hygroelectric Generation Element Installation Example (2): Door)

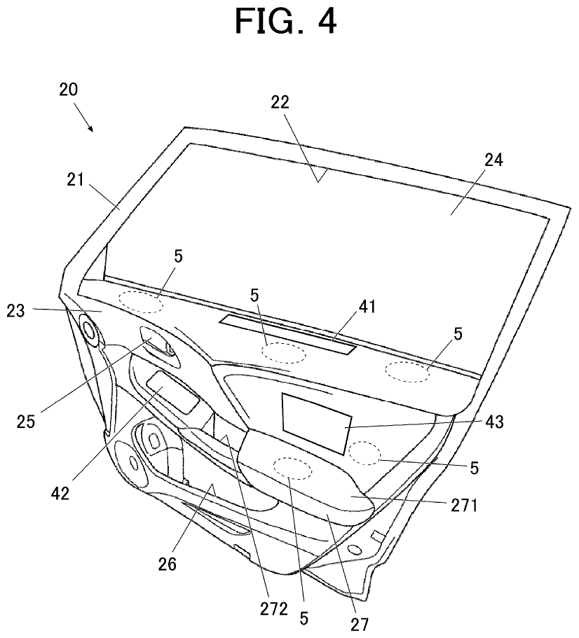

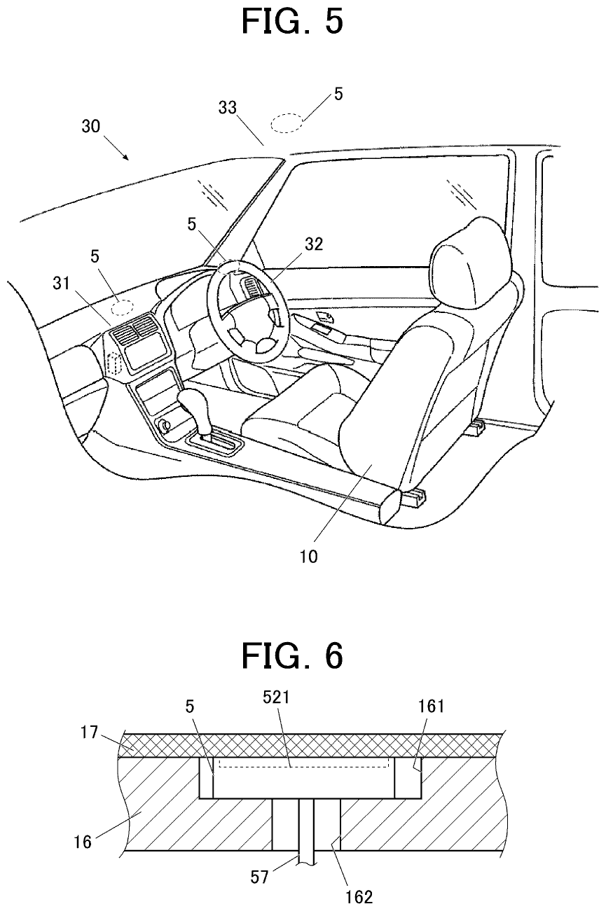

FIG. 4 is a perspective view of a door 20. The door 20 includes: a door panel in which a door skin, not shown, arranged outside of a vehicle cabin 30 (see FIG. 5), and a door inner panel 21 arranged in the vehicle cabin 30 are joined to each other and which is formed to have a closed sectional shape; a door lining 23 that is arranged below a window 22 open at the door panel, is fixed to the door inner panel 21 on the inner side in the vehicle cabin 30, and is made of, for example, a resin material; and a window glass 24 that opens and closes the window 22. The window glass 24 is raised and lowered by an electrical window regulator, not shown, and opens and closes the window 22.

On an upper surface of the door lining 23, a light 41 that is longitudinal in the frontward/rearward direction and serves as an electric component 4 is provided. On an upper front side of the door lining 23, a door lock unit 25 is arranged so as to face the inside of the vehicle cabin 30. At a lower part of the door lining 23, a door pocket 26 open upward is provided.

At an intermediate part of the door lining 23 in the upward/downward direction, an armrest 27 that extends in the frontward/rearward direction is provided. A rear end of the armrest 27 serves as an elbow rest 271 on which an elbow of an occupant (e.g., a driver) is mounted. At an intermediate part of the armrest 27 in the frontward/rearward direction, an armrest pocket 272 is provided.

At a front end of the armrest 27, a touch panel type switch 42 is provided as an electric component 4 through which various types of vehicle equipment are operated.

On the door lining 23 above the armrest 27, a display device 43 as an electric component 4 made up of a liquid crystal display is provided to face the inside of the vehicle cabin 30.

Preferably, in a case where the hygroelectric generation element 5 is installed in the door 20, the installation locations are positions likely to be exposed to an atmosphere in the vehicle cabin 30. Preferably, for example, the hygroelectric generation elements 5 are provided on the upper surface and side surface of the door lining 23, and the upper surface of the armrest 27.

Also at each of these installation locations, a humidity difference tends to occur between day and night or between the driving case and the parking case. The locations are expected to allow efficient power generation by the hygroelectric generation elements 5.

### (Hygroelectric Generation Element Installation Example (3): Each Part in Vehicle Cabin)

FIG. 5 is a perspective view around the seat 10 as a driver seat in a vehicle cabin 30.

Preferably, in a case where the hygroelectric generation elements 5 are installed in the vehicle cabin 30, the installation locations are positions likely to be exposed to an atmosphere and locations with which an occupant is in contact, in the vehicle cabin 30.

Preferably, for example, the upper surface and front surface of an instrument panel 31 in front of the driver seat in the vehicle cabin 30, an outer periphery of a steering wheel 32, a lower surface of a roof 33 and the like are installation locations for the hygroelectric generation elements 5.

Preferably, in the case where the hygroelectric generation elements 5 are provided in the steering wheel 32, the installation locations are away from those for an airbag and switches.

In a case where the roof 33 includes a roof window, the hygroelectric generation element 5 may be installed in the roof window.

Also at each of these installation locations, a humidity difference tends to occur between day and night or between the driving case and the parking case. The locations are expected to allow efficient power generation by the hygroelectric generation elements 5.

The hygroelectric generation elements 5 may be installed not only in the vehicle cabin 30 but also at all places where the humidity can vary in an automobile. For example, the hygroelectric generation elements 5 may be provided on an exhaust path of an engine. On the exhaust path of the engine, the humidity largely varies between the driving case and the parking case. Accordingly, the hygroelectric generation elements 5 can efficiently generate power.

### (Hygroelectric Generation Element Installation Structure)

Preferable installation structures of the hygroelectric generation elements 5 in FIGS. 3 to 5 are described. FIGS. 6 to 9 each show a sectional view of the inside of the seat 10 in a case where the hygroelectric generation element 5 is installed at each of various positions in the seat 10.

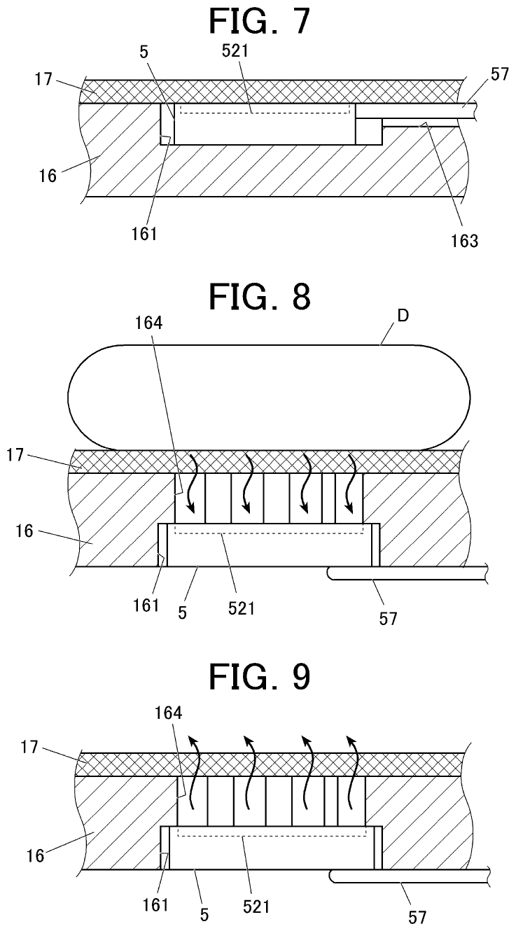

As to arrangement of the hygroelectric generation element 5 allowing communication with a surface with which an occupant is in contact, for example, as shown in FIGS. 6 and 7, the hygroelectric generation element 5 is stored in a concave 161 formed in a cushion pad 16 included in the seat cushion 11, the seat back 12, or the headrest 13 of the seat 10, in a state where the opening 521 faces outward, and the concave 161 and the hygroelectric generation element 5 are covered with a covering 17. The covering 17 is made of a fiber material having air permeability at least at a portion facing the opening 521, mesh, or a material having a structure with a large number of pores.

As shown in FIG. 6, a harness 57 for wiring extending from the hygroelectric generation element 5 to a main body side of the vehicle interior device 1 may pass through a through-hole 162 penetrating to the back surface of the cushion pad 16. Alternatively, as shown in FIG. 7, the harness 57 may pass through a groove 163 provided under the covering 17.

Also as to arrangement of an arrangement of the hygroelectric generation element 5 communicating with a surface with which an occupant is in contact, for example, as shown in FIGS. 8 and 9, the concave 161 may be formed on the back surface side of the cushion pad 16, a plurality of vent holes 164 penetrating from the concave 161 to the surface side (surface in contact with an occupant) may be provided, and the hygroelectric generation element 5 may be stored in the concave 161 so that the opening 521 can face each vent hole 164. In this case, the covering 17 is made of a fiber material having air permeability at least at a portion facing each vent hole 164, mesh, or a material having a structure with a large number of pores.

According to this construction, a difference in touch in a seated situation in the seat 10 between the installation location of the hygroelectric generation element 5 and another location hardly occurs, and favorable seating comfort can be maintained.

In this case, the harness 57 for wiring extending from the hygroelectric generation element 5 can be arranged from the opening 521 to the back surface side of the cushion pad 16.

As shown in FIG. 8, after an occupant D (see FIG. 8) gets in the automobile, moisture emitted from a human body infiltrates through the covering 17 and then through the opening 521 of the hygroelectric generation element 5, and the humidity in the open cell 52 increases. Accordingly, the potential of one electrode 55 increases, which generates power (this similarly applies to the cases in FIGS. 6 and 7).

As shown in FIG. 9, after the occupant D gets out of the automobile, moisture is evaporated through the covering 17, and the humidity of the open cell 52 decreases. Accordingly, the potential of the other electrode 55 increases, which generates power with polarity opposite to the aforementioned polarity (this similarly applies to the cases in FIGS. 6 and 7).

The installation structures shown in FIGS. 6 to 9 can apply to positions other than the seat cushion 11, the seat back 12, or the headrest 13 of the seat 10 with no cushion and no covering. In this case, instead of the cushion pad 16, a component material at the installation location is provided with a concave for storing the hygroelectric generation element 5, and an opening through which the hygroelectric generation element 5 is fitted, and the opening 521 of the hygroelectric generation element 5 is covered with a surface material or a covering material instead of the covering 17. Also in this case, the surface material or the covering material may be made of a fiber material having air permeability at least at a portion facing the opening 521, mesh, or a material having a structure with a large number of pores.

### (Electric Component)

The vehicle interior device 1 includes various devices that operate by electric power, as electric components 4. The configuration includes the electric components 4, which include not only the light 41, the switch 42, and the display device 43 described above, but also what operates at low power, such as a pressure sensor, a wireless communication device, an air blower, and a heater. Note that these are only examples of some of the electric components 4. Every power consuming device mountable on a vehicle can be assumed as a target.

The light 41 includes a light source, and a drive circuit therefor. Preferably, the power source is a light emitting device, or an LED.

The switch 42 is, for example, an input electric component that includes a touch panel type display. Icons of switches for performing input operations and the like for opening and closing windows, various setting of an air conditioner, slide mechanisms for seats in the automobile and the like are displayed on the display of the switch 42. Each icon functions as the corresponding switch through a touch operation. Note that the switch 42 is not limited to a touch panel type display, and may be configured as a switch panel that includes a plurality of analog switches.

The display device 43 displays various types of information. Preferably, this device operates at low power, such as a liquid crystal display.

The pressure sensor is a sensor for detecting that a person is seated in the seat 10, and includes a pressure-sensing element, or a microswitch. For example, this sensor is arranged in the seat cushion frame or therebelow.

The wireless communication device is a device for wirelessly communicating with an external control device, such as the higher-level control device 102. For example, the wireless communication device is provided along with another electric component, transmits an output of the other electric component to the external control device, or receives, from the external control device, a control command destined for the other control device, and transmitted information, and inputs them into the other electric component.

The air blower includes a motor, a fan, and a housing. When the motor rotates the fan, the air blower can blow air taken into the housing, in a predetermined direction, thus blowing cooling air to a person.

The heater includes heating wire or a heating element that is energized and generates heat, and can heat a neighboring region of a person by generating heat. A configuration may be adopted that includes an air blower in addition to a heat source, and blows warm air in a predetermined direction.

### (First Battery)

The first battery 62 accumulates electric power based on power generation by the hygroelectric generation elements 5 and the second power generation element 61, described later. Preferably, the first battery 62 is what is reusable, such as a secondary battery or a capacitor. The secondary battery may be a nickel-cadmium storage battery, a nickel-hydrogen storage battery, a lithium-ion secondary battery, a lithium-ion polymer secondary battery, a sodium-ion battery, etc.

### (Second Power Generation Element)

The second power generation element 61 cooperates with each hygroelectric generation element 5, and serves as a power supply source of the vehicle interior device 1. In a case where the hygroelectric generation elements 5 have a sufficient power supply capability for the electric components 4, the second power generation element 61 is not necessarily mounted on the vehicle interior device 1.

The second power generation element 61 is an element that is for effectively utilizing any type of surplus energy, and belongs to what is called energy harvesting technology. For example, any of power generation elements that can generate power using light energy, such as sunlight, generate power using thermal energy using exhaust heat, generate power using vibration energy, generate power using wind power, generate power using a temperature difference and the like is used as the second power generation element 61.

### (Power Source Circuit)

The power source circuit 63 includes circuits and the like that have a charging function of accumulating, in the first battery 62, electric power generated by power generation by the hygroelectric generation elements 5 and the second power generation element 61, a function of supplying power from the hygroelectric generation elements 5, the second power generation element 61, or the first battery 62 to the electric components 4, with the current and voltage being adjusted, and a function of supplying power from the external second battery 101 to the electric components 4.

Each function described above is achieved based on control by the controller device 7.

### (Controller Device)

The controller device 7 includes a central processing unit (CPU), a random access memory (RAM), and a read only memory (ROM), and can execute control and processes of each component of the vehicle interior device 1.

The controller device 7 mainly performs charging control that charges the first battery 62 from the hygroelectric generation elements 5 and the second power generation element 61 through the power source circuit 63, power supply control that supplies electric power to the electric components 4 from the hygroelectric generation elements 5, the second power generation element 61, or the first battery 62 through the power source circuit 63, and other control.

The controller device 7 includes a first cooperative controller 71, and a second cooperative controller 72, in relation to the control described above. These are functional components achieved by the controller device 7 executing a predetermined program. Alternatively, these may be configured as hardware, such as a circuit provided along with the controller device 7.

In principle, during power generation by the hygroelectric generation elements 5 or the second power generation element 61, the controller device 7 controls the power source circuit 63 so as to charge the first battery 62 with the power, and supply power from the first battery 62 to the electric components 4.

The controller device 7 then monitors the charged amount of the first battery 62, and controls the power source circuit 63 so as to directly supply power from the hygroelectric generation elements 5 and the second power generation element 61 to the electric components 4 in a full-charge case or a little-amount case where the remaining battery life is a predetermined amount or less.

As described above, in the case of direct power supply from the hygroelectric generation elements 5 and the second power generation element 61 to the electric components 4, the first cooperative controller 71 performs cooperative control by the power source circuit 63 so that the second power generation element 61 can make up for a shortage of power supply by the hygroelectric generation elements 5.

That is, the first cooperative controller 71 detects, through the power source circuit 63, the current or voltage to the electric components 4 in a case of power supply solely by the hygroelectric generation elements 5, and controls the power source circuit 63 so as to supply power also from the second power generation element 61 if the detected value is lower than a prescribed value.

As described above, the second cooperative controller 72 performs cooperative control by the power source circuit 63 so as to supplementarily supply shortage power from the external second battery 101 if the remaining battery life of the first battery 62 is a little and the power supply by the hygroelectric generation elements 5 and the second power generation element 61 is insufficient.

That is, the second cooperative controller 72 detects, through the power source circuit 63, the current or voltage to the electric components 4 in a case of power supply by the hygroelectric generation elements 5 and the second power generation element 61 due to a little remaining battery life of the first battery 62, and controls the power source circuit 63 so as to supply power also from the second battery 101 if the detected value is lower than a prescribed value.

### Technical Effects of Embodiments of Invention

As described above, the vehicle interior device 1 is provided in the automobile, and includes the hygroelectric generation elements 5 that generate power through humidity variation. Accordingly, energy conservation can be facilitated by the hygroelectric generation elements 5 covering energy consumption by the automobile-mounted electric components 4.

Furthermore, the hygroelectric generation elements 5 can generate power only if being exposed to an ambient atmosphere with varying humidity. Accordingly, the limitation on the installation locations and the installation structure is small, which can facilitate improvement in versatility.

The hygroelectric generation elements 5 of the vehicle interior device 1 are provided at positions, for example, in the vehicle cabin 30, where the humidity varies due to presence or absence of an occupant. Accordingly, increase in humidity caused by the occupant, and decrease in humidity after the occupant leaves can be utilized to generate power, and efficient power generation can be achieved.

In particular, in cases where the hygroelectric generation elements 5 are provided at positions communicating with the surface with which the occupant D is in contact as shown in FIGS. 6 to 9, the atmosphere with varying humidity due to the occupant D directly reaches the hygroelectric generation elements 5. Accordingly, efficient power generation can be achieved.

In the case where the hygroelectric generation elements 5 are provided in the seat 10, the elements can be arranged at positions closer to the occupant D, and increase in humidity caused by the occupant D, and decrease in humidity after the occupant D leaves more significantly occur. Accordingly, more efficient power generation can be achieved.

Each hygroelectric generation element 5 generates power based on ion movement due to the difference in concentration of the deliquescent inorganic salt aqueous solution in the open cell 52 and the closed cell 53 caused by ambient humidity variation. Accordingly, power generation with a more large current value can be achieved, the range of application of the electric components 4 to which power is supplied can be enlarged, and the vehicle interior device 1 having higher versatility can be provided.

According to the vehicle interior device 1, the hygroelectric generation elements 5 supplies power to the electric components 4 provided in the automobile. Consequently, in the case where various electric components 4 are provided in the automobile, the power source can be easily secured, and improvement in the layout flexibility of electric components 4 can be facilitated. Along with this, types of targeted devices supported by the electric components 4 can be widened.

The vehicle interior device 1 includes the first battery 62 charged by the hygroelectric generation elements 5, and supplies power to the electric component 4 from the first battery 62. Accordingly, power can be supplied even when no power is generated.

The power supply is not limited only to the case where power is consumed by operation of the electric components 4. During occurrence of humidity variation, stationary power generation and charging can be achieved, and the power generation efficiency can be further improved.

Even when power is not generated by the hygroelectric generation elements 5, power can be supplied from the first battery 62 to the electric components 4.

According to the vehicle interior device 1, the first battery 62 is charged also by the second power generation element 61. Consequently, the generated energy increases, and much electric power can be secured.

The vehicle interior device 1 includes the first cooperative controller 71 that performs cooperative control of causing the second power generation element 61 to make up for a shortage of electric power supplied by the hygroelectric generation elements 5. Accordingly, even when constant power cannot be stationarily supplied only by the hygroelectric generation elements 5, more stable operation of the electric components 4 can be secured.

The vehicle interior device 1 includes the second cooperative controller 72 that performs cooperative control of causing the second battery 101 supplying power to each component of the automobile to make up for a shortage of electric power supplied by the first battery 62. Accordingly, even when constant power cannot be stationarily supplied only by the first battery 62, more stable operation of the electric components 4 can be secured.

### (Other Components)

Note that with the embodiments described above, the interior components of the automobile are exemplified as the various electric components 4. However, the components are not limited to them. Alternatively, the vehicle interior device 1 may supply power to electric components equipped outside of the vehicle cabin.

The arrangement of the hygroelectric generation elements 5 is not limited to the inside of a space in which occupants are. Alternatively, the elements may be arranged in a space for storing a drive system and the like.

The power generation scheme of the hygroelectric generation element included in the vehicle interior device 1 is not limited to that of the hygroelectric generation element 5 based on the configuration in FIG. 2. Alternatively, a configuration provided with hygroelectric generation element according to another scheme capable of generating power through humidity variation may be adopted.

The second battery 101, which is the vehicle-mounted battery, may be charged through power generation by the hygroelectric generation elements 5 or the second power generation element 61. In this case, the first battery 62 may be omitted from the vehicle interior device 1.

### (2) Embodiment about Seat State Adjustment System

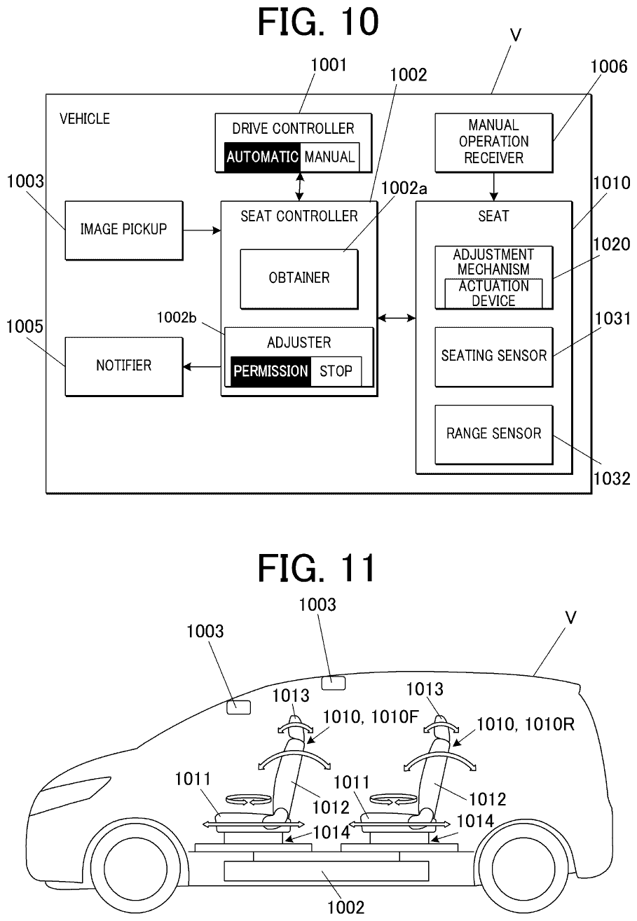

Referring to FIGS. 10 to 17, the embodiment about the seat state adjustment system is described.

The present embodiment pertains to the seat state adjustment system. There is industrial applicability to this.

### Background Art of Present Embodiment

Conventionally, technologies for imaging the motion and state of a seat occupant seated in the vehicle seat through an image pickup, such as a camera, and adjusting the vehicle seat state based on the motion and state of the seat occupant obtained from the image information are disclosed (JP 2021-30842A, JP 2021-66213A, and JP 2021-66211A).

### Object of Present Embodiment

Incidentally, there is a demand that the seat state is adjustable also in a vehicle switchable between the automatic drive mode and the manual drive mode. However, the technologies described in the aforementioned Patent Documents do not consider adjustment of the state of a seat installed in a vehicle that is switchable between an automatic drive mode and a manual drive mode.

For example, in the automatic drive mode, a seat occupant in a seat is free from vehicle drive and operation. Accordingly, the seat state can be adjusted with a large motion that is not allowed in the manual drive mode, and the comfortableness of the seat occupant is expected to be greatly improved. On the other hand, in the manual drive mode, in view of safety, it is required to prevent seat state adjustment that is not intended by the seat occupant.

The present embodiment has been made in view of the situations described above, and has an object to facilitate seat state adjustment without any trouble even in a case of a seat installed in a vehicle that is switchable between the automatic drive mode and the manual drive mode.

### Solution to Problem

To solve the problem described above, an invention as recited in Solution 1 is a seat state adjustment system adjusting a state of a seat installed in a vehicle switchable between an automatic drive mode and a manual drive mode, including:
an image pickup that can image a seat occupant seated in the seat;
an obtainer that obtains image information taken by the image pickup; and
an adjuster that performs control of adjusting the state of the seat, based on a motion of the seat occupant acquired from the image information obtained by the obtainer,
wherein the seat is configured so that the state is adjustable through the control by the adjuster, and the control by the adjuster is permitted when the vehicle is in the automatic drive mode.

An invention as recited in Solution 2 is the seat state adjustment system according to Solution 1,
wherein upon input of a trigger, a permission condition is satisfied, and the control for the seat by the adjuster is permitted in a certain time period after the permission condition is satisfied.

An invention as recited in Solution 3 is the seat state adjustment system according to Solution 2,
wherein when the adjuster determines that a series of motions by the seat occupant acquired from the image information is finished in the certain time period after the permission condition is satisfied, the adjuster cancels the permission condition.

An invention according to Solution 4 is the seat state adjustment system according to any one of Solutions 1 to 3,
wherein a physical size of the seat occupant is identified from the image information, and when the physical size of the seat occupant is smaller than a reference value, the control for the seat by the adjuster based on the motion of the seat occupant is regulated.

An invention as recited in Solution 5 is the seat state adjustment system according to any one of Solutions 1 to 4,
wherein the seat includes a seating sensor that recognizes a seating state of the seat occupant, and identifies a physical size of the seat occupant, and
when the physical size of the seat occupant is smaller than a reference value as a result of identification by the seating sensor, the control by the adjuster based on the motion of the seat occupant is regulated.

An invention as recited in Solution 6 is the seat state adjustment system according to any one of Solutions 3 to 5 reciting Solution 2,
wherein the vehicle includes a plurality of the seats, and
further includes a trigger input receiver that is arranged around one seat among the plurality of seats and is for receiving the trigger.

An invention as recited in Solution 7 is the seat state adjustment system according to any one of Solutions 1 to 6,
wherein on a rear of the seat there is provided a range sensor that detects a distance to an object positioned on a rear side of the seat, and
the control for the seat by the adjuster is stopped based on a detected result by the range sensor.

An invention as recited in Solution 8 is the seat state adjustment system according to any one of Solutions 1 to 7,
wherein the vehicle includes the seat positioned frontward, and a rear seat positioned rearward of the seat,
the seat is configured so that the position is adjustable through the control by the adjuster,
the rear seat is provided with a seating sensor, and
a position adjustment range of the seat when the seat occupant is detected to be seated in the rear seat by the seating sensor is set narrower than the position adjustment range of the seat when the seat occupant is not detected to be seated in the rear seat by the seating sensor.

An invention as recited in Solution 9 is the seat state adjustment system according to any one of Solutions 1 to 8,
wherein the vehicle includes a plurality of the seats arranged frontward and rearward, and the image pickup is provided at a roof lining of the vehicle, and is arranged so as to cover each of the seat arranged forward and the seat arranged rearward among the seats.

An invention as recited in Solution 10 is the seat state adjustment system according to Solution 9,
wherein the image pickup is an omnidirectional imaging device provided at the roof lining of the vehicle.

An invention as recited in Solution 11 is the seat state adjustment system according to any one of Solutions 1 to 10, further including
a manual operation receiver for adjusting the state of the seat through a manual operation by the seat occupant.

An invention as recited in Solution 12 is the seat state adjustment system according to Solution 11,
wherein the seat includes: a seat frame that constitutes a framework of the seat; an adjustment mechanism for transforming or displacing the seat frame; and an actuation device that actuates the adjustment mechanism, and
the manual operation receiver includes a controller device that operates the actuation device.

An invention as recited in Solution 13 is the seat state adjustment system according to any one of Solutions 1 to 12,
wherein when the obtainer is unable to obtain the image information, the control by the adjuster is stopped, and
the seat state adjustment system further includes a notifier that issues a notification that the control by the adjuster is stopped.

An invention as recited in Solution 14 is the seat state adjustment system according to any one of Solutions 1 to 13,
wherein the seat includes a seat cushion, and a seat back,
a lower end of the seat back is coupled to a rear end of the seat cushion via a recliner mechanism, and
the seat state adjustment system further includes an automatic restorer that restores the seat back to a raised state from a reclined state of being tilted rearward with respect to the raised state, when the seat back is in the reclined state, and a failure of the image pickup or the adjuster is detected.

### Advantageous Effects of Solutions

According to the invention as recited in Solution 1, during the manual drive mode, seat state adjustment that is not intended by the seat occupant can be prevented from being made. That is, even in the case of the seat installed in the vehicle switchable between the automatic drive mode and the manual drive mode, the seat state adjustment can be easily made without any trouble.

According to the invention as recited in Solution 2, when the certain time period elapses after the permission condition is satisfied upon input of the trigger, the control for the seat by the adjuster is not performed even though the obtainer obtains the image information where the motion of the seat occupant is taken. Accordingly, seat state adjustment that is not intended by the seat occupant can be prevented from being made.

According to the invention as recited in Solution 3, the permission condition can be canceled without including a motion of the seat occupant after the series of motions of the seat occupant is finished. Accordingly, unnecessary seat state adjustment that is not intended by the seat occupant can be prevented from being made.

According to the invention as recited in Solution 4, based on the image information, the seat occupant in the seat can be estimated as a child, and the control for the seat by the adjuster based on the motion of the seat occupant estimated as a child is regulated. Accordingly, possible seat state adjustment that is to be made by the child and is not intended by an adult riding together can be prevented from being made.

According to the invention as recited in Solution 5, based on the detected result of the seating sensor, the seat occupant in the seat can be estimated as a child, and the control for the seat by the adjuster based on the motion of the seat occupant estimated as a child is regulated. Seat state adjustment that is by the child and is not intended by an adult riding together can be prevented from being made.

According to the invention as recited in Solution 6, the trigger can be input through the trigger input receiver arranged around one seat. Accordingly, instead of a seat occupant seated in a seat away from the trigger input receiver, a seat occupant seated in the one seat or a seat occupant seated in a seat adjacent to the one seat can determine whether to permit the control for the seat by the adjuster or not.

According to the invention as recited in Solution 7, during the control for the seat by the adjuster, the seat can be prevented from coming into contact with an object positioned on the rear side of the seat.

According to the invention as recited in Solution 8, when the seating sensor detects that the seat occupant is seated in the rear, the position adjustment range of the seat can be uniformly regulated to be small. Accordingly, the seat arranged frontward can be prevented from coming into contact with the seat occupant in the rear seat.

According to the invention as recited in Solution 9, each of the seat occupant seated in the seat arranged forward, and the seat occupant seated in the seat arranged rearward can be covered as an imaging target of the image pickup. Accordingly, each of the seat arranged forward, and the seat arranged rearward can be regarded as a target of control by the adjuster.

According to the invention as recited in Solution 10, each of the seat occupant seated in the seat arranged forward, and the seat occupant seated in the seat arranged rearward can be covered as an omnidirectional imaging target of the image pickup, which is the omnidirectional imaging device. Accordingly, each of the seat arranged forward, and the seat arranged rearward can be regarded as a target of control by the adjuster.

According to the invention as recited in Solution 11, even when the control for the seat by the adjuster is not allowed, the state of the seat is adjustable by a manual operation through the manual operation receiver by the seat occupant.

According to the invention as recited in Solution 12, the actuation device for actuating the adjustment mechanism for transforming or displacing the seat frame can be operated by the controller device of the manual operation receiver. Accordingly, even when the control for the seat by the adjuster is not allowed, the state of the seat is adjustable through a manual operation by the seat occupant.

According to the invention as recited in Solution 13, for example, in a case where the image pickup malfunctions or the inside of the vehicle is dark, and the motion of the seat occupant cannot be captured from the image information, control for the seat by the adjuster can be stopped, and the seat occupant is notified of this. Accordingly, the state of the seat is prevented from being adjusted by an erroneous operation.

According to the invention as recited in Solution 14, in a case where a failure of the image pickup or the adjuster is detected, the seat back is restored by the automatic restorer from the reclined state to the raised state. Accordingly, safety is easily secured when the vehicle is switched from the automatic drive mode to the manual drive mode.

(Content of Embodiment about Seat State Adjustment System)

Hereinafter, referring to the drawings, the embodiment about the seat state adjustment system is described. Although various limitations technically preferable to implement the present invention are imposed on the following embodiments, the technical scope of the present invention is not limited to the following embodiments and illustrated examples.

### First Embodiment

A vehicle in a first embodiment about the seat state adjustment system is an automobile (passenger car: wheeled vehicle V). Hereinafter, seats 1010 are vehicle seats in which a driver and passengers are seated. However, there is no limitation to this. For example, the seats may be vehicle seats in vessels, aircraft, construction vehicles, military vehicles, industrial vehicles, railroad vehicles, agricultural vehicles and the like.

In the wheeled vehicle V in the present embodiment, there are installed a plurality of seats 1010. These seats 1010 are configured so that their states are adjustable.

Note that the seats 1010 include front seats 1010F as a driver seat and a front passenger seat, and a rear seat 1010R. The rear seat 1010R may be a bench seat, or separated seats like the driver seat and the front passenger seat. Even in the case of the bench seat type one, the seat may be configured so that its right and left portions are separately reclined.

FIG. 10 shows a schematic configuration of a seat state adjustment system.

The seat state adjustment system of the present embodiment is for adjusting the states of the seats 1010 installed in the wheeled vehicle V switchable between an automatic drive mode and a manual drive mode, and cooperates with a vehicle control system that controls the entire wheeled vehicle V.

The vehicle control system includes a drive controller 1001 that switches the wheeled vehicle V between the automatic drive mode and the manual drive mode, and further includes a component required to switch the mode as needed. The plurality of seats 1010 are adjustable between different states in automatic driving and manual driving.

The seat state adjustment system at least includes a seat controller 1002 for controlling the operations of the seats 1010, and image pickups 1003 that provide image information on seat occupants for the seat controller 1002. The present embodiment further includes a notifier 1005 that issues a notification about information on control of the seats 1010 by the seat controller 1002, and a manual operation receiver 1006 for adjusting the state of each seat 1010 through a manual operation by a seat occupant.

The individual components constituting the seat state adjustment system, and the vehicle control system are communicably connected to each other by a wired or wireless communication network constructed in the vehicle.

### (Drive Controller)

The drive controller 1001 is made up of a microcomputer that includes a central processing unit (CPU), a read only memory (ROM), and a random access memory (RAM). Brake lamps, auxiliary components (e.g., direction indicators, headlights, wiper devices, etc.), and various components, such as actuators, are connected to the drive controller 1001.

The drive controller 1001 loads a program preliminarily stored in the ROM, into the RAM, causes the CPU to execute the program, and controls the operations of the various components and the like, thus controlling automatic driving. Note that the drive controller 1001 may include a plurality of electronic control units.

Specifically, the drive controller 1001 controls the switch between the automatic drive mode for determining the situations around the wheeled vehicle V and the situations of the wheeled vehicle V and controls the wheeled vehicle V, and the manual drive mode by the seat occupant. In the automatic drive mode, the drive controller 1001 determines the vehicle itself and the peripheral situations, based on information obtained from a peripheral situation detector, such as various sensors and a peripheral imaging camera, in order to cause the wheeled vehicle V to travel autonomously. Depending on a determination result, an automatic drive control process of controlling actuators for driving the degree of the accelerator, the degree of brakes, the steering angle and the like is performed. The automatic drive control process generates a travel plan along a preset intended route, based on the peripheral situations of the wheeled vehicle V and map information, and controls driving so that the wheeled vehicle V can autonomously travel according to the generated travel plan.

For example, the drive controller 1001 can automatically start the automatic drive control process in response to the behavior of the wheeled vehicle V and the surrounding situations during the seat occupant's manual driving, and support seat occupant's driving of the wheeled vehicle V. In this case, the drive controller 1001 outputs information indicating the start of the automatic drive control process. In a case where the seat occupant's manual driving is switched by the seat occupant's instruction to automatic driving based on the automatic drive control process, the drive controller 1001 outputs information indicating that transition by the driver's initiative is made, i.e., predetermined information indicating the start of the automatic drive control process.

The drive controller 1001 can automatically finish (cancel) the automatic drive control process in accordance with the behavior of the wheeled vehicle V and the surrounding situations during execution of the automatic drive control process, and perform a process of prompting the seat occupant to manually drive the wheeled vehicle V. In this case, the drive controller 1001 outputs information indicating the end of the automatic drive control process in order to prompt the seat occupant to manually drive the wheeled vehicle V. In a case where the automatic driving based on the automatic drive control process is switched to the seat occupant's manual driving, the drive controller 1001 outputs information indicating that transition by the driver's initiative is made, i.e., predetermined information indicating the end of the automatic drive control process.

Note that the drive controller 1001 may include communication equipment that transmits and receives information on the peripheral situations and the like between the wheeled vehicle V and the outside of this wheeled vehicle V. One example of the communication equipment may be communication equipment that receives road situations through road-to-vehicle communication, such as of wireless communication equipment, by narrowband communication of dedicated short range communications (DSRC).

The information indicating the road situations on the peripheral situations received through the road-to-vehicle communication includes information on the curvature of a driving lane, the shapes and states of the lane and the road such as the road surface cant, the positional relationship of the wheeled vehicle V with the lane, and the positional relationship with another driving vehicle, and the surrounding traffic volume, etc. The drive controller 1001 includes a navigation system as an example of equipment for obtaining the peripheral situations.

The peripheral situation detector described above includes various types of sensors, and a peripheral imaging camera, and detects the peripheral situations of the wheeled vehicle V to perform automatic driving by the drive controller 1001. The peripheral situation detector detects, for example, imaging information by the peripheral imaging camera, obstacle information by a radar, obstacle information by laser imaging detection and ranging (LIDER), etc., as the peripheral situations of the wheeled vehicle V. The peripheral situations include, for example, the positions of white lines of the driving lane for the wheeled vehicle V, the position of the center of the lane, the road width, the road shape, and the situations of obstacles around the wheeled vehicle V. Note that the road shape includes, for example, the curvature of the driving lane, and the slope variation and rolls of the road surface that are effective to estimate the visibility of the sensor. The situations of obstacles around the wheeled vehicle V include, for example, information distinguishing fixed obstacles and mobile obstacles from each other, the positions of the obstacles with respect to the wheeled vehicle V, the moving direction of the obstacles with respect to the wheeled vehicle V, and the relative velocities of the obstacles with respect to the wheeled vehicle V.

### (Image Pickup)

The image pickups 1003 can image the seat occupants seated in the seats 1010. Cameras are adopted as the image pickups 1003. Alternatively, a smartphone or a tablet terminal having a camera function may be adopted instead. Note that the cameras, which are the image pickups 1003 in the present embodiment, are provided on the roof lining of the wheeled vehicle V, and are arranged to cover the front seats 1010F and the rear seat 1010R. That is, in the present embodiment, a plurality of image pickups 1003 are provided at high positions in the vehicle, and can image seat occupants (a driver, and a passenger seated in the front passenger seat) seated in the front seats 1010F, and seat occupants seated in the rear seat 1010R.

The cameras, which are the image pickups 1003, may be provided in plurality not only at the front and the rear but also at the right and left.

Note that the image pickups 1003 in the present embodiment may be an omnidirectional imaging device. The omnidirectional imaging device is also called an omnidirectional camera or an entire celestial sphere camera, and can take images in all the directions centered at the omnidirectional imaging device.

The image pickup 1003, which is the omnidirectional imaging device, is provided on the roof lining of the wheeled vehicle V. The arrangement position may be around the center of the roof lining, or around a rearview mirror to allow imaging the seat occupants seated in the front seats 1010F, and the seat occupants seated in the rear seat 1010R from the front.

Possible adoption of the omnidirectional imaging device as the image pickup 1003 as the present embodiment can reduce the number of image pickups 1003 to be used, and is excellent in cost accordingly. Furthermore, each of the seat occupants seated in the front seats 1010F, and the seat occupants seated in the rear seat 1010R can be covered as an omnidirectional imaging target of the image pickup, which is the omnidirectional imaging device. Accordingly, each of the seat arranged forward, and the seat arranged rearward can be regarded as a target of control by the seat controller 1002.

The image pickup 1003, which is the omnidirectional imaging device, can be used also as a drive recorder.

The image pickup 1003 in the present embodiment can take an image of the motions of the bodies, physical sizes, gestures and the like of the seat occupants seated in the front seats 1010F and the seat occupants seated in the rear seat 1010R, and transmit and provide the taken image, as image information, to and for the seat controller 1002. The taken image may be a still image or a video.

### (Seat Controller and Seats)

The seat controller 1002 changes the position, attitude, and orientation of each seat 1010 with respect to the wheeled vehicle V provided in the wheeled vehicle V, and operates various devices provided in the seats 1010, i.e., is a control device for adjusting the state of each seat 1010, and is made up of a microcomputer that includes a central processing unit (CPU), a read only memory (ROM), and a random access memory (RAM).

The seat controller 1002 is connected to the drive controller 1001, and can perform control of adjusting the state of each seat 1010 in cooperation with control pertaining to driving of the wheeled vehicle V by the drive controller 1001. However, there is no limitation to this. The drive controller 1001 and the seat controller 1002 may be an integrated controller (e.g., ECU: electronic control unit).

The seat controller 1002 in the present embodiment includes various devices required to adjust the state of each seat 1010, such as a storage device that stores various types of information and programs, an input device for transmitting an intention of each seat occupant to the system, and an output device for transmitting various information to each seat occupant, although not shown.

The seat controller 1002 includes an obtainer 1002a that obtains image information taken by the image pickup 1003, and an adjuster 1002b that performs control of adjusting the state of each seat 1010, based on the motion of the corresponding seat occupant acquired from the image information obtained by the obtainer 1002a. That is, the seat controller 1002 executes a program for obtaining the image information taken by the image pickup 1003, and a program for performing control of adjusting the state of each seat 1010, based on the motion of the corresponding seat occupant acquired from the obtained image information.

The obtainer 1002a continuously or periodically (intermittently) obtains the image information taken by the image pickup 1003. The obtained image information includes information such as on the motions, physical sizes, gestures and the like of the bodies of the seat occupants.

The adjuster 1002b performs control of an adjustment mechanism 1020 included in each seat 1010 so as to adjust the state of the corresponding seat 1010 according to multiple patterns, based on the motion of the seat occupant acquired from the obtained image information. The control of each seat 1010 by the adjuster 1002b is permitted when the wheeled vehicle V is in the automatic drive mode. That is, the drive controller 1001 and the seat controller 1002 cooperate with each other, and can determine whether the wheeled vehicle V operates in the automatic drive mode or the manual drive mode. Accordingly, the adjuster 1002b can adjust the states of the seats 1010 only when the wheeled vehicle V is in the automatic drive mode.

Note that it is preliminarily stored in the seat controller 1002 how the states of the seats 1010 are adjusted and which motion and gesture the adjustment is based on. Setting of the motions and gestures may be added later.

Control of each seat 1010 by the adjuster 1002b is stopped when the obtainer 1002a is unable to obtain image information. That is, when, for example, the image pickup 1003 malfunctions or the inside of the vehicle is dark in the night, and the motions of the seat occupants are unable to be captured, control of the seat 1010 by the adjuster 1002b is stopped in order to prevent the image information from being erroneously recognized.

The adjuster 1002b identifies the physical size of each seat occupant from the obtained image information. When the physical size of the seat occupant is smaller than a reference value, the adjuster 1002b can regulate the control for the seat 1010 based on the motion of the seat occupant.

That is, the adjuster 1002b controls the adjustment mechanism 1020, based on the motion of each seat occupant acquired from the obtained image information. In a case of a child, it is conceivable that they more frequently and actively move than an adult. Consequently, there is a possibility that the adjuster 1002b erroneously recognizes the motion of the seat occupant acquired from the obtained image information. Accordingly, when the physical size of the seat occupant identified from the obtained image information is smaller than the reference value, the control by the adjuster 1002b based on the motion of the seat occupant is regulated.

Here, as to the content of the regulation, even when a motion or a gesture largely transforming or largely displacing the seat 1010 among motions of the seat occupant acquired from the image information is performed by the seat occupant, control of adjusting the state of the seat 1010 based on the motion or gesture is not performed. In addition, for example, the regulation may be a regulation of permitting or preventing some patterns among patterns for adjusting the state of the seat 1010, or a regulation of narrowing the amount of transformation or displacement (motion range) of the seat 1010.

The reference value is, for example, the seating height (position of the head), or an area in the contour of a body. The numerical value can be freely set. Reference values may be set for the respective seats 1010.

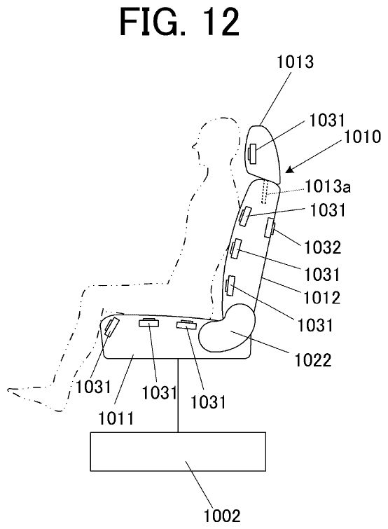

As shown in FIGS. 11 and 12, each seat 1010 subjected to control of adjusting its state by the seat controller 1002 includes, as components constituting this seat 1010: a seat cushion 1011 that holds the buttocks of a seat occupant; a seat back 1012 supported at its lower end by the seat cushion 1011; and a headrest 1013 that is provided at the upper end of the seat back 1012, and supports the head of the seat occupant.

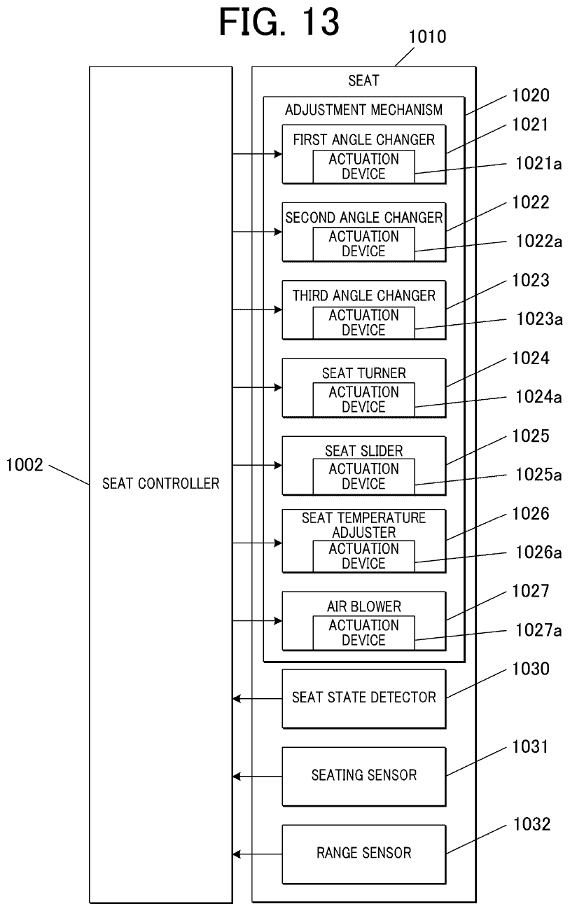

As shown in FIGS. 12 and 13, such a seat 1010 includes, as internal structures constituting this seat 1010: a seat frame (not shown) constituting the framework of the seat 1010; the adjustment mechanism 1020 for transforming or displacing the seat frame; and actuation devices 1021a, 1022a, 1023a, 1024a, 1025a, 1026a, and 1027a for actuating the adjustment mechanism 1020. Accordingly, the seat 1010 can be seat-arranged in any of multiple states by the adjustment mechanism 1020.

For the seat cushion 1011, the seat frame (seat cushion frame) is supported on the floor of the vehicle body by a support mechanism 1014.

As shown in FIG. 12, the headrest 1013 includes pillars 1013a. The pillars 1013a are inserted into headrest guides (not shown) provided in the seat back 1012 (seat back frame).

A plurality of states of each seat 1010 include a state suitable for manual driving, and a state unsuitable for manual driving.

According to the present embodiment, at timing when the drive controller 1001 switches driving from automatic driving to manual driving, the seat controller 1002 controls the adjustment mechanism 1020 so as to change the state to a state suitable for manual driving.

On the other hand, at timing when the drive controller 1001 switches driving from manual driving to automatic driving, the seat controller 1002 controls the adjustment mechanism 1020 so as to change the state to a state unsuitable for manual driving. That is, the state unsuitable for manual driving is a state of the seat 1010 set by changing through actuation of the adjustment mechanism 1020 based on control by the seat controller 1002 when the wheeled vehicle V is switched from the manual driving to automatic driving by the drive controller 1001, and is a state of facilitating relaxation.

The state of the seat 1010 unsuitable for manual driving includes a plurality of patterns. The operation of the seat 1010 is controlled by the seat controller 1002 so as to have the state with a pattern selected by the seat occupant among these patterns.

To allow adjustment of the state of the seat 1010 as described above, the seat 1010 includes a first angle changer 1021, a second angle changer 1022, a third angle changer 1023, a seat turner 1024, a seat slider 1025, a seat temperature adjuster 1026, an air blower 1027, a seat state detector 1030, seating sensors 1031, and a range sensor 1032 (see FIG. 13).

The first angle changer 1021 can be controlled by the seat controller 1002 to change the angle of the seat cushion 1011 with respect to the floor of the vehicle body, and is embedded in the support mechanism 1014 described above. The support mechanism 1014 includes the actuation device 1021a that drives the seat cushion frame constituting the framework of the seat cushion 1011 to change the angle. That is, the first angle changer 1021 is an angle changing mechanism embedded in the support mechanism 1014. The angle changing mechanism is actuated by the actuation device 1021a. The support mechanism 1014 that supports the seat cushion 1011 is configured to allow the angle of the seat cushion 1011 to be changed.

The angle of the seat cushion 1011 can be changed by the first angle changer 1021 from a state suitable for manual driving to a flat state. Furthermore, the right and left tilts can also be changed.

The second angle changer 1022 is a recliner mechanism that can be controlled by the seat controller 1002 to change the angle of the seat back 1012, and includes the actuation device 1022a that drives and turns the seat back 1012 with respect to the seat cushion 1011.

In more detail, although not shown, the lower end of the seat back frame constituting the framework of the seat back 1012 is coupled in a turnable manner via a turning shaft to the rear end of the seat cushion frame constituting the framework of the seat cushion 1011, thus achieving a configuration of allowing the seat back frame to be turned about the axis of the turning shaft by the actuator that is the actuation device 1022a.

The angle of the seat back 1012 can be changed by the second angle changer 1022 from a state suitable for manual driving to a flat state.

The third angle changer 1023 can be controlled by the seat controller 1002 to change the angle of the headrest 1013, and includes the actuation device 1023a that drives and turns the headrest 1013 with respect to the seat back 1012.

Note that the angle change mode of the headrest 1013 may be a pattern of changing the angle of the pillars 1013a with respect to the seat back frame, or a pattern of changing the angle of the headrest 1013 with respect to the pillars 1013a.

In the case of the pattern of changing the angle of the pillars 1013a with respect to the seat back frame, it is configured such that the headrest guides are coupled in a turnable manner via a turning shaft to the seat back frame constituting the framework of the seat back 1012, and the headrest guides can be turned about the axis of the turning shaft by the actuator that is the actuation device 1023a.

In the case of the pattern of changing the angle of the headrest 1013 with respect to the pillars 1013a, it is configured such that a headrest frame constituting the framework of the headrest 1013 is coupled in a turnable manner via a turning shaft to the pillars 1013a, and the headrest frame can be turned about the axis of the turning shaft by the actuator that is the actuation device 1022a.

When the seat back 1012 is in a flat state, the angle of the headrest 1013 can be changed by the third angle changer 1023 from an upright state, such as of a pillow, to the flat state.

The seat turner 1024 can be controlled by the seat controller 1002 to swing the seat cushion 1011 (in turn, the entire seat 1010), and is embedded in the support mechanism 1014 described above. The support mechanism 1014 includes the actuation device 1024a that swings the seat cushion frame constituting the framework of the seat cushion 1011. That is, the seat turner 1024 is a swing mechanism embedded in the support mechanism 1014. The swing mechanism is actuated by the actuation device 1024a. The support mechanism 1014 that supports the seat cushion 1011 is configured to allow the seat cushion 1011 to be swung.

The seat cushion 1011 can be swung by the seat turner 1024 from a position suitable for manual driving to a position of being oriented backward.

The seat slider 1025 can be controlled by the seat controller 1002 to slide the seat cushion 1011 (in turn, the entire seat 1010) in the frontward/rearward direction and the left/right direction, and is embedded in the support mechanism 1014 described above. The support mechanism 1014 includes: a mechanism, such as rails provided on the floor of the vehicle body, and a slider moving along the rails; and the actuation device 1025a that drives the seat cushion frame joined to the mechanism to slide. That is, the seat slider 1025 is a slide mechanism embedded in the support mechanism 1014. The slide mechanism is actuated by the actuation device 1024a. The support mechanism 1014 that supports the seat cushion 1011 is configured to allow the position of the seat cushion 1011 to be changed in the frontward/rearward direction and the left/right direction.

The seat cushion 1011 can be slid by the seat slider 1025 from a position suitable for manual driving to a position unsuitable for manual driving.

It is a matter of course that the first angle changer 1021, the second angle changer 1022, the third angle changer 1023, the seat turner 1024, and the seat slider 1025 can be separately controlled by the seat controller 1002. Furthermore, they can be simultaneously controlled by the seat controller 1002.

The seat temperature adjuster 1026 is a seat heater that is provided in the seat 1010 and heats the seat 1010, and mainly includes sheet-shaped base material made of cloth, such as of polyester, and heater wire (heating wire) that is made of metal, and adheres and is fixed to the base material. The seat temperature adjuster 1026 further includes the actuation device 1026a that turns on and off power supply from the vehicle-mounted battery to the heater wire, and operates the seat temperature adjuster 1026.

The seat 1010 is heated by the seat temperature adjuster 1026, thus allowing the heating state of the seat 1010 to be adjusted.

The air blower 1027 is built in the seat cushion 1011, the seat back 1012, or the headrest 1013 of the seat 1010 to provide the seat 1010 with an air blowing function, and includes an actuation device 1027a that turns on and off power supply from the vehicle-mounted battery to the air blower 1027 to actuate the air blower 1027.

The seat 1010 is blown with air from the air blower 1027, thus allowing the heating state of the seat 1010 to be adjusted.

Although not shown, the seat state detector 1030 includes a plurality of sensors that detect the positions of individual components of the seat 1010, and a plurality of sensors that detect the operation states of the actuation devices 1021a, 1022a, 1023a, 1024a, 1025a, 1026a, and 1027a for the individual components of the seat 1010. The seat controller 1002 can compute and derive the attitude, position, and orientation of the seat 1010, and detect the operation states, based on detected signals of the sensors. That is, after the state of the seat 1010 is adjusted, it can be grasped which state the seat 1010 is in by the seat state detector 1030.

The seating sensors 1031 are sensors for recognizing the seating state of the seat occupant, and identifying the physical size of the seat occupant, and are arranged along the seating surface of the seat 1010, as shown in FIG. 12.

The type of the seating sensor in the present embodiment is, for example, a pressure sensor that detects the pressure of the seat occupant seated in the seat 1010. In the present embodiment, the seating sensors 1031 are arranged along the seating surface of the seat 1010. The seat controller 1002 can determine the physical size of the seat occupant, based on the positions and the number of seating sensors 1031 detecting the seat occupant, by executing a program of determining the physical size of the seat occupant.

When the physical size of the seat occupant is smaller than the reference value as a result of identification by each seating sensor 1031, the control by the adjuster 1002b based on the motion of the seat occupant can be regulated.

That is, the adjuster 1002b controls the adjustment mechanism 1020, based on the motion of each seat occupant acquired from the obtained image information. In a case of a child, it is conceivable that they more frequently and actively move than an adult. Consequently, there is a possibility that the adjuster 1002b erroneously recognizes the motion of the seat occupant acquired from the obtained image information. Accordingly, when the physical size of the seat occupant is determined to be smaller than the reference value as a result of detection by each seating sensor 1031, the control by the adjuster 1002b based on the motion of the seat occupant is regulated.

Here, as to the content of the regulation, even when a motion or a gesture largely transforming or largely displacing the seat 1010 among motions of the seat occupant acquired from the image information is performed by the seat occupant, control of adjusting the state of the seat 1010 based on the motion or gesture is not performed. In addition, for example, the regulation may be a regulation of permitting or preventing some patterns among patterns for adjusting the state of the seat 1010, or a regulation of narrowing the amount of transformation or displacement (motion range) of the seat 1010.

Note that the physical size of the seat occupant can be determined from the image information as described above. Determination from a result of identification by each seating sensor 1031 may be performed at the same time. It is preset which case is prioritized if the determination result is different between the case of determining the physical size from the image information, and the case of determining the physical size by each seating sensor 1031.

The seating sensors 1031 are provided for all the seats 1010. That is, the sensors are provided not only for the front seats 1010F but also for the rear seat 1010R. Detected results by the seating sensors 1031 are transmitted to the seat controller 1002, and used as a determination basis for adjusting the states of the seats 1010, and detected results by the seating sensors 1031 provided for the rear seat 1010R are also used as a determination basis for adjusting the states of the seats 1010.

In more detail, the position adjustment range of each front seat 1010F when a seat occupant is detected to be seated in the rear seat 1010R by the seating sensor 1031 is set narrower than the position adjustment range of the seat 1010 when no seat occupant is detected to be seated in the rear seat 1010R by the seating sensor 1031. That is, a situation where a front seat 1010F is reclined to the flat state even with a person being seated in the rear seat 1010R, and a situation where a front seat 1010F is slid to come into contact with the rear seat 1010R can be avoided.

Note that the pressure sensors are adopted as the seating sensors 1031, but there is no limitation to this. Seating sensors that use electromagnetic waves and can also detect the pulse waves of seat occupants, and seating sensors that are infrared sensors widely used as occupancy sensors may be adopted. Multiple types of sensors may be used together.

The range sensor 1032 is a sensor that is provided on the rear surface of each seat 1010, is for detecting a distance to an object positioned on the rear side of the seat 1010, and is arranged along the rear of the seat back 1012, as shown in FIG. 12.

The type of the range sensor 1032 in the present embodiment is, for example, an ultrasonic range sensor that uses reflection of ultrasonic waves. The control for the seat 1010 by the adjuster 1002b is configured so as to be stopped based on a detected result by the range sensor 1032. That is, a situation where a front seat 1010F comes into contact with the rear seat 1010R, and a situation where a front seat 1010F is reclined to the flat state even with a person being seated in the rear seat 1010R can be avoided.

Note that it can be determined whether a person is seated in the rear seat 1010R or not based not only on determination by the range sensor 1032 but also on determination by the seating sensors 1031 provided for the rear seat 1010R or image information. Determination by these measures may be simultaneously performed. It is preliminarily set which measure is prioritized if detected results by the measures are different from each other.

### (Notifier)

The notifier 1005 issues a notification about information on control of the seats 1010 by the seat controller 1002 (adjuster 1002b). In the present embodiment, a display device provided for the wheeled vehicle V is adopted. The display device is for a car navigation system, and includes a touch panel or another input device.

Such a notifier 1005 can issue a notification on, for example, information on which mode between the automatic drive mode and the manual drive mode the wheeled vehicle V is in, and information on the operation state of the seat controller 1002. The multiple states (multiple patterns of transformation or displacement) of the seats 1010 in the automatic drive mode may be displayed on the notifier 1005, which is the display device, and the seat occupant may be allowed to select the state. In other words, the seat state adjustment system preliminarily stores multiple alternatives (multiple patterns), a selection device (input device) for selecting the states of the seats 1010 is embedded in the wheeled vehicle V, and the seat occupant can select any pattern of the mode of each seat 1010 from among the alternatives.

As described above, if the obtainer 1002a is unable to obtain image information, control of each seat 1010 by the adjuster 1002b is stopped. The notifier 1005 in the present embodiment can issue a notification about such information. When a notification about such information is issued by the notifier 1005, the image information can be prevented from being erroneously recognized in a case where, for example, the image pickup 1003 malfunctions or the inside of the vehicle is dark in the night, and the motions of the seat occupants are difficult to be captured.

Note that in the present embodiment, the display device provided in the wheeled vehicle V serves as the notifier 1005, but there is no limitation to this. An audio output speaker may be adopted as the notifier 1005.

### (Manual Operation Receiver)

The manual operation receiver 1006 is for adjusting the state of each seat 1010 by a manual operation of the seat occupant, and specifically, includes a controller device that operates the actuation devices 1021a, 1022a, 1023a, 1024a, 1025a, 1026a, and 1027a for actuating the adjustment mechanism 1020.

The controller device includes: switches for turning on and off the actuation devices 1021a, 1022a, 1023a, 1024a, 1025a, 1026a, and 1027a; a switch for operating the motion range of each seat 1010; and switches for adjusting the strengths of the seat temperature adjuster 1026 and the air blower 1027.

Such a controller device (manual operation receiver 1006) may be provided in a state of being viewable on the surface of the seat 1010, or on an interior member (e.g., a door trim, a pillar trim, an instrument panel, etc.) of the wheeled vehicle V. Alternatively, the controller device may be displayed on the display device described above, and allows the state of each seat 1010 to be adjusted on the display device through a manual operation.

Although in every respect it is assumed that the manual operation for each seat 1010 through the manual operation receiver 1006 is permitted when the wheeled vehicle V is in the automatic drive mode, there is no limitation to this. Alternatively, the operation may be performed in the case of the manual drive mode.

Accordingly, the seat 1010 changed to the mode suitable for manual driving can be adjusted by the seat occupant's manual operation, and fine adjustment can be made by the seat occupant in accordance with the physical characteristics and the driving attitude of the seat occupant, thus allowing a comfortable seating state to be achieved.

The manual operation for the seat 1010 by the manual operation receiver 1006 can be made even when the obtainer 1002a can obtain no image information, and control of the seat 1010 by the adjuster 1002b is stopped.

### (Seat State Adjustment Method)

Next, a method of adjusting the state of the seat 1010 using the seat state adjustment system configured as described above is described.

Although a method of adjusting the state of the front seat 1010F is herein described, it is assumed that a method of adjusting the state of the rear seat 1010R is performed in a substantially similar manner.

First, to adjust the state of the seat 1010, the wheeled vehicle V is required to be in the automatic drive mode. Imaging by the image pickup 1003 may be performed irrespective of whether the mode is in the automatic drive mode or the manual drive mode. The present embodiment assumes that imaging by the image pickup 1003 is performed in the automatic drive mode.

When the wheeled vehicle V is switched from the manual drive mode to the automatic drive mode, the seat occupant is imaged by the image pickup 1003 (step S1).

In the case where the image pickup 1003 malfunctions or the inside of the vehicle is dark, and the obtainer 1002a can obtain no image information, control of adjusting the states of the seats 1010 by the adjuster 1002b is stopped (steps S2 and S3). Furthermore, a notification that the control for adjusting the states of the seats 1010 is stopped is issued by the notifier 1005 (step S4).

If there is no problem to obtain image information by the obtainer 1002a occurs in step S2, the obtainer 1002a obtains the image information where the motion (gesture or the like) of the seat occupant is captured (step S5).

The obtained image information is stored in the storage device of the seat controller 1002. The seat controller 1002 then identifies the physical size of the seat occupant from the obtained image information (step S6). Alternatively, the physical size of the seat occupant may be identified by the seating sensors 1031 of the seat 1010.

If the physical size of the seat occupant does not satisfy the preset reference value, control for the seats 1010 by the adjuster 1002b based on the motion of the seat occupant is regulated (step S7).

If the physical size of the seat occupant is equal to or more than the preset reference value, or the control for the seats 1010 by the adjuster 1002b based on the motion of the seat occupant is regulated, it is then verified whether a person is seated in the rear seat 1010R or not (step S8).

If a person is seated in the rear seat 1010R, even after control for adjusting the state of the seat 1010 is started, the position adjustment range of the seat 1010 is set narrower than the position adjustment range of the seat 1010 when no seat occupant is detected to be seated in the rear seat 1010R by the seating sensor 1031. That is, if a person is seated in the rear seat 1010R, the seat controller 1002 sets a regulation such that range of transformation or displacement of the front seats 1010F can be small (step S9).

In a case where no person is seated in the rear seat 1010R, and in a case where a regulation such that the range of transformation or displacement of each front seat 1010F can be small is set, control of adjusting the state of the seat 1010 is then started (step S10).

It varies how the state of the seat 1010 is adjusted depending on the motion and gesture of the seat occupant. For example, the seat back 1012 is reclined or the seat 1010 is slid rearward in some cases. In such cases, the distance to an object, e.g., the rear seat 1010R or the seat occupant seated in the rear seat 1010R) positioned on the rear side of the front seat 1010F is detected by the range sensor 1032. If the distance reaches a predetermined distance, and the object is detected by the range sensor 1032, control of the seat 1010 by the adjuster 1002b is stopped (steps S11 and 14).

If no object is detected by the range sensor 1032, the control of adjusting the state of the seat 1010 is continued (step S12).

If the control of adjusting the state of the seat 1010 is continued, and it is determined by the seat state detector 1030 that the seat 1010 is adjusted to the state according to the instruction issued by the motion or gesture of the seat occupant, the control of the seat 1010 by the adjuster 1002b is stopped (steps S13 and 14). If it is determined that the seat 1010 is not adjusted to the state according to the instruction issued by the motion or gesture of the seat occupant, the control of adjusting the state of the seat 1010 is continued (step S12).

As described above, the state of each seat 1010 can be adjusted.

If a different motion or gesture is further imaged after adjustment of the state of the seat 1010, the control of adjusting the state of the seat 1010 is performed again according to the procedures as described above.

When the mode is switched from the automatic drive mode to the manual drive mode, the adjuster 1002b performs control of adjusting the seat 1010 to the state suitable for manual driving. If it is confirmed that the seat 1010 is adjusted to the state suitable for manual driving, and the driver is seated in the seat 1010 that is the driver seat, and has hands on the steering wheel, switching from the automatic drive mode to the manual drive mode is finished.

The present embodiment has excellent advantageous effects as described below.

The seat state adjustment system that adjusts the states of the seats 1010 (1010F and 1010R) installed in the wheeled vehicle V switchable between the automatic drive mode and the manual drive mode, includes: the image pickups 1003 that can image the seat occupants seated in the seats 1010; the obtainer 1002a that obtains image information taken by the image pickups 1003; and the adjuster 1002b that performs control of adjusting the states of the seats 1010, based on the motion of each seat occupant acquired from the image information obtained by the obtainer 1002a. The seats 1010 are configured to be capable of adjusting their states. The control of the seats 1010 by the adjuster 1002b is permitted when the wheeled vehicle V is in the automatic drive mode. Accordingly, adjustment of the state of the seats 1010 that the seat occupants does not intend is prevented in the manual drive mode. That is, even in the case of the seats 1010 installed in the wheeled vehicle V switchable between the automatic drive mode and the manual drive mode, the adjustment of the states of the seats 1010 can be easily made without any trouble.

Based on the image information, the seat occupant in the seat 1010 can be estimated as a child, and the control for the seat 1010 by the adjuster 1002b based on the motion of the seat occupant estimated as a child is regulated. Accordingly, possible adjustment of the state of the seat 1010 that is to be made by the child and is not intended by an adult riding together can be prevented from being made.

Based on the detected results of the seating sensors 1031, the seat occupant in the seat 1010 can be estimated as a child, and the control for the seat 1010 by the adjuster 1002b based on the motion of the seat occupant estimated as a child is regulated. Accordingly, possible adjustment of the state of the seat 1010 that is to be made by the child and is not intended by an adult riding together can be prevented from being made.

The range sensor 1032 that detects the distance to an object positioned on the rear side of the seat 1010 is provided on the rear of the seat 1010. The control of the seat 1010 by the adjuster 1002b is stopped based on the detected result of the range sensor 1032. Accordingly, during the control for the seat 1010 by the adjuster 1002b, the seat 1010 can be prevented from coming into contact with the object positioned on the rear side of the seat 1010.

The wheeled vehicle V includes the seats 1010 (front seats 1010F) arranged frontward, and the rear seat 1010R arranged rearward of the seats 1010 (1010F). The seats 1010 (1010F) are configured to allow their positions to be adjustable through control by the adjuster 1002b. The rear seat 1010R is provided with the seating sensors 1031. The position adjustment range of each seat 1010 (1010F) in the case where it is detected by the seating sensors 1031 that a seat occupant is seated in the rear seat 1010R is set narrower than the position adjustment range of each seat 1010 (1010F) in the case where it is detected by the seating sensors 1031 that no seat occupant is seated in the rear seat 1010R. Accordingly, in the case where it is detected by the seating sensors 1031 that a seat occupant is seated in the rear seat 1010R, the position adjustment range of each seat 1010 (1010F) are uniformly regulated to be small. Accordingly, each seat 1010 (1010F) arranged frontward can be prevented from coming into contact with the seat occupant in the rear seat 1010R.

The wheeled vehicle V includes the seats 1010 (the front seats 1010F and the rear seat 1010R) arranged frontward and rearward. The image pickup 1003 is provided on the roof lining of the wheeled vehicle V, and arranged to cover the seats 1010F arranged frontward and the seat 1010R arranged rearward among the seats 1010. Accordingly, seat occupants seated in the seats 1010F arranged frontward, and seat occupants seated in the seat 1010R arranged rearward can be regarded as imaging targets by the image pickup 1003. Accordingly, the seats 1010F arranged frontward and the seat 1010R arranged rearward can be regarded as targets of control by the adjuster 1002b.

The image pickup 1003 is the omnidirectional imaging device provided on the roof lining of the wheeled vehicle V. Accordingly, each of the seat occupants seated in the seats 1010F arranged forward, and the seat occupants seated in the seat 1010R arranged rearward can be covered as an omnidirectional imaging target of the image pickup 1003, which is the omnidirectional imaging device. Consequently, each of the seats 1010F arranged forward, and the seat 1010R arranged rearward can be regarded as a target of control by the adjuster 1002b.

The manual operation receiver 1006 that adjusts the state of the seat 1010 through the seat occupant's manual operation is further provided. Even in a case where the seat 1010 cannot be controlled by the adjuster 1002b, the state of the seat 1010 can be adjusted by the seat occupant's manual operation through the manual operation receiver 1006.

The seat 1010 includes: the seat frame constituting the framework of the seat 1010; the adjustment mechanism 1020 for transforming or displacing the seat frame; and the actuation devices 1021a, 1022a, 1023a, 1024a, 1025a, 1026a, and 1027a for actuating the adjustment mechanism 1020. The manual operation receiver 1006 includes a controller device for actuating the actuation devices 1021a, 1022a, 1023a, 1024a, 1025a, 1026a, and 1027a. Accordingly, the actuation devices 1021a, 1022a, 1023a, 1024a, 1025a, 1026a, and 1027a for actuating the adjustment mechanism 1020 for transforming or displacing the seat frame can be controlled by the controller device of the manual operation receiver 1006. Accordingly, even when the control for the seat 1010 by the adjuster 1002b is not allowed, the state of the seat 1010 is adjustable through a manual operation by the seat occupant.

The control by the adjuster 1002b is stopped in the case where the obtainer 1002a can obtain no image information. The notifier 1005 that issues a notification that the control by the adjuster 1002b is stopped is further provided. Accordingly, for example, if the image pickup 1003 malfunctions or the inside of the wheeled vehicle V is dark, and the motion of the seat occupant cannot be captured from the image information, the control for the seat 1010 by the adjuster 1002b is stopped, and the seat occupant is notified of this fact through the notifier 1005. Accordingly, the state of the seat 1010 can be prevented from being adjusted by an erroneous operation.

### Second Embodiment

Next, referring to the drawings, a second embodiment is described. Note that for the sake of convenience of description, portions common to those in the first embodiment described above are assigned the same symbols. Description is made focusing mainly on components different from those in the first embodiment.

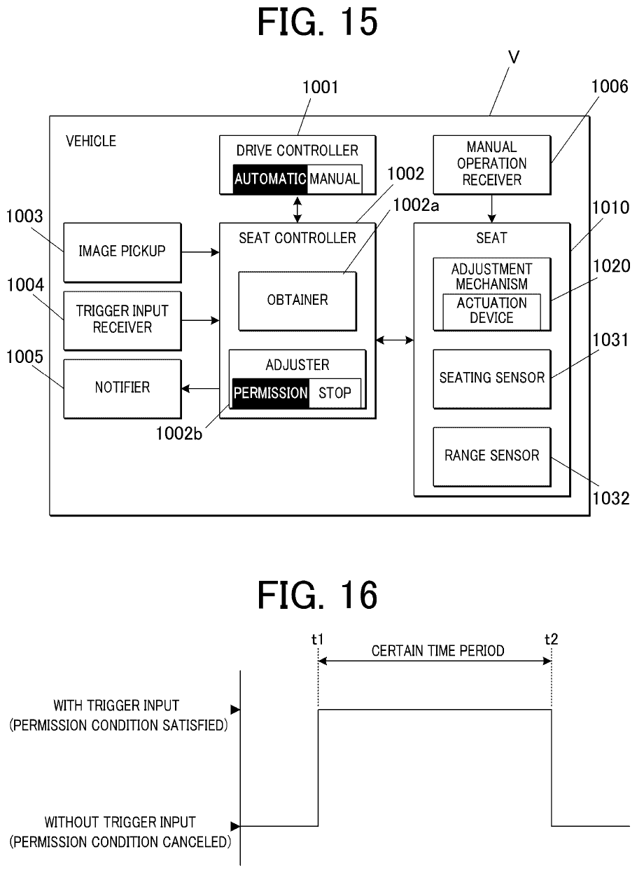

As shown in FIG. 15, the seat state adjustment system in the present embodiment further includes a trigger input receiver 1004. The trigger input receiver 1004 is a device that inputs a predetermined trigger into the seat controller 1002. By inputting the trigger, the permission condition is satisfied. As shown in FIG. 16, in a certain time period after the permission condition is satisfied, the control for the seat 1010 by the adjuster 1002b is permitted.

Here, the trigger indicates information, a signal, data or the like input into the seat controller 1002 when the seat occupant intends to adjust the state of the seat 1010.

More specifically, the trigger in the present embodiment may be a signal issued when a switch dedicated to trigger input is turned on, image information that is obtained through the image pickup 1003 and includes a gesture recognized as the trigger, or audio data pertaining to a predetermined speech by the seat occupant collected by a microphone provided in the wheeled vehicle V.

The switch dedicated to trigger input is provided on, for example, the seat 1010 or an interior member (a door trim, a pillar trim, an instrument panel or the like) around the seat 1010. Accordingly, the switch is arranged in a range manually reachable by the seat occupant. By an operation of turning on the switch, the trigger that is the signal is input into the seat controller 1002, and the permission condition is satisfied.

In this case, the switch dedicated to trigger input functions as the trigger input receiver 1004.

The switch dedicated to trigger input may be provided for the display device for a car navigation system. The switch may be displayed as an object on a touch panel.

The image information that includes a gesture recognized as a trigger is taken by each image pickup 1003. Thus, the seat occupant is seated in the seat 1010, and performs a predetermined gesture, and the trigger that is the image information is input into the seat controller 1002 accordingly, and the permission condition is satisfied. That is, when the seat occupant adjusts the state of the seat 1010, imaging by the image pickup 1003 is performed according to two stages of operations.

In this case, the image pickup 1003 functions as the trigger input receiver 1004.

The microphone is provided at, for example, any of the seats 1010 (headrests 1013), the interior members around the seats 1010 (door trims, pillar trims, instrument panel, sun visors, etc.), the steering wheel, etc. Accordingly, the switch is arranged in a range audibly reachable by the seat occupant. By collecting a predetermined speech by the seat occupant through the microphone, the trigger that is the audio data is input into the seat controller 1002, and the permission condition is satisfied.

In this case, the microphone functions as the trigger input receiver 1004.

In the present embodiment, any of the switch dedicated to trigger input, the image pickups 1003, and the microphone described above may be adopted as the trigger input receiver 1004. Alternatively, another device may be adopted as the trigger input receiver 1004. Any of the trigger input receivers 1004 can input the trigger into the seat controller 1002, and make the permission condition satisfied.

By making the permission condition satisfied, the adjuster 1002b can perform control of adjusting the state of the seat 1010, based on the motion of the seat occupant acquired from the image information obtained by the obtainer 1002a.

The trigger input receiver 1004 is assumed to be arranged around one seat 1010 among the seats 1010. Preferably, the one seat 1010 is a front seat 1010F. More preferably, the one seat 1010 is the front seat 1010F that is the driver seat.

Thus, a seat occupant as a driver or a seat occupant seated in the front passenger seat has the authority of adjusting the states of the seats 1010. Accordingly, for example, a situation that a child changes the state of the seat 1010 without any permission can be prevented from occurring.

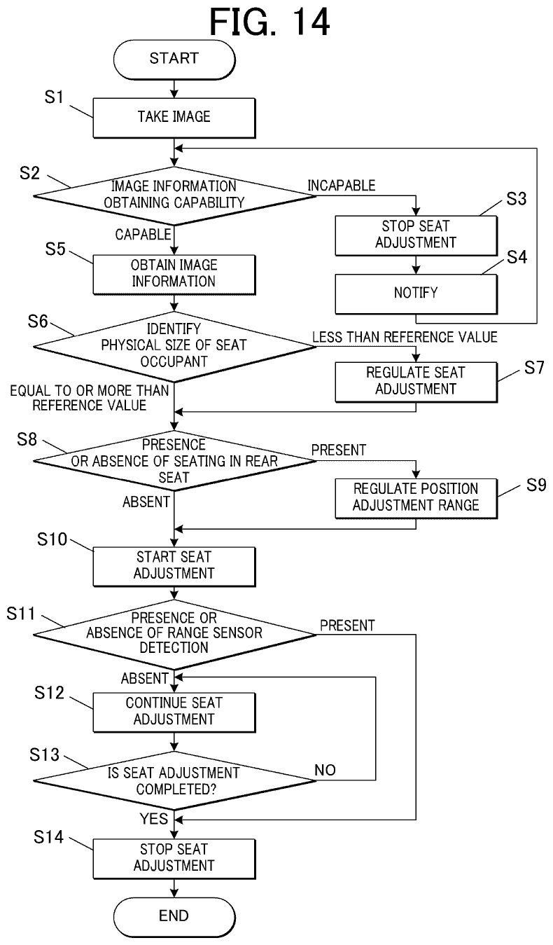

In the procedures of adjusting the state of each seat 1010, the trigger is input at least in a stage before the obtainer 1002a obtains the image information. In more detail with reference to FIG. 14, to adjust the state of each seat 1010, it is prerequisite that the wheeled vehicle V is in the automatic drive mode. Accordingly, the step of inputting the trigger is inserted after the wheeled vehicle V is switched from the manual drive mode to the automatic drive mode and before the obtainer 1002a obtains the image information. It is more desirable that the trigger be input before imaging in step S1.

As described above, it is assumed that by the trigger is input, the permission condition is satisfied, and the control for the seat 1010 by the adjuster 1002b is permitted in the certain time period after the permission condition is satisfied. The permission condition is canceled after the certain time period elapses.

That is, when the seat occupant intends to adjust the state of the seat 1010, it is required that as shown in FIG. 16, a predetermined motion or gesture is performed in a certain time period (t1 to t2), images are taken by the image pickups 1003, and image information is input into the seat controller 1002 (i.e., the obtainer 1002a obtains the image information).

In the present embodiment, the certain time period is set to, e.g., 30 seconds. However, the setting time period can be changed as appropriate.

When the adjuster 1002b determines that a series of motions by the seat occupant acquired from the image information is finished in the certain time period after the permission condition is satisfied, the adjuster 1002b cancels the permission condition. That is, after the series of motions of the seat occupant acquired from the image information is determined to be finished, no permission condition is satisfied even if the seat occupant makes a motion or gesture even in the certain time period. To make the permission condition again, a trigger is required to be input.

The present embodiment has excellent advantageous effects as described below.

The trigger is input, which makes the permission condition satisfied. In the certain time period after the permission condition is satisfied, the control for the seat 1010 by the adjuster 1002b is permitted. Accordingly, when the certain time period elapses after the permission condition is satisfied upon input of the trigger, the control for the seat 1010 by the adjuster 1002b is not performed even if the obtainer 1002a obtains image information where the motion of the seat occupant is taken. Thus, adjustment of the state of each seat 1010 that the seat occupant does not intend can be prevented from being made.

In the certain time period after the permission condition is satisfied, the adjuster 1002b cancels the permission condition when determining that the seat occupant's series of motions acquired from the image information is finished. Accordingly, the permission condition can be canceled without including motions by the seat occupant after completion of the seat occupant's series of motions. Thus, unnecessary adjustment of the state of each seat 1010 that the seat occupant does not intend can be prevented from being made.

The wheeled vehicle V includes the multiple seats 1010 (the front seats 1010F and the rear seat 1010R), and further includes the trigger input receiver 1004 arranged around one seat 1010 (1010F) among the multiple seats 1010 (1010F and 1010R) for receiving the trigger. Accordingly, the trigger can be input from the trigger input receiver 1004 arranged around the one seat 1010 (1010F).

Accordingly, instead of a seat occupant seated in a seat 1010 away from the trigger input receiver 1004, a seat occupant seated in the one seat 1010 (1010F) or a seat occupant seated in a seat 1010 (1010F) adjacent to the one seat 1010 (1010F) can determine whether to permit the control for the seat 1010 by the adjuster 1002a or not.

### Modified Examples

Note that embodiments to which the present invention is applicable are not limited to the embodiments described above, and alterations can be made, as appropriate, without departing from the spirit of the present invention. Hereinafter, modified examples are described. The modified examples described below may be combined if possible.

In each of the following modified examples, elements common to those in the embodiment described above are assigned the common symbols, and description of the elements are omitted or simplified.

The seat 1010 in the present modified example includes the seat cushion 1011, and the seat back 1012. The lower end of the seat back 1012 is coupled to the rear end of the seat cushion 1011 via the recliner mechanism (i.e., the second angle changer 1022).

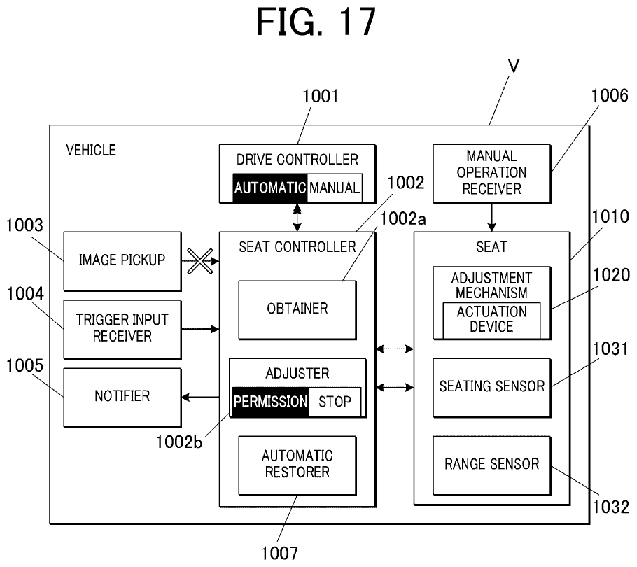

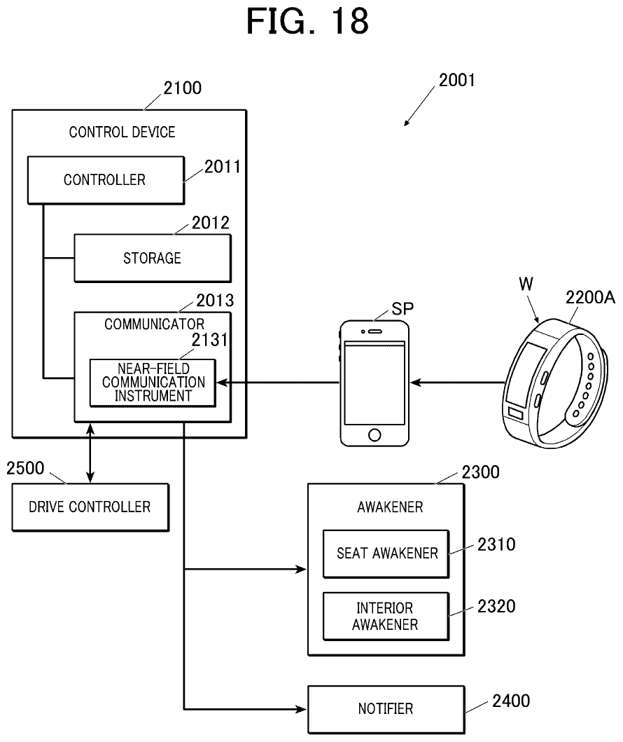

As shown in FIG. 17, the seat state adjustment system in the present modified example further includes an automatic restorer 1007 that restores the seat back 1012 to the raised state from the reclined state of being tilted rearward with respect to the raised state, when the seat back 1012 is in the reclined state, and a failure of the image pickup 1003 or the adjuster 1002b is detected.

The automatic restorer 1007 restores the adjustment mechanism 1020 from the state unsuitable for manual driving to the state suitable for manual driving, and has a function of actuating the actuation devices 1021a, 1022a, 1023a, 1024a, 1025a, 1026a, and 1027a of the adjustment mechanism 1020.

The automatic restorer 1007 is a program executed by the seat controller 1002. By executing the program, the actuation devices 1021a, 1022a, 1023a, 1024a, 1025a, 1026a, and 1027a of the adjustment mechanism 1020 are operated, which restores the adjustment mechanism 1020, i.e., the seat 1010, from the state unsuitable for manual driving to the state suitable for manual driving.

According to the present modified example, in a case where a failure of the image pickup 1003 or the adjuster 1002b is detected, the seat back 1012 is restored by the automatic restorer 1007 from the reclined state to the raised state (the seat 1010 is restored to the state suitable for manual driving). Accordingly, safety is easily secured when the wheeled vehicle V is switched from the automatic drive mode to the manual drive mode.

### (3) Embodiment about Occupant Awakening System

Referring to FIGS. 18 to 29, an embodiment about an occupant awakening system is described.

The present embodiment pertains to the occupant awakening system. There is industrial applicability to this.

### Background Art of Present Embodiment

Conventionally, a vehicle switchable between the automatic drive mode and the manual drive mode includes a drive control device that automatically switches the mode between the automatic drive mode and the manual drive mode.

For example, WO2018/235699 discloses a technology that detects an awakening degree of a driver through a biometric sensor provided at a seat mounted on a vehicle, and switches the mode from the automatic drive mode to the manual drive mode in accordance with the awakening degree.

### Object of Present Embodiment

Unfortunately, the biometric sensor provided at the seat according to the disclosed technology detects the awakening degree via clothes worn by the driver. Accordingly, there is a possibility that the accuracy of detecting the awakening degree is low.

The present embodiment is devised in view of the situations described above, and has an object to provide an occupant awakening system that can more accurately detect the awakening degree of an occupant, and more appropriately urge the occupant to awaken.

### Solution to Problem

To solve the problem described above, an occupant awakening system as recited in Solution 1, includes:
a wearable device that is worn by an occupant in a vehicle, and includes a first detector that detects a first awakening degree of the occupant;
an awakener that is provided in the vehicle, and applies a stimulus that urges the occupant to awaken; and
a controller that controls the awakener, based on the first awakening degree detected by the first detector.

An invention as recited in Solution 2 is the occupant awakening system according to Solution 1,
wherein the awakener includes at least one of a light source that illuminates the occupant with light, a vibration source device that applies vibrations to the occupant, a sound source device that emits a sound, and an actuation device that moves a seat that supports the occupant.

An invention as recited in Solution 3 is the occupant awakening system according to Solution 1 or 2, further including
a determiner that determines whether the first awakening degree is equal to or higher than a predetermined first awakening degree threshold or not,
wherein if the first awakening degree is determined to be lower than the first awakening degree threshold by the determiner, the controller drives the awakener.

An invention as recited in Solution 4 is the occupant awakening system according to Solution 3,
wherein the controller can switch the vehicle between automatic driving and manual driving, and switches the automatic driving to the manual driving if the first awakening degree is determined to be equal to or higher than the first awakening degree threshold by the determiner.

An invention as recited in Solution 5 is the occupant awakening system according to Solution 3 or 4,
wherein if a state where the first awakening degree is determined to be lower than the first awakening degree threshold by the determiner is maintained for a predetermined time period, the controller stops the vehicle.

An invention as recited in Solution 6 is the occupant awakening system according to any one of Solutions 3 to 5,
wherein if the vehicle performs manual driving, the determiner determines whether the first awakening degree is equal to or higher than a predetermined second awakening degree threshold,
if the first awakening degree is determined to be lower than the second awakening degree threshold by the determiner, the controller drives the awakener, and
the second awakening degree threshold is higher than the first awakening degree threshold.

An invention as recited in Solution 7 is the occupant awakening system according to any one of Solutions 1 to 6, further including
a second detector that is provided at a seat that supports the occupant, and detects a second awakening degree of the occupant,
wherein the controller controls the awakener, based on the first awakening degree, or the second awakening degree detected by the second detector.

An invention as recited in Solution 8 is the occupant awakening system according to Solution 7,
wherein the second detector includes at least one of a heart rate sensor, a respiration sensor, a pressure sensor, and a brain wave sensor.

An invention as recited in Solution 9 is the occupant awakening system according to Solution 7 or 8, further including
a temperature detector that detects at least one of an external air temperature outside of the vehicle, and an internal temperature of the vehicle,
wherein if the first awakening degree and the second awakening degree do not coincide with each other, the controller controls the awakener, based on a temperature measured by the temperature detector, and the first awakening degree or the second awakening degree.

An invention as recited in Solution 10 is the occupant awakening system according to any one of Solutions 7 to 9, further including:
an image pickup that can image the occupant; and
a third detector that detects a third awakening degree of the occupant, based on a motion of the occupant acquired from image information taken by the image pickup,
wherein the controller controls the awakener, based on at least one of the first awakening degree, the second awakening degree, and the third awakening degree detected by the third detector.

### Advantageous Effects of Solutions

According to the invention as recited in Solution 1, the awakener can be controlled based on the awakening degree detected by the wearable device that detects an awakening degree more accurate than that detected via clothes worn by the occupant. Accordingly, the occupant can be more appropriately urged to awaken.

According to the invention as recited in Solution 2, the occupant can be more accurately urged to awaken by any of the light source device, the vibration source device, the sound source device, and the actuation device.

According to the invention as recited in Solution 3, the awakener can be driven in a state where the occupant is unable to perform manual driving. Consequently, the occupant can be more appropriately urged to awaken.

According to the invention as recited in Solution 4, in a state where the occupant is sufficiently capable of manual driving, the automatic driving can be switched to the manual driving. Consequently, the vehicle can be safely driven.

According to the invention as recited in Solution 5, if the occupant does not become in a state of being sufficiently capable of manual driving even though the occupant is continuously urged to awaken for the predetermined time period, the vehicle can be stopped. Accordingly, the safety of the vehicle can be secured.

According to the invention as recited in Solution 6, in the manual driving that requires a more awaken state than the automatic driving does, the awakener can be driven based on the second awakening degree threshold higher than the first awakening degree threshold. Accordingly, higher safety can be secured in the manual driving.

According to the invention as recited in Solution 7, the awakener can be controlled based on a more appropriate awakening degree between the first awakening degree and the second awakening degree. Consequently, the occupant can be more appropriately urged to awaken.

According to the invention as recited in Solution 8, the second awakening degree of the occupant can be appropriately detected using a detected result of any of the heart rate sensor, the respiration sensor, the pressure sensor, and the brain wave sensor.

According to the invention as recited in Solution 9, the awakener can be controlled based on a more appropriate awakening degree between the first awakening degree and the second awakening degree, based on the temperature measured by the temperature detector. Consequently, the occupant can be more appropriately urged to awaken.

According to the invention as recited in Solution 10, the awakener can be controlled based on a more appropriate awakening degree among the first awakening degree, the second awakening degree, and the third awakening degree. Consequently, the occupant can be more appropriately urged to awaken.

(Content of Embodiment about Occupant Awakening System)

Hereinafter, referring to the drawings, the embodiment about an occupant awakening system is described. Although various limitations technically preferable to implement the present invention are imposed on the following embodiments, the technical scope of the present invention is not limited to the following embodiments and illustrated examples.

### First Embodiment

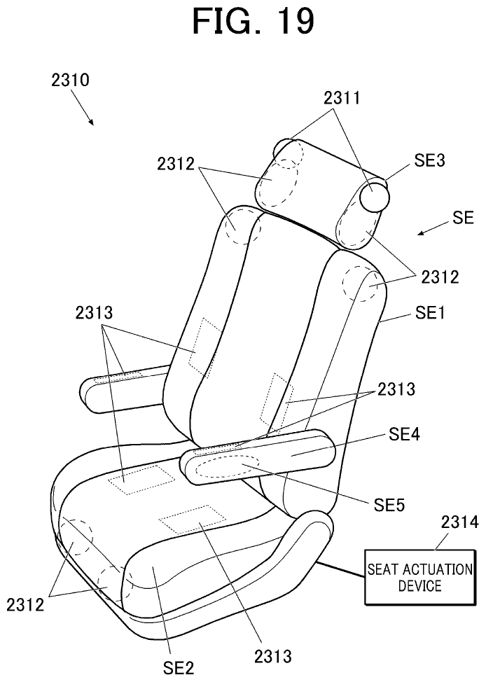

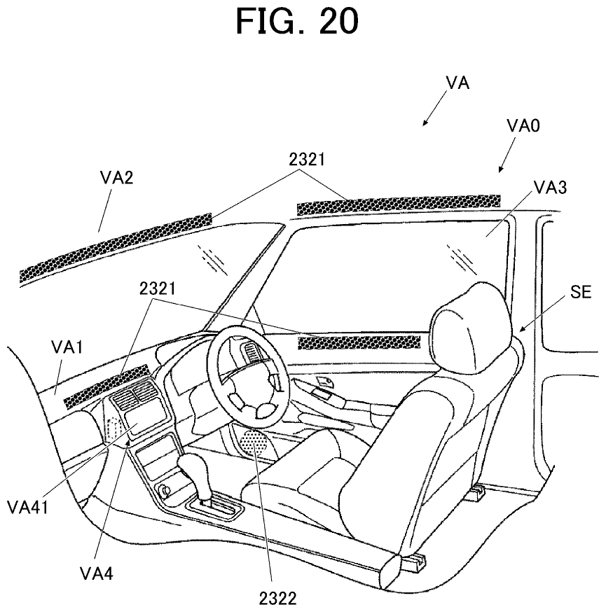

A vehicle in a first embodiment about the occupant awakening system is an automobile (passenger car: wheeled vehicle VA (see FIG. 20)). Hereinafter, a seat SE (see FIG. 19) is a vehicle seat in which a driver is seated. However, there is no limitation to this. For example, the seat is a vehicle seat in vessels, aircraft, construction vehicles, military vehicles, industrial vehicles, railroad vehicles, agricultural vehicles and the like.

### (Occupant Awakening System)

The occupant awakening system 2001 in the present embodiment is mounted on a wheeled vehicle VA switchable between the automatic drive mode and the manual drive mode.

As shown in FIG. 18, the occupant awakening system 2001 includes a control device 2100, a wearable device W, a smartphone SP, an awakener 2300, a notifier 2400, and a drive controller 2500.

### (Control Device)

The control device 2100 includes a controller 2011, a storage 2012, and a communicator 2013.

The control device 2100 is provided in the seat SE. Note that the control device 2100 may be provided at a portion other than the seat SE of the vehicle.

The controller 2011 includes a central processing unit (CPU), and a random access memory (RAM), and controls components of the controller 2100. Specifically, the controller 2011 reads various processing programs stored in the storage 2012, loads the programs into the RAM, and executes various processes according to the programs.

The controller 2011 controls the awakener 2300, based on the first awakening degree detected by a first detector 2200A described later.

The controller 2011 determines whether the first awakening degree is lower than a predetermined first awakening degree threshold or not. In this case, the controller 2011 functions as a determiner.

The storage 2012 includes, for example, a hard disk drive (HDD), a solid state drive (SSD), and an electrically erasable programmable read only memory (EEPROM).

The storage 2012 stores the various processing programs to be executed by the controller 2011, and data required to execute these programs.

The storage 2012 stores the first awakening degree threshold, and a temporal threshold.

The communicator 2013 can transmit a control signal to the awakener 2300, the notifier 2400, etc., and transmit and receive a control signal to and from the drive controller 2500.

The communicator 2013 includes a near-field communication instrument 2131.

The near-field communication instrument 2131 can achieve near-field wireless communication, such as of Bluetooth (R) or Wi-Fi (R). The controller 2011 can communicate with the smartphone SP via the near-field communication instrument 2131.

The smartphone SP and the wearable device W each includes a CPU, a read only memory (ROM), a RAM, and a rewritable nonvolatile memory, which are not shown, and executes preliminarily stored programs.

### (Wearable Device)

The wearable device W is a watch-type device worn around a wrist of a seat occupant (driver) seated in the seat SE, and includes the first detector 2200A. Note that the wearable device W may be underwear-type device worn by the driver.

The wearable device W has a function of transmitting a detected result (first awakening degree) of the first detector 2200A to the smartphone SP.

The first detector 2200A includes an acceleration sensor, and detects the awakening state (first awakening degree) of the driver wearing the wearable device W, based on a measured result of the acceleration sensor. A publicly known method (for example, see WO2021/006235) can be used as a method of detecting the awakening state of the driver. The first awakening degree is defined as a numerical value that is zero when the driver is in a deep sleep state, and increases as they awake.

In the case where the wearable device W is an underwear-type device, the first detector 2200A detects the first awakening degree, based on the heart rate, pulse, respiration or the like of the driver.

### (Awakener)

The awakener 2300 includes a seat awakener 2310, and an interior awakener 2320.

As shown in FIG. 19, the seat awakener 2310 is provided in the seat SE.

The seat SE includes a seat back SE1, a seat cushion SE2, a headrest SE3, armrests SE4, and a wireless power supply SE5.

The wireless power supply SE5 is provided in the armrests SE4 and below a vibration source device 2313 described later.

The wireless power supply SE5 is a power transmitter that wirelessly supplies power to the wearable device W when the driver places, on the armrests SE4, the arm around which the wearable device W is worn.

In the case where the wearable device W is an underwear-type device, the wireless power supply SE5 is provided in the seat back SE1 or the seat cushion SE2. In this case, when the driver is seated in the seat SE, the wireless power supply SE5 wirelessly supplies power to the wearable device W.

The seat awakener 2310 includes light source devices 2311, sound source devices 2312, vibration source devices 2313, a seat actuation device 2314 (actuation device) and the like. Note that it may be configured so that the seat awakener 2310 includes at least one of the light source device 2311, the sound source device 2312, the vibration source device 2313, and the seat actuation device 2314.

The light source devices 2311 are provided at, for example, the headrest SE3.

The light source devices 2311 are devices (e.g., lights, such as LEDs) that can illuminate the driver at the head with strong light and awake the driver.

The sound source devices 2312 are provided, for example, at upper parts of the seat back SE1, parts of the seat cushion SE2 around the feet of the driver, or at the headrest SE3.

The sound source devices 2312 are devices (e.g., speakers or the like) that emit sounds with a volume allowing the driver to awaken, toward the driver. The sounds emitted toward the driver are, for example, music, speech, notification sounds or the like.

The vibration source devices 2313 are provided for the seat back SE1, the seat cushion SE2, or the armrests SE4.

The vibration source devices 2313 are devices (e.g., vibration motors) that can transmit, to the driver, strong vibrations allowing the driver to awaken.

The seat actuation device 2314 is a seat moving device that can move the seat SE itself. Specifically, the device is a recliner device for the seat SE, or a front-rear sliding device for the seat SE. Movement of the seat SE may be front and rear, right and left, rotation, or swinging.

As shown in FIG. 20, the interior awakener 2320 is provided in an interior member VA0 of the wheeled vehicle VA. The interior member VA0 includes an instrument panel VA1, a roof lining VA2, doors VA3, and a navigation device VA4.

The navigation device VA4 includes a display VA41, and an audio input and output device, not shown.

The interior awakener 2320 includes light source devices 2321, and sound source devices 2322. Note that the interior awakener 2320 may include at least one of the light source devices 2321, and the sound source devices 2322.

The light source devices 2321 are provided at, for example, instrument panel VA1, the roof lining VA2, and the doors VA3.

The light source device 2321 has a configuration similar to that of the light source device 2311.

The display VA41 of the navigation device VA4 may be made to function as the light source device 2321.

The sound source devices 2322 are provided at, for example, the doors VA3.

The sound source device 2322 has a configuration similar to that of the sound source device 2312.

The audio input and output device of the navigation device VA4 may be made to function as the sound source device 2322.

### (Notifier)

The notifier 2400 is, for example, the navigation device VA4.

The controller 2011 causes the display VA41 to display a predetermined message, thus notifying the driver.

The controller 2011 causes the audio input and output device of the navigation device VA4 to output a predetermined sound, thus notifying the driver.

In a case where the control device 2100 includes a boarding detector that detects that the driver gets in the wheeled vehicle VA, and the boarding detector actually detects that the driver gets in the wheeled vehicle VA, the controller 2011 determines whether communication with the wearable device W can be established via the smartphone SP. If communication cannot be established with the wearable device W, the controller 2011 controls the notifier 2400 to issue a notification that communication cannot be established with the wearable device W or that the driver does not wear the wearable device W.

If communication cannot be established with the wearable device W, the controller 2011 may control the drive controller 2500, which is described later in detail, not to move the wheeled vehicle VA.

### (Drive Controller)

The drive controller 2500 is made up of a microcomputer that includes a CPU, a ROM, and a RAM. Brake lamps, auxiliary components (e.g., direction indicators, headlights, wiper devices, etc.), and various components, such as actuators, are connected to the drive controller 2500.

The drive controller 2500 loads a program preliminarily stored in the ROM, into the RAM, causes the CPU to execute the program, and controls the operations of the various components and the like, thus controlling automatic driving. Note that the drive controller 2500 may include a plurality of electronic control units.

The drive controller 2500 switches the wheeled vehicle VA between the automatic drive mode (automatic driving) and the manual drive mode (manual driving).

The manual drive mode is a mode for controlling the wheeled vehicle VA through an operation by the driver.

The automatic drive mode is a mode for allowing the drive controller 2500 to determine the peripheral situations of the wheeled vehicle VA and the situations of the wheeled vehicle VA itself, and control the wheeled vehicle VA.

When the drive controller 2500 starts a switching process for the wheeled vehicle VA from the automatic drive mode to the manual drive mode, the drive controller 2500 transmits a start signal as a control signal to the controller 2011.

Upon reception of a switch permission signal as a control signal from the controller 2011, the drive controller 2500 switches the wheeled vehicle VA from the automatic drive mode to the manual drive mode.

Upon reception of a vehicle stop signal as a control signal transmitted from the controller 2011, the drive controller 2500 causes the wheeled vehicle VA to automatically drive to an escape place (e.g., a rest area, a parking lot, etc.), and stop there.

### (Driver Monitoring Process in First Embodiment)

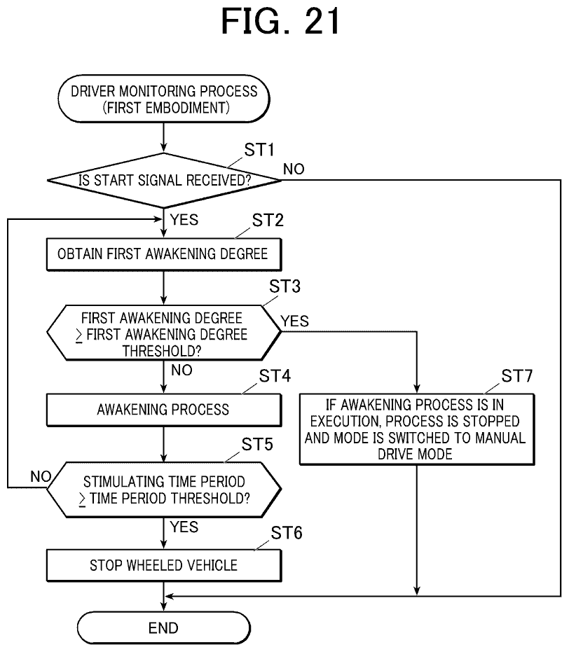

When the wheeled vehicle VA is driving in the automatic drive mode and the switching process to the manual drive mode is started, the controller 2011 of the control device 2100 executes a driver monitoring process shown in FIG. 21.

In the driver monitoring process, first, the controller 2011 determines whether the start signal is received from the drive controller 2500 or not (step ST 1). If the start signal is not received (step ST1: NO), the controller 2011 finishes this processing. In this case, the wheeled vehicle VA maintains the automatic drive mode.

If the start signal is received (step ST1: YES), the controller 2011 obtains a detected result (first awakening degree) of the first detector 2200A from the wearable device W via the smartphone SP (step ST22).

Next, the controller 2011 determines whether the first awakening degree obtained in step ST2 is equal to or higher than the first awakening degree threshold or not (step ST3).

Preferably, the first awakening degree threshold is defined as a value of the awakening degree of the driver when the driver is sufficiently capable of manually driving.

Note that the controller 2011 may perform personal identification of the driver through communication with the wearable device W, and use a value defined on a driver-by-driver basis, as the first awakening degree threshold. The controller 2011 may use, as the first awakening degree threshold, a first awakening degree threshold used in the driver monitoring process executed last time.

If the first awakening degree is lower than the first awakening degree threshold (step ST3: NO), the controller 2011 executes an awakening process (step ST4). In the awakening process, the controller 2011 controls the awakener 2300 to apply a stimulus to the driver, and urges them to awaken. At this time, the controller 2011 may execute the awakening process using either the seat awakener 2310 or the interior awakener 2320, or may execute the awakening process using both the seat awakener 2310 and the interior awakener 2320. In the case of executing the awakening process using both the seat awakener 2310 and the interior awakener 2320, a stronger stimulus can be applied to the driver.

Next, the controller 2011 calculates a stimulating time period that is a difference between the current time and the time of starting the awakening process (a time period during which the stimulus is applied to the driver), and determines whether the stimulating time period is longer than a predetermined time period threshold or not (step ST5). The time period threshold is set with reference to a time period required to make the driver in a sleeping state awaken by the awakener 2300, and is set to about one minute in the present embodiment. If the stimulating time period continues longer than the time period threshold, it is difficult for the awakener 2300 to awaken the driver.

If the stimulating time period is less than the time period threshold (step ST5: NO), the controller 2011 causes this processing to transition to step ST2.

According to this processing, in step ST4 at the second time or thereafter, a stimulus stronger than the stimulus applied to the driver by the awakener 2300 in step ST4 last time may be applied. That is, as the number of times of executing step ST4 increases, the strength of the stimulus applied to the driver by the awakener 2300 may be increased.

If the stimulating time period is longer than the time period threshold (step ST5: YES), the controller 2011 transmits the vehicle stop signal to the drive controller 2500 (step ST6), and finishes this processing. Upon reception of the vehicle stop signal, the drive controller 2500 moves the wheeled vehicle VA to an escape place before the wheeled vehicle VA enters a manual driving section provided for a road or a parking lot and stops the wheeled vehicle VA. That is, if a state where the first awakening degree is determined to be lower than the first awakening degree threshold by the determiner is maintained for the predetermined time period (time period threshold), the controller 2011 stops the wheeled vehicle VA.

Accordingly, even if it is difficult to awaken the driver, the safety of the wheeled vehicle VA can be secured.

If the first awakening degree is equal to or higher than the first awakening degree threshold (step ST3: YES), and the state is in a state of executing the awakening process at the time, the controller 2011 controls the awakener 2300 to stop the awakening process. To stop the awakening process, the controller 2011 may gradually reduce the strength of the stimulus applied to the driver by the awakener 2300, and finally stop the awakening process. The controller 2011 then transmits the switch permission signal to the drive controller 2500 (step ST7), and finishes this processing. Upon reception of the switch permission signal, the drive controller 2500 switches the wheeled vehicle VA from the automatic drive mode to the manual drive mode. Here, the awakening degree (first awakening degree) of the driver is equal to or higher than the first awakening degree threshold, and the driver is sufficiently awake. Accordingly, the driver can safely manually drive the wheeled vehicle VA.

Note that in a case where an abnormality, such as a malfunction of communication or a failure of a device, occurs in driver monitoring process step ST2, and the first awakening degree cannot be obtained from the wearable device W, the controller 2011 may control the notifier 2400 to issue a notification about this.

### Advantageous Effects of First Embodiment

The occupant awakening system 2001 in the first embodiment includes: the wearable device W that is worn by the occupant (driver) in the vehicle (wheeled vehicle VA), and includes the first detector 2200A that detects the first awakening degree of the occupant; the awakener 2300 that is provided in the vehicle, and applies a stimulus for urging the occupant to awaken; and the controller 2011 that controls the awakener 2300, based on the first awakening degree detected by the first detector 2200A.

Consequently, the awakener can be controlled based on the awakening degree detected by the wearable device that detects an awakening degree more accurate than that detected via clothes worn by the occupant. Accordingly, the occupant can be more appropriately urged to awaken.

In the occupant awakening system 2001 in the first embodiment, the awakener 2300 includes at least one of the light source devices 2311 and 2321 that illuminate the occupant with light, the vibration source devices 2313 that apply vibrations to the occupant, the sound source devices 2312 and 2322 that emit sounds, and the actuation device (seat actuation device 2314) that moves the seat SE that supports the occupant.

Consequently, the occupant can be more accurately urged to awaken by any of the light source devices, the vibration source devices, the sound source devices, and the actuation device.

The occupant awakening system 2001 in the first embodiment includes the determiner (controller 2011) that determines whether the first awakening degree is equal to or higher than the predetermined first awakening degree threshold or not. If the first awakening degree is determined to be lower than the first awakening degree threshold by the determiner, the controller 2011 drives the awakener 2300.

Accordingly, the awakener can be driven in a state where the occupant is unable to perform manual driving. Consequently, the occupant can be more appropriately urged to awaken.

In the occupant awakening system 2001 in the first embodiment, the controller 2011 can switch the vehicle between automatic driving and manual driving, and switches the automatic driving to the manual driving if the first awakening degree is determined to be equal to or higher than the first awakening degree threshold by the determiner.

Accordingly, in a state where the occupant is sufficiently capable of manual driving, the automatic driving can be switched to the manual driving. Consequently, the vehicle can be safely driven.

In the occupant awakening system 2001 in the first embodiment, if the state where the first awakening degree is determined to be lower than the first awakening degree threshold by the determiner is maintained for the predetermined time period (time period threshold), the controller 2011 stops the vehicle.

Consequently, if the occupant does not become in the state of being sufficiently capable of manual driving even though the occupant is continuously urged to awaken for the predetermined time period (if it is difficult to awaken the occupant), the wheeled vehicle can be stopped. Accordingly, the safety of the wheeled vehicle can be secured.

### Modified Example

Next, a modified example of the first embodiment is described. Note that for the sake of convenience of description, portions common to those in the first embodiment described above are assigned the same symbols. Description is made focusing mainly on components different from those in the first embodiment.

In the present modified example, the wheeled vehicle VA can only be driven manually by the driver.

The storage 2012 of the control device 2100 in the present modified example stores a second awakening degree threshold. The second awakening degree threshold is defined as a value of the awakening degree of the driver in a case where the driver is sufficiently capable of manually driving. Preferably, this threshold has a value higher than the first awakening degree threshold in the first embodiment described above.

The controller 2011 drives the awakener 2300, based on the second awakening degree threshold. Accordingly, higher safety can be secured in the manual driving.

### (Driver Monitoring Process of Modified Example of First Embodiment)

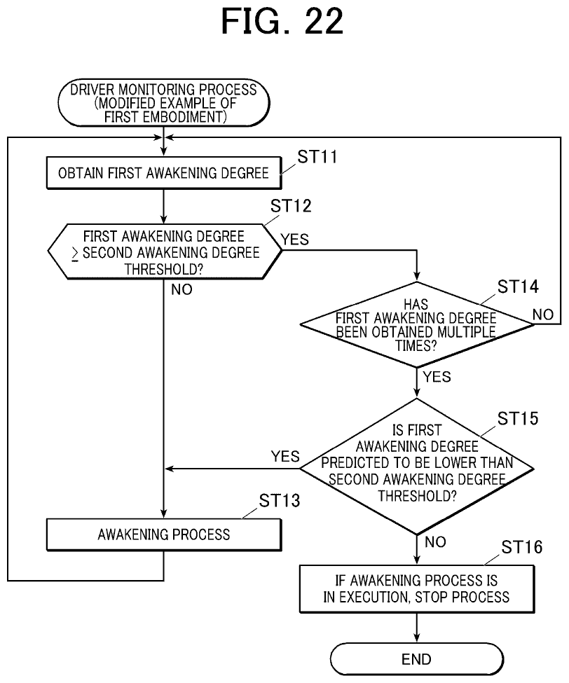

The controller 2011 of the control device 2100 executes the driver monitoring process shown in FIG. 22 during manual driving of the wheeled vehicle VA by the driver's operation.

In the driver monitoring process in the present modified example, first, the controller 2011 executes step ST11 similar to the driver monitoring process step ST2 in the first embodiment. That is, the controller 2011 obtains the first awakening degree.

Next, the controller 2011 determines whether the first awakening degree obtained in step ST11 is equal to or higher than the second awakening degree threshold or not (step ST12).

If the first awakening degree is lower than the second awakening degree threshold (step ST12: NO), the controller 2011 executes step ST13 similar to the driver monitoring process step ST4 in the first embodiment. That is, the controller 2011 executes the awakening process.

Subsequently, the controller 2011 causes this processing to transition to step ST11.

If the first awakening degree is equal to or higher than the second awakening degree threshold (step ST12: YES), the controller 2011 determines whether step ST11 has been executed multiple times or not, i.e., whether the controller 2011 has obtained the first awakening degree multiple times or not (step ST14).

If the controller 2011 has obtained the first awakening degree only once (step ST14: NO), the controller 2011 causes this processing to transition to step ST11.

If the controller 2011 has obtained the first awakening degree multiple times (step ST14: YES), the controller 2011 determines whether the first awakening degree is predicted to be lower than the second awakening degree threshold thereafter or not based on a result of obtaining the first awakening degree multiple times (step ST15). The prediction of the first awakening degree to be lower than the second awakening degree threshold thereafter indicates, for example, a case where the first awakening degree obtained multiple times decreases every time of obtainment. The prediction may be executed by artificial intelligence. The artificial intelligence may be what is based on any of publicly known artificial intelligence technologies.

If the first awakening degree is predicted to be lower than the second awakening degree threshold thereafter (step ST15: YES), the controller 2011 causes this processing to transition to step ST13.

If the first awakening degree is not predicted to be lower than the second awakening degree threshold thereafter (step ST15: NO), and the state is in that of executing the awakening process at the time, the controller 2011 controls the awakener 2300 to stop the awakening process (step ST16), and finishes this processing.

Note that if the first awakening degree is equal to or higher than the second awakening degree threshold (step ST12: YES) in the driver monitoring process in the modified example of the first embodiment, the controller 2011 may omit steps ST14 and ST15. However, in order to secure higher safety, it is preferable to execute steps ST14 and ST15.

### Advantageous Effects of Modified Example of First Embodiment

In the occupant awakening system 2001 in the modified example of the first embodiment, if the vehicle (wheeled vehicle VA) is manually driving, the determiner determines whether the first awakening degree is equal to or higher than the second awakening degree threshold or not. If the first awakening degree is determined to be lower than the second awakening degree threshold by the determiner, the controller 2011 drives the awakener 2300. The second awakening degree threshold is higher than the first awakening degree threshold.

Consequently, in the manual driving that requires a more awaken state than the automatic driving does, the awakener can be driven based on the second awakening degree threshold higher than the first awakening degree threshold. Accordingly, higher safety can be secured in the manual driving.

### Second Embodiment

Next, referring to the drawings, a second embodiment is described. Note that for the sake of convenience of description, portions common to those in the first embodiment described above are assigned the same symbols. Description is made focusing mainly on components different from those in the first embodiment.

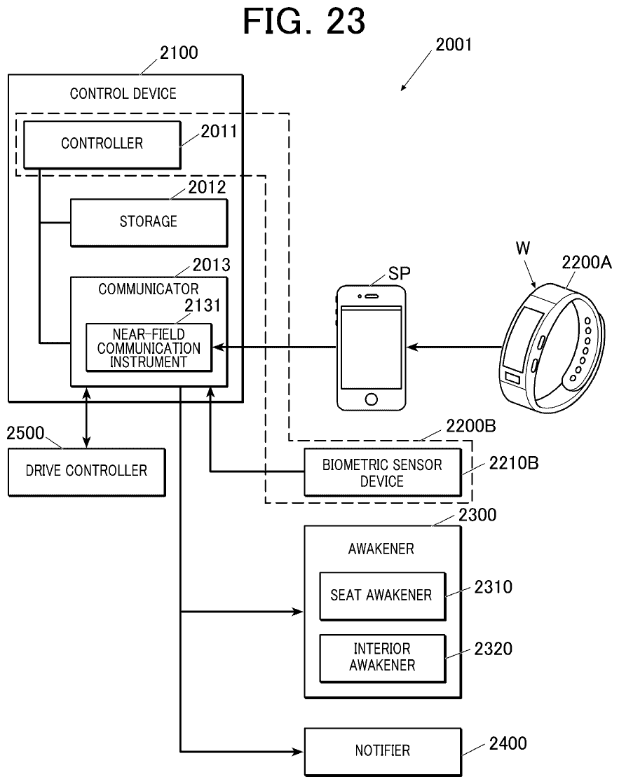

As shown in FIG. 23, the occupant awakening system 2001 in the present embodiment further includes a biometric sensor device 2210B.

The controller 2011 of the control device 2100 receives a detected result of the biometric sensor device 2210B via the communicator 2013, and calculates the second awakening degree, based on the detected result of the biometric sensor device 2210B. The second awakening degree is defined as a numerical value that is zero when the driver is in the deep sleep state, and increases as they awake.

The controller 2011 and the biometric sensor device 2210B function as a second detector 2200B.

### (Biometric Sensor Device)

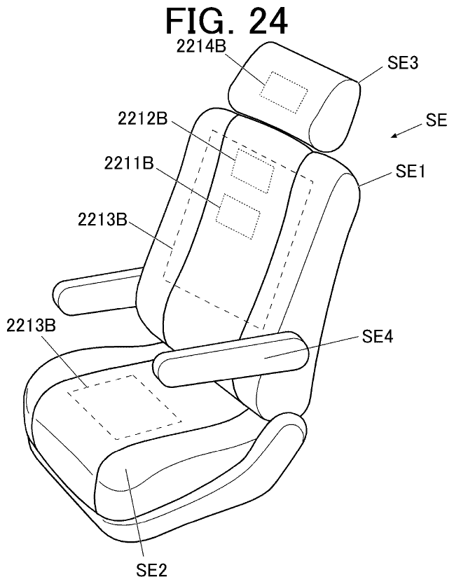

As shown in FIG. 24, the biometric sensor device 2210B includes a heart rate sensor 2211B, respiration sensors 2212B, pressure sensors 2213B, and a brain wave sensor 2214B. Note that the biometric sensor device 2210B may include at least one of the heart rate sensor 2211B, the respiration sensors 2212B, the pressure sensors 2213B, and the brain wave sensor 2214B.

The heart rate sensor 2211B is provided on the front surface of the seat back SE1. Preferably, this sensor is arranged at a position corresponding to the heart of the driver. The heart rate sensor 2211B is a sensor that counts the number of heartbeats of the heart of the driver in a certain time period (heart rate), and may be based on any of schemes that are a touch-type, optical, and electrocardiographic one.

The respiration sensors 2212B are sensors that detect the respiration rate and the depth of respiration of the driver. The respiration sensors 2212B detect the pressure applied from the driver at, for example, positions that are on the front surface of the seat back SE1 and correspond to the lungs of the driver, and capture the variation in pressure caused by the respiratory movement of the driver. Each respiration sensor 2212B may be based on a scheme that includes two sheet-shaped electrodes along the front surface of the seat back SE1, and detects variation in capacitance between the electrodes due to the motion of the chest of a person. The respiration sensor 2212B may be based on any scheme.

The pressure sensors 2213B are sensors for detecting the attitude of the driver, based on the pressure applied to the seat SE. The pressure sensors 2213B are provided to have planar shapes that are on surfaces of the seat cushion SE2 and the seat back SE1 and face the driver, measure the in-plane distribution of pressures applied from the driver to them (pressure distribution), and detect the attitude of the driver.

The brain wave sensor 2214B includes a magnetic sensor provided at a position on the headrest SE3 that faces the head of the driver, detects a magnetic signal due to the activity of brain cells of the driver, and calculates the brain waves of the driver.

By using the biometric sensor device 2210B including any of these sensors, the second awakening degree of the driver can be appropriately detected.

### (Driver Monitoring Process in Second Embodiment)

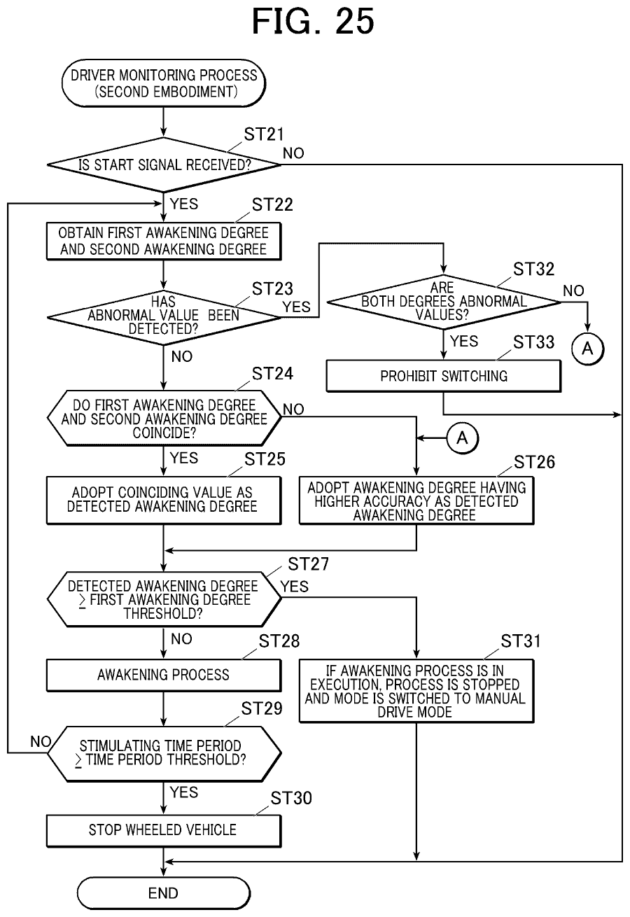

When the wheeled vehicle VA is driving in the automatic drive mode and the switching process to the manual drive mode is started, the controller 2011 of the control device 2100 executes a driver monitoring process in the present embodiment shown in FIG. 25.

In the driver monitoring process in the present embodiment, first, the controller 2011 executes step ST21 similar to driver monitoring process step ST1 in the first embodiment.

If the start signal is not received (step ST21: NO), the controller 2011 finishes this processing. In this case, the wheeled vehicle VA maintains the automatic drive mode. If the start signal is received (step ST21: YES), the controller 2011 obtains a detected result (first awakening degree) of the first detector 2200A from the wearable device W via the smartphone SP. The controller 2011 then calculates the second awakening degree, based on a detected result of the biometric sensor device 2210B, thus obtaining the second awakening degree (step ST22).

Specifically, in the case where the biometric sensor device 2210B includes the heart rate sensor 2211B, it is preferred that the controller 2011 compares the heart rate of the driver at the drive start time and the heart rate of the driver at the time, and reduces the second awakening degree in accordance with the degree of reduction in heart rate.

In the case where the biometric sensor device 2210B includes the respiration sensors 2212B, it is preferred that the controller 2011 compares the respiration rate of the driver at the drive start time and the respiration rate of the driver at the time, and reduces the second awakening degree in accordance with the degree of reduction in respiration rate.

In the case where the biometric sensor device 2210B includes the pressure sensors 2213B, it is preferred that the controller 2011 detects the attitude of the driver, based on the pressure distribution, and calculates the second awakening degree of the driver in accordance with the attitude.

In the case where the biometric sensor device 2210B includes the brain wave sensor 2214B, it is preferred that the controller 2011 calculates the second awakening degree of the driver, based on the waveform of the brain waves of the driver.

The controller 2011 may calculate the second awakening degree of the driver, using two or more of the heart rate, respiration rate, pressure distribution, and brain waves.

Next, the controller 2011 determines whether the first awakening degree and the second awakening degree obtained in step ST22 are abnormal values or not (step ST23). The abnormal value is a value out of a preliminarily set predetermined range, for example, a value that is impossible in actuality.

If the first awakening degree and the second awakening degree are not abnormal values (step ST23: NO), the controller 2011 determines whether the first awakening degree and the second awakening degree coincide with each other or not (step ST24). The coincidence between the first awakening degree and the second awakening degree also includes a case where the difference between the first awakening degree and the second awakening degree is in a predetermined value.

If the first awakening degree and the second awakening degree coincide with each other (step ST24: YES), the controller 2011 adopts the coinciding value as a detected awakening degree (step ST25).

If the first awakening degree and the second awakening degree do not coincide with each other (step ST24: NO), the controller 2011 adopts an awakening degree having a higher detection accuracy between the first awakening degree and the second awakening degree, as the detected awakening degree (step ST26). The detection accuracy may be preset, or determined based on a result of comparison between the first awakening degree and the second awakening degree. There is a high possibility that in comparison with the second awakening degree based on the detected result of the biometric sensor device 2210B obtained via clothes of the driver, the first awakening degree obtained from the wearable device W has a higher accuracy. Accordingly, the higher detection accuracy of the first awakening degree may be higher than that of the second awakening degree.

Next, the controller 2011 determines whether the value adopted as the detected awakening degree in step ST25 or ST26 is equal to or higher than the first awakening degree threshold or not (step ST27).

Hereinafter, the controller 2011 executes steps ST28 to ST31 similar to driver monitoring process steps ST4 to ST7 in the first embodiment.

If at least one of the first awakening degree and the second awakening degree is an abnormal value (step ST23: YES), the controller 2011 determines whether both the first awakening degree and the second awakening degree are abnormal values or not (step ST32).

If only one of the first awakening degree and the second awakening degree is an abnormal value (step ST32: NO), the controller 2011 causes this processing to transition to step ST26.

In step ST26, the controller 2011 adopts the awakening degree that is not an abnormal value (first awakening degree or the second awakening degree) as the detected awakening degree, and executes the following process.

If both the first awakening degree and the second awakening degree are abnormal values (step ST32: YES), the controller 2011 prohibits switching from the automatic drive mode to the manual drive mode (step ST33). That is, hereafter, the controller 2011 does not execute the switching process from the automatic drive mode to the manual drive mode.

Subsequently, the controller 2011 finishes this processing.

Note that if at least one of the first awakening degree and the second awakening degree is an abnormal value in the driver monitoring process in the second embodiment (step ST23: YES), the controller 2011 may prohibit switching from the automatic drive mode to the manual drive mode.

If an abnormality, such as a malfunction of communication or a failure of a device, occurs and the first awakening degree or the second awakening degree cannot be obtained in driver monitoring process step ST22 in the second embodiment, the controller 2011 may execute the following process, based on the obtained first awakening degree or second awakening degree.

If only one of the first awakening degree and the second awakening degree is an abnormal value in the driver monitoring process in the second embodiment (step ST32: NO), the controller 2011 may replace the awakening degree that is abnormal (the first awakening degree or the second awakening degree), with the awakening degree obtained when step ST22 is executed last time, and execute the following process. That is, if the first awakening degree is an abnormal value, the first awakening degree obtained last time is used as the first awakening degree this time. That is, if the second awakening degree is an abnormal value, the second awakening degree obtained last time is used as the second awakening degree this time.

If both the first awakening degree and the second awakening degree are abnormal values in the driver monitoring process in the second embodiment (step ST32: YES), the controller 2011 may adopt the first awakening degree obtained when step ST22 is executed last time as the first awakening degree this time, and adopt the second awakening degree obtained when step ST22 is executed last time as the second awakening degree this time. Subsequently, the controller 2011 may perform the processes in and after step ST24.

If at least one of the first awakening degree and the second awakening degree is an abnormal value in the driver monitoring process in the second embodiment (step ST23: YES), the controller 2011 may cause this processing to transition to step ST22, and obtain the first awakening degree and the second awakening degree again. At this time, if the state where at least one of the first awakening degree and the second awakening degree is an abnormal value continues over a predetermined number of times of obtainment, the controller 2011 may prohibit switching from the automatic drive mode to the manual drive mode.

### Advantageous Effects of Second Embodiment

The occupant awakening system 2001 in the second embodiment is provided in the seat SE that supports the occupant, and includes the second detector (the biometric sensor device 2210B and the controller 2011) that detects the second awakening degree of the occupant. The controller 2011 controls the awakener 2300, based on the first awakening degree, or on the second awakening degree detected by the second detector.

Consequently, the awakener can be controlled based on a more appropriate awakening degree between the first awakening degree and the second awakening degree. Consequently, the occupant can be more appropriately urged to awaken.

In the occupant awakening system 2001 in the second embodiment, the second detector includes at least one of the heart rate sensor 2211B, the respiration sensors 2212B, the pressure sensors 2213B, and the brain wave sensor 2214B.

Consequently, the second awakening degree of the occupant can be appropriately detected using a detected result of any of the heart rate sensor, the respiration sensors, the pressure sensors, and the brain wave sensor.

### Third Embodiment

Next, referring to the drawings, a third embodiment is described. Note that for the sake of convenience of description, portions common to those in the second embodiment described above are assigned the same symbols. Description is made focusing mainly on components different from those in the second embodiment.

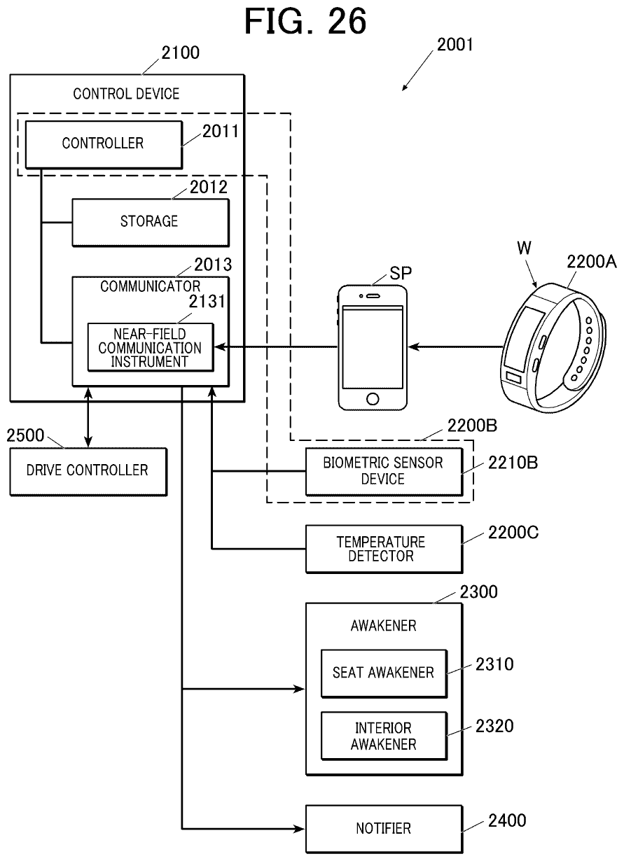

As shown in FIG. 26, the occupant awakening system 2001 in the present embodiment further includes a temperature detector 2200C.

The controller 2011 of the control device 2100 receives a detected result (measured temperature) of the temperature detector 2200C via the communicator 2013.

### (Temperature Detector)

The temperature detector 2200C measures at least one of the external air temperature outside of the wheeled vehicle VA, and the cabin temperature in the wheeled vehicle VA.

In the case where the temperature detector 2200C detects the external air temperature outside of the wheeled vehicle VA, the temperature detector 2200C is provided outside of the wheeled vehicle VA.

In the case where the temperature detector 2200C detects the cabin temperature in the wheeled vehicle VA, the temperature detector 2200C is provided in the interior member VA0.

### (Driver Monitoring Process in Third Embodiment)

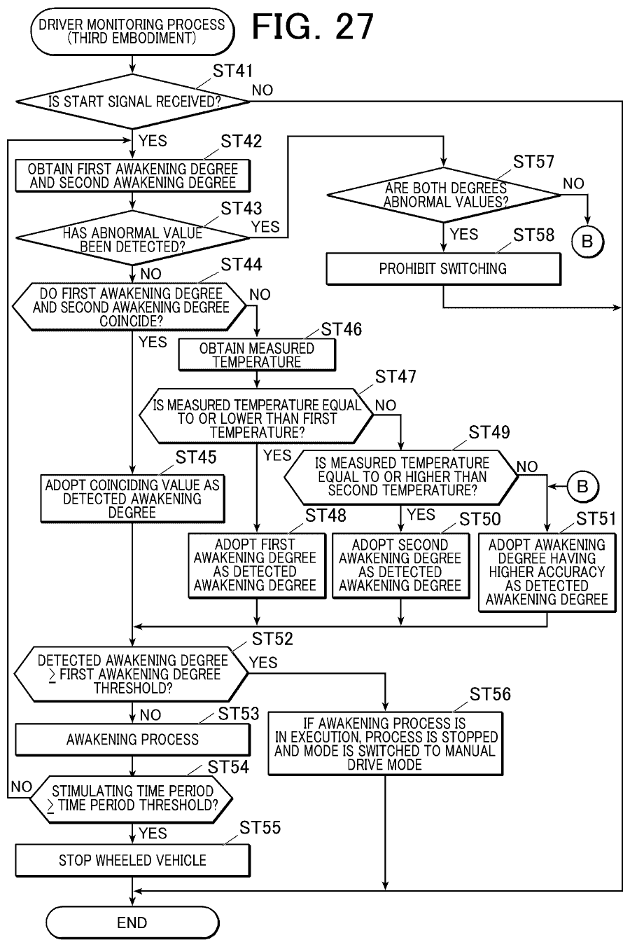

When the wheeled vehicle VA is driving in the automatic drive mode and the switching process to the manual drive mode is started, the controller 2011 of the control device 2100 executes a driver monitoring process in the present embodiment shown in FIG. 27.

In the driver monitoring process in the present embodiment, first, the controller 2011 executes steps ST41 to ST45 similar to driver monitoring process steps ST21 to ST25 in the second embodiment.

If the first awakening degree and the second awakening degree do not coincide with each other (step ST44: NO), the controller 2011 obtains at least one (measured temperature) of the external air temperature outside of the wheeled vehicle VA and the cabin temperature in the wheeled vehicle VA from the temperature detector 2200C (step ST46).

Next, the controller 2011 determines whether or not the external air temperature or the cabin temperature obtained in step ST46 is equal to or lower than a first temperature (step ST47). The first temperature is, for example, five degrees, but there is no limitation to this. The first temperature may be a temperature at which the driver feels cold.

If the external air temperature or the cabin temperature is equal to or lower than the first temperature (step ST47: YES), the controller 2011 adopts the first awakening degree as the detected awakening degree (step ST48). If the external air temperature or the cabin temperature is equal to or lower than the first temperature (e.g., five degrees), the driver is highly possibly overdressed. In this case, the second awakening degree based on the detected result of the biometric sensor device 2210B obtained via the clothes of the driver possibly has a lower accuracy than the first awakening degree does. Accordingly, by performing the following process based on the first awakening degree having a higher accuracy, the occupant can be more appropriately urged to awaken.

If the external air temperature or the cabin temperature is higher than the first temperature (step ST47: NO) the controller 2011 determines whether or not the external air temperature or the cabin temperature is equal to or higher than a second temperature (step ST49). The second temperature is, for example, 30 degrees, but there is no limitation to this. The second temperature may be a temperature at which the driver feels hot.

If the external air temperature or the cabin temperature is equal to or higher than the second temperature (step ST49: YES), the controller 2011 adopts the second awakening degree as the detected awakening degree (step ST50). If the external air temperature or the cabin temperature is equal to or higher than the second temperature (e.g., 30 degrees), the driver is highly possibly in a sweat. In this case, the accuracy of the first awakening degree is possibly reduced by the sweat of the driver. Accordingly, by performing the following process based on the second awakening degree having a higher accuracy, the occupant can be more appropriately urged to awaken.

If the external air temperature and the cabin temperature are higher than the first temperature and lower than the second temperature (step ST49: NO), the controller 2011 executes steps ST51 to ST58 similar to driver monitoring process steps ST26 to ST33 in the second embodiment, and finishes this processing.

Note that in the driver monitoring process in the third embodiment, the controller 2011 may execute the following processes instead of steps ST46 to ST48.

The controller 2011 is connected to a heating device provided for the interior member VA0, seat heaters, etc., and obtains the operation states of the heating device, the seat heaters, etc. The controller 2011 then determines whether the heating device, the seat heaters, etc., operate or not, and adopts the first awakening degree as the detected awakening degree if the heating device, the seat heaters, etc., are in operation.

In the driver monitoring process in the third embodiment, the controller 2011 may execute the following processes instead of steps ST46, ST47, ST49, and ST50.

The controller 2011 is connected to a cooling device provided for the interior member VA0, and obtains the operation state of the cooling device. The controller 2011 then determines whether the cooling device operates or not, and adopts the second awakening degree as the detected awakening degree if the cooling device is in operation.

### Advantageous Effects of Third Embodiment

The occupant awakening system 2001 in the third embodiment includes the temperature detector 2200C that measures at least one of the external air temperature of the vehicle (wheeled vehicle VA), and the internal temperature (cabin temperature) of the vehicle. If the first awakening degree and the second awakening degree do not coincide with each other, the controller 2011 controls the awakener 2300, based on the temperature measured by the temperature detector 2200C and on the first awakening degree or the second awakening degree.

Consequently, the awakener can be controlled based on a more appropriate awakening degree between the first awakening degree and the second awakening degree, based on the temperature measured by the temperature detector. Consequently, the occupant can be more appropriately urged to awaken.

### Fourth Embodiment

Next, referring to the drawings, a fourth embodiment is described. Note that for the sake of convenience of description, portions common to those in the second embodiment described above are assigned the same symbols. Description is made focusing mainly on components different from those in the second embodiment.

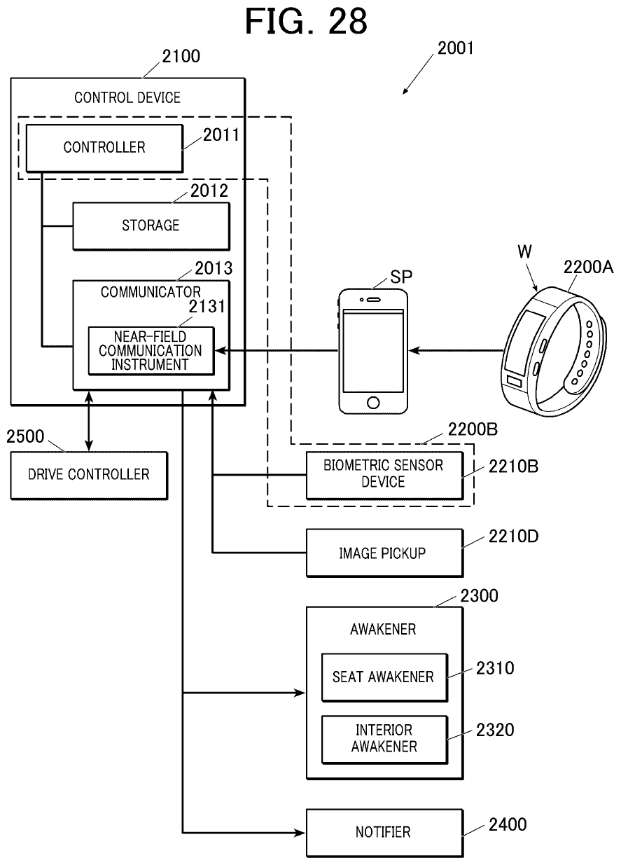

As shown in FIG. 28, the occupant awakening system 2001 in the present embodiment further includes an image pickup 2210D.

The controller 2011 of the control device 2100 receives images taken by the image pickup 2210D via the communicator 2013, and calculates the third awakening degree, based on the taken images. The third awakening degree is defined as a numerical value that is zero when the driver is in the deep sleep state, and increases as they awake.

That is, the controller 2011 detects the third awakening degree of the occupant, based on the motion of the occupant (driver) obtained from the image information taken by the image pickup 2210D. In this case, the controller 2011 functions as a third detector.

### (Image Pickup)

The image pickup 2210D can image the seat occupant (driver) seated in the seat SE. Cameras are adopted as the image pickup 2210D. Alternatively, a smartphone or a tablet terminal having a camera function may be adopted instead. Note that the camera that is the image pickup 2210D in the present embodiment is provided on, for example, the roof lining VA2.

A plurality of cameras each serving as the image pickup 2210D may be provided.

The image pickup 2210D takes images of the motion of eyelids, the motion of the body and the like of the seat occupant seated in the seat SE, and transmits the taken images, as image information, to the controller 2011. The taken image may be a still image or a video.

### (Driver Monitoring Process in Fourth Embodiment)

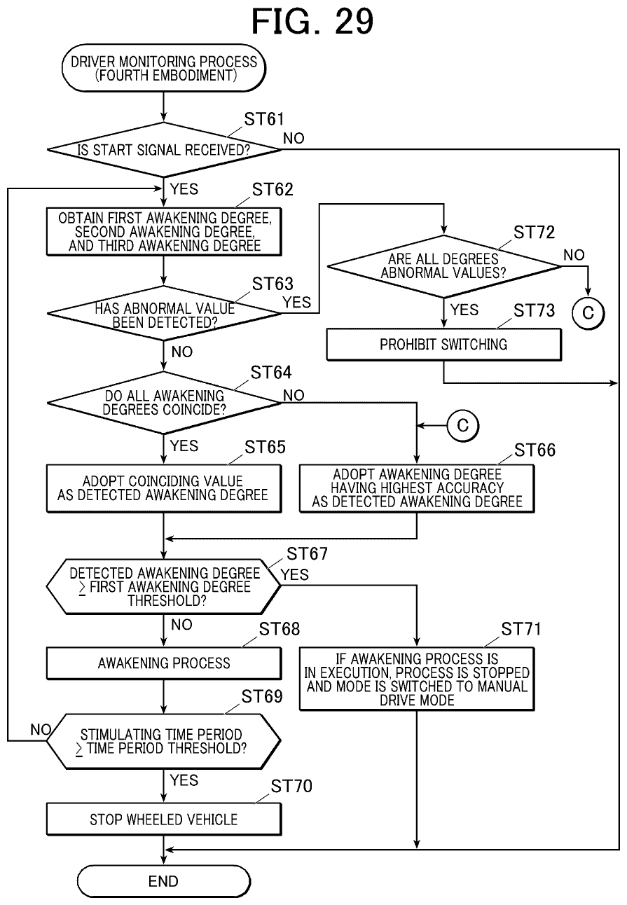

When the wheeled vehicle VA is driving in the automatic drive mode and the switching process to the manual drive mode is started, the controller 2011 of the control device 2100 executes a driver monitoring process in the present embodiment shown in FIG. 29.

In the driver monitoring process in the present embodiment, first, the controller 2011 executes step ST61 similar to driver monitoring process step ST21 in the second embodiment.

If the start signal is not received (step ST61: NO), the controller 2011 finishes this processing. In this case, the wheeled vehicle VA maintains the automatic drive mode. If the start signal is received (step ST61: YES), the controller 2011 obtains a detected result (first awakening degree) of the first detector 2200A from the wearable device W via the smartphone SP. The controller 2011 then calculates the second awakening degree, based on a detected result of the biometric sensor device 2210B, thus obtaining the second awakening degree. The controller 2011 then calculates the third awakening degree, based on the image taken by the image pickup 2210D, thus obtaining the third awakening degree (step ST62).

Specifically, the controller 2011 calculates the eye openness (eye opening degree) of the seat occupant, based on the taken image of the seat occupant. The controller 2011 then calculates the third awakening degree, based on the calculated eye openness. For example, the controller 2011 assumes that a state with an eye openness of zero is the deep sleep state, and the third awakening degree increases with increase in eye openness.

The controller 2011 calculates an activity level of the motion of the seat occupant, based on the taken image of the seat occupant. The controller 2011 then calculates the third awakening degree, based on a calculated activity level of the motion. For example, the controller 2011 assumes that a state where the activity level of the motion is zero is the deep sleep state, and the third awakening degree increases with increase in activity level of the motion.

Next, the controller 2011 determines whether the first awakening degree, the second awakening degree, and the third awakening degree obtained in step ST62 are abnormal values or not (step ST63).

If the first awakening degree, the second awakening degree, and the third awakening degree are not abnormal values (step ST63: NO), the controller 2011 determines whether the first awakening degree, the second awakening degree, and the third awakening degree coincide with one another or not (step ST64). The coincidence among the first awakening degree, the second awakening degree, and the third awakening degree also includes a case where the differences between the first awakening degree, the second awakening degree, and the third awakening degree are in a predetermined value.

If the first awakening degree, the second awakening degree, and the third awakening degree coincide with one another (step ST64: YES), the controller 2011 adopts the coinciding value as a detected awakening degree (step ST65).

If the first awakening degree, the second awakening degree, and the third awakening degree do not coincide with one another (step ST64: NO), the controller 2011 adopts an awakening degree having the highest detection accuracy among the first awakening degree, the second awakening degree, and the third awakening degree, as the detected awakening degree (step ST66). The detection accuracy may be preset, or determined based on a result of comparison among the first awakening degree, the second awakening degree, and the third awakening degree.

Next, the controller 2011 executes steps ST67 to ST71 similar to driver monitoring process steps ST27 to ST31 in the second embodiment.

If at least one of the first awakening degree, the second awakening degree, and the third awakening degree is an abnormal value (step ST63: YES), the controller 2011 determines whether all the first awakening degree, the second awakening degree, and the third awakening degree are abnormal values or not (step ST72).

If at least one of the first awakening degree, the second awakening degree, and the third awakening degree is not an abnormal value (step ST72: NO), the controller 2011 causes this processing to transition to step ST66.

In step ST66, the controller 2011 adopts the awakening degree that is not an abnormal value and has a higher accuracy (first awakening degree, the second awakening degree, or the third awakening degree) as the detected awakening degree, and executes the following process.

If all the first awakening degree, the second awakening degree, and the third awakening degree are abnormal values (step ST72: YES), the controller 2011 prohibits switching from the automatic drive mode to the manual drive mode (step ST73), and finishes this processing.

Note that if an abnormality, such as a malfunction of communication or a failure of a device, occurs and any one of the first awakening degree, the second awakening degree, and the third awakening degree cannot be obtained in driver monitoring process step ST63 in the fourth embodiment, the controller 2011 may execute the following process, based on the successfully obtained first awakening degree, second awakening degree, or third awakening degree.

If only at least one of the first awakening degree, the second awakening degree, and the third awakening degree is not an abnormal value in the driver monitoring process in the fourth embodiment (step ST72: NO), the controller 2011 may replace the awakening degree that is abnormal (at least one of the first awakening degree, the second awakening degree, and the third awakening degree), with the awakening degree obtained when step ST62 is executed last time, and execute the following process. That is, if the first awakening degree is an abnormal value, the first awakening degree obtained last time is used as the first awakening degree this time. That is, if the second awakening degree is an abnormal value, the second awakening degree obtained last time is used as the second awakening degree this time. That is, if the third awakening degree is an abnormal value, the third awakening degree obtained last time is used as the third awakening degree this time.

Note that the control device 2100 may include an operation receiver, such as a switch.

In this case, instead of driver monitoring process step ST66 in the fourth embodiment, the controller 2011 may adopt, as the detected awakening degree, the awakening degree selected by the seat occupant through the operation receiver among the first awakening degree, the second awakening degree, and the third awakening degree.

Instead of driver monitoring process step ST66 in the fourth embodiment, the controller 2011 may adopt, as the detected awakening degree, the awakening degree selected by artificial intelligence from among the first awakening degree, the second awakening degree, and the third awakening degree. The artificial intelligence may be what is based on any of publicly known artificial intelligence technologies.

### Advantageous Effects of Fourth Embodiment

The occupant awakening system 2001 in the fourth embodiment includes: the image pickup 2210D that can image the occupant; and the third detector (controller 2011) that detects the third awakening degree of the occupant, based on the motion of the occupant acquired from image information taken by the image pickup 2210D. The controller 2011 controls the awakener 2300, based on at least one of the first awakening degree, the second awakening degree, and the third awakening degree.

Consequently, the awakener can be controlled based on a more appropriate awakening degree between the first awakening degree, the second awakening degree, and the third awakening degree. Consequently, the occupant can be more appropriately urged to awaken.

Note that embodiments to which the present invention is applicable are not limited to the embodiments described above, and alterations can be made, as appropriate, without departing from the spirit of the present invention.

For example, the wearable device W is not limited to the watch-type device worn around a wrist, or the underwear-type device, and may be, for example, any of wearable devices that can be worn at various portions of a person, such as a device worn at a head of the driver, a device worn at a hip, or a finger-ring-type device.

In the embodiment described above, the awakener 2300 includes the seat awakener 2310, and the interior awakener 2320. However, there is no limitation to this. It may be configured to include one of the seat awakener 2310 and the interior awakener 2320.

The awakener 2300 may include a heat source that is a device heating or cooling part of the body of the driver. The heat source is, for example, a heater and a Peltier element that are provided in the headrest SE3, and heat or cool the head of the driver.

The awakener 2300 may include an electric stimulus generation source. The electric stimulus generation source includes two electrodes provided on a surface of the seat back SE1 or the seat cushion SE2 that faces the driver, and can apply an electric stimulus to the driver by applying a predetermined voltage between the two electrodes.

### (4) Embodiment about Vehicle Seat

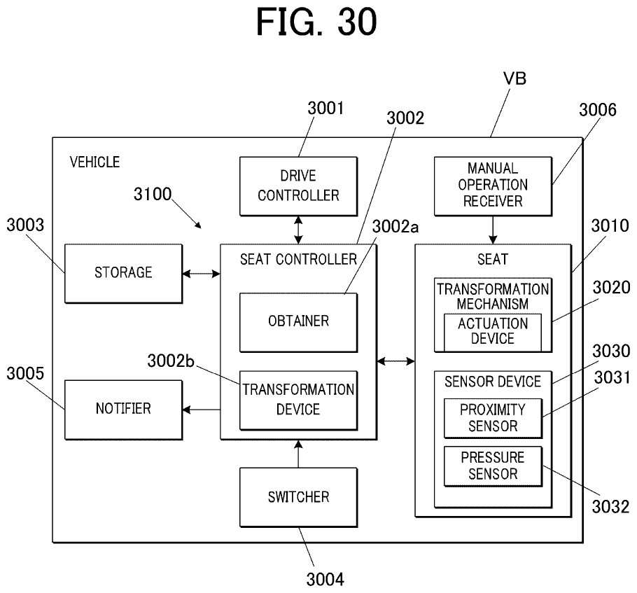

Referring to FIGS. 30 to 38, the embodiment about a vehicle seat is described.

The present embodiment pertains to the vehicle seat. There is industrial applicability to this.

### Background Art of Present Embodiment

Conventionally, the vehicle seat provided in the wheeled vehicle allows its attitude to be adjustable at a position and an orientation.

In recent years, the seat is sometimes transformed with a seat occupant being seated in the vehicle seat so as to recline the seat back of the vehicle seat rearward and relax the seat occupant.

For example, JP 2020-131914A discloses a technology that can reduce variation in an actual movement time period required to transform the vehicle seat and always perform the same operation even in cases where the load applied on the vehicle seat varies.

### Object of Present Embodiment

In a case of transforming the vehicle seat as in the invention in JP 2020-131914, the occupant of the vehicle is required to operate an operation switch, which is cumbersome.

The present embodiment has been achieved in view of the situation described above, and has an object to provide a vehicle seat that can easily transform the seat.

### Solution to Problem

To solve the problem described above, a vehicle seat as recited in Solution 1 is
a vehicle seat including a headrest and a seat back, the vehicle seat further including:
a sensor device that is provided at least at the headrest, and detects a motion of a head of an occupant in the vehicle seat;
a recliner mechanism that turns the seat back in a frontward/rearward direction of the vehicle seat; and
a controller that controls the recliner mechanism, based on the motion of the head of the seat occupant detected by the sensor device.

An invention as recited in Solution 2 is the vehicle seat according to Solution 1,
wherein the sensor device includes a proximity sensor, and a pressure sensor.

An invention as recited in Solution 3 is the vehicle seat according to Solution 2, further including
a first determiner that determines whether a pressure value detected by the pressure sensor is equal to or higher than a predetermined pressure threshold or not,
wherein when it is determined by the first determiner that the pressure value is equal to or higher than the pressure threshold, the controller controls the recliner mechanism, and turns the seat back in a rearward direction of the vehicle seat.

An invention as recited in Solution 4 is the vehicle seat according to Solution 3, further including
a second determiner that determines whether a distance detected by the proximity sensor is equal to or higher than a predetermined distance threshold or not,
wherein when it is determined by the second determiner that the distance is equal to or higher than the distance threshold, the controller controls the recliner mechanism, and turns the seat back in a frontward direction of the vehicle seat.

An invention as recited in Solution 5 is the vehicle seat according to Solution 4, further including
a slide mechanism that moves the vehicle seat in a frontward/rearward direction of the vehicle seat,
wherein when it is determined by the first determiner that the pressure value is equal to or higher than the pressure threshold, the controller controls the slide mechanism, and moves the vehicle seat in the rearward direction of the vehicle seat.

An invention as recited in Solution 6 is the vehicle seat according to Solution 5,
wherein when it is determined by the second determiner that the distance is equal to or larger than the distance threshold, the controller controls the slide mechanism, and moves the vehicle seat in the frontward direction of the vehicle seat.

An invention as recited in Solution 7 is the vehicle seat according to any one of Solutions 2 to 6,
wherein the headrest includes a pad that is a cushion material, and a covering material that covers the pad, and
the sensor device is provided in a concave provided in a surface of the pad that is in contact with the covering material.

An invention as recited in Solution 8 is the vehicle seat according to any one of Solutions 2 to 6,
wherein the headrest includes a pad that is a cushion material, and a covering material that covers the pad,
the proximity sensor is provided in a concave provided in a surface of the pad that is in contact with the covering material, and
the pressure sensor is provided between the pad and the covering material.

An invention as recited in Solution 9 is the vehicle seat according to any one of Solutions 1 to 8,
wherein the sensor device is provided at an upper part of the seat back, and detects a motion of shoulders of the seat occupant, and
the controller controls the recliner mechanism, based on the motions of the head and the shoulders of the seat occupant detected by the sensor device.

An invention as recited in Solution 10 is the vehicle seat according to any one of Solutions 1 to 9,
wherein the vehicle including the vehicle seat can automatically drive, and
when the vehicle is automatically driving, the controller controls the recliner mechanism.

An invention as recited in Solution 11 is the vehicle seat according to any one of Solutions 1 to 10, further including
a changer that changes an angle of the headrest with respect to the seat back,
wherein the controller controls the changer and changes the angle of the headrest, based on an angle of the seat back.

### Advantageous Effects of Solutions

According to the invention as recited in Solution 1, based on the motion of the head of the seat occupant in the vehicle seat detected by the sensor device, the recliner mechanism can be controlled. Consequently, when the attitude of the vehicle seat is transformed, the seat can be easily transformed without operating the operation switch.

According to the invention as recited in Solution 2, the motion of the head of the seat occupant can be detected by the proximity sensor and the pressure sensor. Consequently, the recliner mechanism can be more appropriately controlled.

According to the invention as recited in Solution 3, when the pressure value detected by the pressure sensor is equal to or higher than the pressure threshold, the seat back can be controlled to be tilted. Consequently, only when the seat occupant presses the head against the headrest, the seat back can be controlled to be tilted.

According to the invention as recited in Solution 4, when the distance detected by the proximity sensor is equal to or larger than the distance threshold, the seat back can be controlled to be raised. Consequently, only when the seat occupant intends to rise, the seat back can be controlled to be raised.

According to the invention as recited in Solution 5, when the seat back is tilted, the vehicle seat can be moved in the rearward direction. Consequently, the seat occupant can stretch their legs.

According to the invention as recited in Solution 6, when the seat back is raised, the vehicle seat can be moved in the frontward direction. Consequently, the position of the vehicle seat can be placed at a position suitable for manual driving.

According to the invention as recited in Solution 7, even in a case where the proximity sensor or the pressure sensor does not have a film shape, the sensor can be accommodated in the concave. Consequently, the proximity sensor and the pressure sensor can be appropriately provided in the headrest.

According to the invention as recited in Solution 8, even in a case where the proximity sensor does not have a film shape, the sensor can be accommodated in the concave. Consequently, the proximity sensor can be appropriately provided in the headrest. In a case where the pressure sensor has a film shape, the pressure sensor can be appropriately provided in the headrest by arranging the pressure sensor between the pad and the covering material.

According to the invention as recited in Solution 9, based on the motions of the head and shoulders of the seat occupant seated in the vehicle seat detected by the sensor device, the recliner mechanism can be controlled. Consequently, the recliner mechanism can be more appropriately controlled.

According to the invention as recited in Solution 10, the recliner mechanism is controlled only when the vehicle is automatically driving. Consequently, the recliner mechanism can be prevented from being driven in an unintended manner when the vehicle is manually driven.

According to the invention as recited in Solution 11, the angle of the headrest can be changed based on the angle of the seat back. Consequently, the angle of the headrest can be changed to that allowing the seat occupant to take a comfortable attitude.

(Content of Embodiment about Vehicle Seat)

Hereinafter, referring to the drawings, an embodiment about the vehicle seat is described. Although various limitations technically preferable to implement the present invention are imposed on the following embodiments, the technical scope of the present invention is not limited to the following embodiments and illustrated examples.

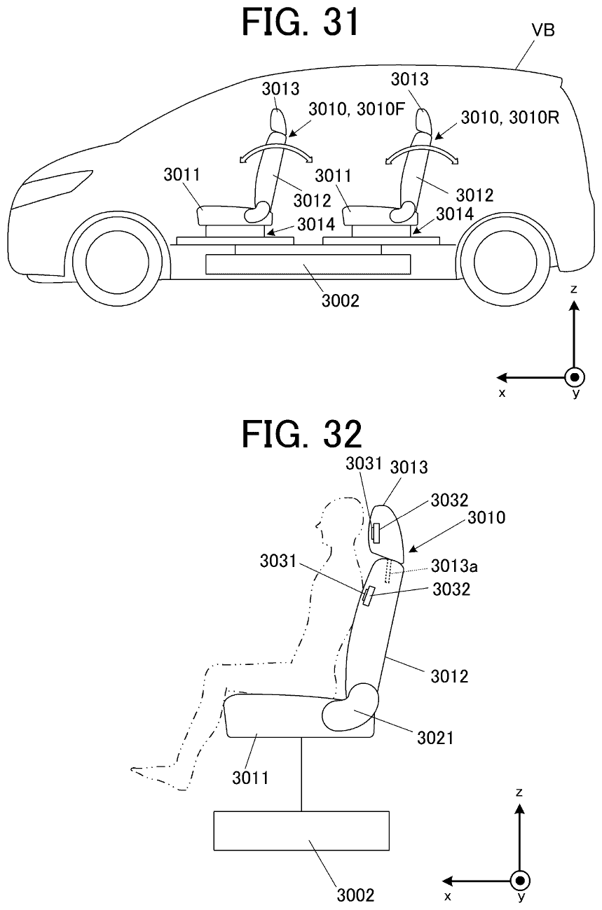

The vehicle in the embodiment about the vehicle seat is an automobile (passenger car: wheeled vehicle VB shown in FIGS. 30 and 31). Hereinafter, seats 3010 are vehicle seats in which a driver and passengers (occupants) are seated. However, there is no limitation to this. For example, the seat is a vehicle seat in vessels, aircraft, construction vehicles, military vehicles, industrial vehicles, railroad vehicles, agricultural vehicles and the like.

As shown in FIG. 31, in the wheeled vehicle VB in the present embodiment, there are installed a plurality of seats 3010. These seats 3010 are configured so that their attitudes are adjustable.

Note that the seats 3010 include front seats 3010F as a driver seat and a front passenger seat, and a rear seat 3010R. The rear seat 3010R may be a bench seat, or separated seats like the driver seat and the front passenger seat. Even in the case of the bench seat type one, the seat may be configured so that its right and left portions are separately reclined.

In the following description, “X-axis direction” indicates the frontward/rearward direction viewed from the seat occupant in the seat 3010, and is a direction coinciding with the travel direction of the wheeled vehicle. Here, “X-axis positive direction” indicates the frontward direction, and “X-axis negative direction” indicates the rearward direction.

The “Y-axis direction” indicates the width direction of each seat 3010, and coincides with the left/right direction viewed from the seat occupant in the seat 3010.

The “Z-axis direction” indicates the height direction of the seat 3010, and coincides with the upward/downward direction with the seat 3010 being viewed from the front. Here, “Z-axis positive direction” indicates the upward direction, and “Z-axis negative direction” indicates the downward direction.

FIG. 30 shows a schematic configuration of a seat transformation system 3100.

The seat transformation system 3100 of the present embodiment is for transforming the attitudes of each seat 3010 installed in the wheeled vehicle VB switchable between an automatic drive mode (automatic driving) and a manual drive mode (manual driving), and cooperates with a vehicle control system that controls the entire wheeled vehicle VB.

The vehicle control system includes a drive controller 3001 that switches the wheeled vehicle VB between the automatic drive mode and the manual drive mode, and further includes a component required to switch the mode as needed.

The seat transformation system 3100 includes a seat controller 3002, a storage 3003, a switcher 3004, a notifier 3005, and a manual operation receiver 3006.

The individual components constituting the seat transformation system 3100, and the vehicle control system are communicably connected to each other by a wired or wireless communication network constructed in the vehicle.

### (Drive Controller)

The drive controller 3001 is made up of a microcomputer that includes a central processing unit (CPU), a read only memory (ROM), and a random access memory (RAM). Brake lamps, auxiliary components (e.g., direction indicators, headlights, wiper devices, etc.), and various components, such as actuators, are connected to the drive controller 3001.

The drive controller 3001 loads a program preliminarily stored in the ROM, into the RAM, causes the CPU to execute the program, and controls the operations of the various components and the like, thus controlling automatic driving. Note that the drive controller 3001 may include a plurality of electronic control units.

The drive controller 3001 switches the wheeled vehicle VB between the automatic drive mode and the manual drive mode.

The manual drive mode is a mode for controlling the wheeled vehicle VB through an operation by the driver.

The automatic drive mode is a mode for allowing the drive controller 3001 to determine the peripheral situations of the wheeled vehicle VB and the situations of the wheeled vehicle VB itself, and control the wheeled vehicle VB.

### (Seat Controller)

The seat controller 3002 is a control device for transforming the attitudes of each seat 3010, and is made up of a microcomputer that includes a CPU, a ROM, and a RAM.

The seat controller 3002 is connected to the drive controller 3001, and can perform control of transforming the attitude of each seat 3010 in cooperation with control pertaining to driving of the wheeled vehicle VB by the drive controller 3001. However, there is no limitation to this. The drive controller 3001 and the seat controller 3002 may be an integrated controller (ECU: electronic control unit).

As shown in FIGS. 31 and 32, the seat controller 3002 is provided below the seat cushions 3011 (in the Z-axis negative direction).

In the present embodiment, the vehicle seats include the seats 3010, and the seat controller 3002.

The seat controller 3002 includes: an obtainer 3002a that obtains a detected result of a sensor device 3030 described later; and a transformation device 3002b that controls the transformation of the attitude of each seat 3010, based on the detected result obtained by the obtainer 3002a. That is, the seat controller 3002 executes a program for obtaining the detected result of the sensor device 3030, and a program for controlling the transformation of the attitude of each seat 3010.

The obtainer 3002a continuously or periodically (intermittently) obtains a detected result of the sensor device 3030.

The transformation device 3002b controls a transformation mechanism 3020 included in each seat 3010 so as to transform the attitude of the seat 3010, based on the obtained detected result. The transformation control of each seat 3010 by the transformation device 3002b is permitted when the wheeled vehicle VB is in the automatic drive mode, and the transformation control is set to ON by the switcher 3004. The drive controller 3001 and the seat controller 3002 cooperate with each other, and can determine which mode between the automatic drive mode and the manual drive mode the wheeled vehicle VB is driving in.

### (Storage)

The storage 3003 includes, for example, a hard disk drive (HDD), a solid state drive (SSD), and an electrically erasable programmable read only memory (EEPROM).

The storage 3003 stores the various processing programs to be executed by the seat controller 3002, and data required to execute these programs.

The storage 3003 further stores a distance threshold and a pressure threshold, which are described later. The distance threshold and the pressure threshold are stored with respect to each of after-mentioned tilt angles of each seat back 3012.

### (Seat)

As shown in FIGS. 31 and 32, each seat 3010 subjected to control of transforming its attitude by the seat controller 3002 includes, as components constituting this seat 3010: a seat cushion 3011 that holds the buttocks of a seat occupant; a seat back 3012 supported at its lower end by the seat cushion 3011; and a headrest 3013 that is provided at the upper end of the seat back 3012, and supports the head of the seat occupant.

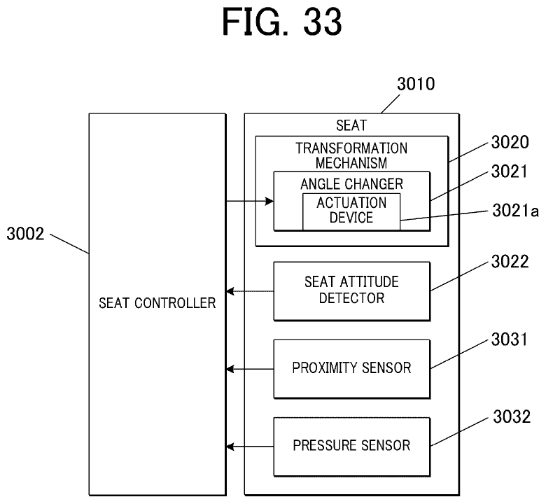

As shown in FIG. 33, such a seat 3010 includes, as internal structures constituting this seat 3010: a seat frame (not shown) constituting the framework of the seat 3010; the transformation mechanism 3020 for transforming the seat frame; and an actuation device 3021a for actuating the transformation mechanism 3020.

As shown in FIG. 31, for the seat cushion 3011, the seat frame (seat cushion frame) is supported on the floor of the vehicle body by a support mechanism 3014.

As shown in FIG. 32, the headrest 3013 includes pillars 3013a. The pillars 3013a are inserted into headrest guides (not shown) provided in the seat back 3012 (seat back frame).

To allow the attitude of each seat 3010 to be transformable, the seat 3010 includes an angle changer 3021 of the transformation mechanism 3020, and a seat attitude detector 3022.

The angle changer 3021 is a recliner mechanism that can be controlled by the seat controller 3002 to change the angle of the seat back 3012, and includes the actuation device 3021a that drives and turns the seat back 3012 with respect to the seat cushion 3011.

In more detail, although not shown, the lower end of the seat back frame constituting the framework of the seat back 3012 is coupled in a turnable manner via a turning shaft to the rear end of the seat cushion frame constituting the framework of the seat cushion 3011, thus achieving a configuration of allowing the seat back frame to be turned about the axis of the turning shaft by the actuator that is the actuation device 3021a.

The angle of the seat back 3012 can be changed by the angle changer 3021 from a state suitable for manual driving (raised attitude) to a flat state (a state where the seat back 3012 is completely laid flat).

Although not shown, the seat attitude detector 3022 includes a sensor that detects the angle of the seat back 3012.

The seat controller 3002 can compute and derive the attitude of each seat 3010, based on a detected signal of the sensor of the seat attitude detector 3022. That is, the seat controller 3002 can grasp the angle of the seat back 3012 through the seat attitude detector 3022.

### (Sensor Device)

As shown in FIG. 30, the sensor device 3030 includes a proximity sensor 3031, and a pressure sensor 3032, and detects the motions of the head and shoulders of the seat occupant of the seat 3010.

As shown in FIG. 32, the proximity sensor 3031 and the pressure sensor 3032 are provided at each of a position on the front surface of the headrest 3013 (surface on the X-axis positive direction side) where the head of the seat occupant is in contact, and a position on the front surface of the upper part of the seat back 3012 where the shoulders of the seat occupant is in contact.

The proximity sensor 3031 and the pressure sensor 3032 are wiredly connected to a vehicle body power source of the wheeled vehicle VB, and are supplied with power from the vehicle body power source. Note that the proximity sensor 3031 and the pressure sensor 3032 may be supplied with power by a device that provides wireless power supply.

The proximity sensor 3031 and the pressure sensor 3032 may be configured to be provided only for the headrest 3013.

The proximity sensors 3031 are sensors for detecting distances to an object positioned on the front surface of the headrest 3013 and on the front surface of the upper part of the seat back 3012.

Each proximity sensor 3031 in the present embodiment is an optical sensor that emits light, such as infrared light, to the object, and measures the distance to the object, based on a reflection time, which is a time period until the reflected light from the object returns. Note that the emitted light is not limited to the infrared light, and may be laser light or the like instead. The proximity sensor 3031 is not limited to the optical sensor, and may be, for example, an ultrasonic sensor that uses reflection of ultrasonic waves, or a radio-frequency sensor that uses reflection of radio waves, instead.

The pressure sensors 3032 are sensors for detecting pressures applied to the front surface of the headrest 3013 and the front surface of the upper part of the seat back 3012.

Each pressure sensor 3032 in the present embodiment is, for example, a capacitance sensor.

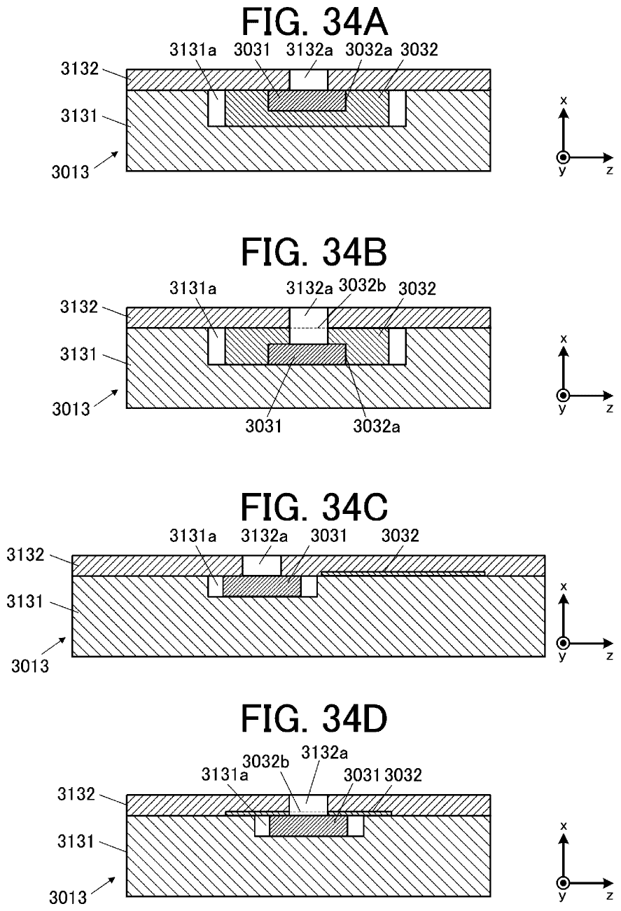

FIGS. 34A to 34D show examples of arrangement of the proximity sensor 3031 and the pressure sensor 3032 in the headrest 3013. FIGS. 34A to 34D are sectional views of the headrest 3013 taken along a plane formed by the X-axis and Z-axis. Note that the arrangement of the proximity sensor 3031 and the pressure sensor 3032 in the upper part of the seat back 3012 is similar to the example of arrangement in the headrest 3013.

As shown in FIGS. 34A to 34D, the headrest 3013 includes a pad 3131 that is a cushion material, and a covering material 3132 that covers the pad 3131.

The pad 3131 includes a concave 3131a in a surface (surface in the X-axis positive direction) in contact with the covering material 3132.

The covering material 3132 has a hole 3132a that allows light emitted from the proximity sensor 3031, and reflected light from the object to pass therethrough. Note that in the case where the proximity sensor 3031 is an ultrasonic sensor or a radio-frequency sensor, the hole 3132a is not required.

In the example shown in FIG. 34A, the proximity sensor 3031 and the pressure sensor 3032 are provided in the concave 3131a.

The pressure sensor 3032 has a concave 3032a in a surface (surface in the X-axis positive direction) in contact with the covering material 3132. The proximity sensor 3031 is provided in the concave 3032a.

In the example shown in FIG. 34B, the proximity sensor 3031 and the pressure sensor 3032 are provided in the concave 3131a.

The pressure sensor 3032 has a concave 3032a in a surface in the X-axis negative direction. The proximity sensor 3031 is provided in the concave 3032a.

The pressure sensor 3032 has a hole 3032b that allows light emitted from the proximity sensor 3031 and the reflected light from the object to pass therethrough, in the X-axis positive direction from the concave 3032a. The hole 3032b and the hole 3132a are provided to be overlaid on each other.

In the example shown in FIG. 34C, the proximity sensor 3031 is provided in the concave 3131a.

The pressure sensor 3032 has a film shape, and is provided between the pad 3131 and the covering material 3132, at a position not overlapping the proximity sensor 3031 in the Z-axis direction.

In the example shown in FIG. 34D, the proximity sensor 3031 is provided in the concave 3131a.

The pressure sensor 3032 has a film shape, and is provided between the pad 3131 and the covering material 3132, at a position overlapping the proximity sensor 3031 in the Z-axis direction.

The pressure sensor 3032 has a hole 3032b that allows light emitted from the proximity sensor 3031 and the reflected light from the object to pass therethrough, in the X-axis direction. The hole 3032b and the hole 3132a are provided to be overlaid on each other.

### (Switcher)

The switcher 3004 accepts an operation that is issued by the occupant and pertains to turning on and off transformation control for the seat 3010 by the transformation device 3002b, and outputs operation information to the seat controller 3002.

When the transformation control for the seat 3010 by the transformation device 3002b is in the ON state, the seat controller 3002 permits the transformation control for the seat 3010 by the transformation device 3002b.

In the present embodiment, the switcher 3004 includes, as an input device, a touch panel included in a car navigation device (not shown) provided in the wheeled vehicle VB. Note that the switcher 3004 may include, as an input device, a switch or the like provided for the seat 3010.

### (Notifier)

In the present embodiment, the notifier 3005 is, for example, a navigation device.

The seat controller 3002 causes the display (not shown) included in the navigation device to display a predetermined message, thus notifying the driver.

The seat controller 3002 causes the audio input and output device (not shown) of the navigation device to output a predetermined sound, thus notifying the driver.

### (Manual Operation Receiver)

The manual operation receiver 3006 is for transforming the attitude of each seat 3010 by a manual operation of the seat occupant, and specifically, includes a controller device that operates the aforementioned actuation device 3021a for actuating the transformation mechanism 3020.

The controller device includes a switch for turning on and off the actuation device 3021a, and a switch for operating the motion range of the seat 3010.

Such a controller device (manual operation receiver 3006) may be provided in a state of being viewable on the surface of the seat 3010, or on an interior member (e.g., a door trim, a pillar trim, an instrument panel, etc.) of the wheeled vehicle VB. Alternatively, the controller device may be displayed on a display of the navigation device described above, and allows the attitude of each seat 3010 to be transformed by a manual operation through a touch panel.

Note that the manual operation for each seat 3010 through the manual operation receiver 3006 is permitted when the wheeled vehicle VB is in the manual drive mode, but there is no limitation to this. Alternatively, the operation may be performed in the case of the automatic drive mode.

### (Seat Transformation Process)

Next, a seat transformation process executed by the seat controller 3002 in the seat transformation system 3100 configured as described above is described.

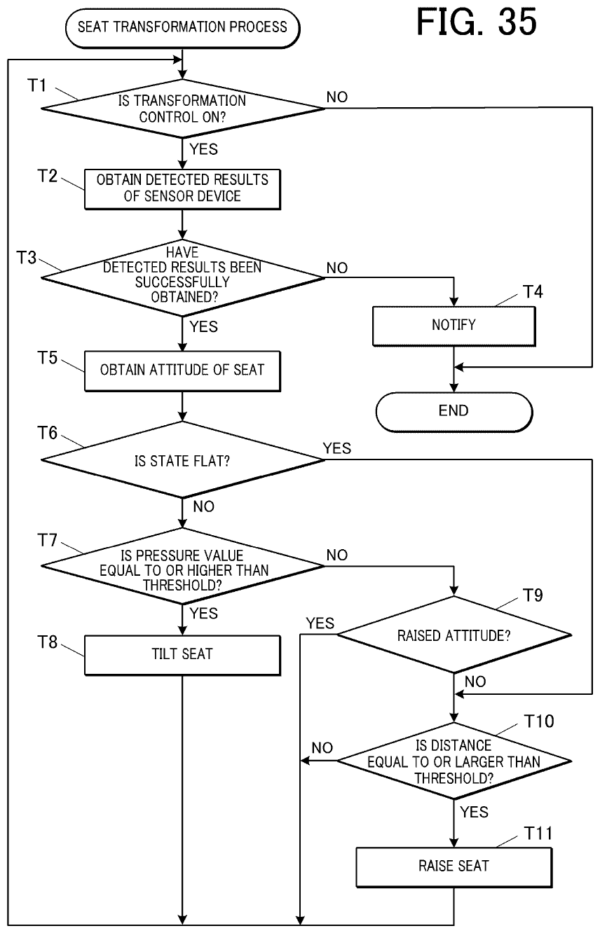

FIG. 35 shows a flowchart showing a flow of the seat transformation process.

First, when the wheeled vehicle VB is switched from the manual drive mode to the automatic drive mode, the seat controller 3002 determines whether the transformation control for the seat 3010 by the transformation device 3002b is in the ON state or not based on the operation information from the switcher 3004 (step T1).

When the transformation control for the seat 3010 by the transformation device 3002b is in the OFF state (step T1: NO), the seat controller 3002 finishes this processing.

When the transformation control for the seat 3010 by the transformation device 3002b is in the ON state (step T1: YES), the seat controller 3002 obtains detected results of the proximity sensor 3031 and the pressure sensor 3032 (step T2).

Next, the seat controller 3002 determines whether the detected results have been successfully obtained from the proximity sensor 3031 and the pressure sensor 3032 in step T2 or not (step T3).

If the detected results have not been obtained owing to failures or the like of the proximity sensor 3031 and the pressure sensor 3032 (step T3: NO), the seat controller 3002 controls the notifier 3005 to issue a notification about this (step T4), and finishes this processing.

If the detected results have been successfully obtained from the proximity sensor 3031 and the pressure sensor 3032 (step T3: YES), the seat controller 3002 obtains the attitude of the seat 3010 (the tilt angle of the seat back 3012) from the seat attitude detector 3022 (step T5).

Next, the seat controller 3002 determines whether the seat back 3012 is in the flat state or not based on the tilt angle of the seat back 3012 obtained in step T5 (step T6).

If the seat back 3012 is not in the flat state (step T6: NO), the seat controller 3002 obtains, from the storage 3003, the pressure threshold based on the tilt angle of the seat back 3012 obtained in step T5, and determines whether the pressure value, which is the detected result of the pressure sensor 3032, is equal to or higher than the pressure threshold or not (step T7).

If the seat back 3012 is tilted at a predetermined angle, i.e., the seat occupant rests the head on the headrest 3013, the larger the angle is, the higher the pressure value detected by the pressure sensor 3032 is. Consequently, the larger the tilt angle of the seat back 3012 is, the larger the pressure threshold is set. The pressure threshold has a value higher than a pressure value in a state where the head of the seat occupant seated in the seat 3010 is in contact with the headrest 3013 (the seat occupant rests the head on the headrest 3013) without their head being pressed against the headrest 3013.

If the pressure value is equal to or higher than the pressure threshold (step T7: YES), i.e., the seat occupant in the seat 3010 presses the head against the headrest 3013, the seat controller 3002 controls the angle changer 3021, tilts the seat back 3012 by a predetermined angle (step T8), and returns this processing to step T1. The predetermined angle is preset. Accordingly, the seat controller 3002 continuously tilts the seat back 3012 while the seat occupant presses the head against the headrest 3013.

If the pressure value is lower than the pressure threshold (step T7: NO), i.e., the seat occupant in the seat 3010 does not press the head against the headrest 3013, the seat controller 3002 determines whether the seat back 3012 is in the raised attitude (the state where the seat back 3012 is not tilted) or not based on the tilt angle of the seat back 3012 obtained in step T5 (step T9).

If the seat back 3012 is not in the raised attitude (step T9: NO), the seat controller 3002 obtains, from the storage 3003, the distance threshold based on the tilt angle of the seat back 3012 obtained in step T5, and determines whether the distance to the object (the head or shoulders of the seat occupant), which is the detected result of the proximity sensor 3031, is equal to or larger than the distance threshold or not (step T10).

When the seat occupant rises from the seat 3010 when the seat back 3012 is in a state of being tilted at a predetermined angle, the larger the angle is, the greater the force required to rise is. That is, the larger the angle is, the smaller the distance between the proximity sensor 3031 and the head or the shoulders of the seat occupant is when the seat occupant rises. Consequently, the larger the tilt angle of the seat back 3012 is, the smaller the distance threshold is set.

If the distance to the object is equal to or larger than the distance threshold (step T10: YES), i.e., when the seat occupant in the seat 3010 raises their head off the headrest 3013 or raises their shoulders off the seat back 3012 to rise, the seat controller 3002 controls the angle changer 3021, raises the seat back 3012 by a predetermined angle (step T11), and returns this processing to step T1. The predetermined angle is preset. Accordingly, while the seat occupant keeps the head off the headrest 3013 or keeps the shoulders off the seat back 3012, the seat controller 3002 continuously raises the seat back 3012.

If the seat back 3012 is in the flat state (step T6: YES), the seat controller 3002 causes this processing to transition to step T10.

In a case where the seat back 3012 is in the raised attitude (step T9: YES) and in a case where the distance to the object is smaller than the distance threshold (step T10: NO), the seat controller 3002 causes this processing to transition to step T1.

When the wheeled vehicle VB is switched from the automatic drive mode to the manual drive mode, the seat controller 3002 finishes this processing.

Note that in the seat transformation process described above, step T1 may be omitted, and the transformation control for the seat 3010 by the transformation device 3002b may be always performed when the wheeled vehicle VB is in the automatic drive mode.

Instead of step T8 for the seat transformation process described above, the seat controller 3002 may tilt the seat back 3012 to the flat state (step T8A).

Instead of step T11 for the seat transformation process described above, the seat controller 3002 may raise the seat back 3012 to the raised attitude (step T11A).

In the seat transformation process, it may be selectable which is executed between steps T8 and T8A, by the occupant's operation through, for example, the touch panel of the navigation device. Likewise, in the seat transformation process, it may be selectable which is executed between steps T11 and T11A, by the occupant's operation.

In a case where the angle of the seat back 3012 cannot be changed owing to a failure or the like of the angle changer 3021 in step T8 or T11 for the seat transformation process, the seat controller 3002 may control the notifier 3005 to issues a notification about this, and finish the seat transformation process.

The storage 3003 may store the distance threshold and the pressure threshold with respect to the installation position of each sensor device 3030. In this case, the thresholds (the distance threshold and the pressure threshold) to be compared with the detected results of the sensor device 3030 provided in the headrest 3013 have values different from the thresholds to be compared with the detected results of the sensor device 3030 provided in the upper part of the seat back 3012.

### Modified Example 1

Next, Modified Example 1 of the embodiment described above is described. Note that for the sake of convenience of description, portions common to those in the embodiment described above are assigned the same symbols. Description is made focusing mainly on components different from those in the embodiment described above.

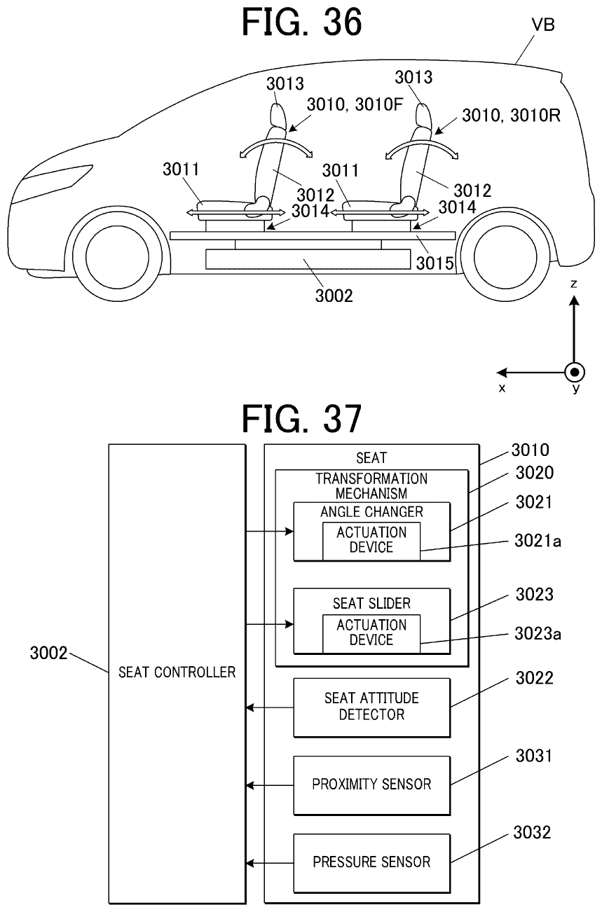

In the present modified example, as shown in FIG. 36, the wheeled vehicle VB includes long rails 3015.

The front seats 3010F and rear seat 3010R are movable in the X-axis direction along the long rails 3015.

In the present modified example, as shown in FIG. 37, the transformation mechanism 3020 of the seat 3010 further includes a seat slider 3023.

The seat slider 3023 can be controlled by the seat controller 3002 to slide the seat cushion 3011 (in turn, the entire seat 3010) in the frontward/rearward direction (X-axis direction), and is embedded in the support mechanism 3014 described above. The support mechanism 3014 includes: a mechanism, such as the long rails 3015 provided on the floor of the vehicle body, and a slider moving along the long rails 3015; and the actuation device 3023a that drives the seat cushion frame joined to the mechanism to slide. That is, the seat slider 3023 is a slide mechanism embedded in the support mechanism 3014. The slide mechanism is actuated by the actuation device 3023a.

In step T8 for the seat transformation process in the present modified example, the seat controller 3002 controls the angle changer 3021 to tilt the seat back 3012, and controls the seat slider 3023 and moves the seat 3010 in the rearward direction (X-axis negative direction). When the transformation control is applied to the attitude of the front seat 3010F, the distance of moving the front seat 3010F in the rearward direction by controlling the seat slider 3023 may be set to a distance preventing contact with the rear seat 3010R.

Accordingly, the seat occupant in the seat 3010 can stretch their legs in the state where the seat back 3012 is tilted.

In step T11 for the seat transformation process in the present modified example, the seat controller 3002 controls the angle changer 3021 to raise the seat back 3012, and controls the seat slider 3023 and moves the seat 3010 in the frontward direction (X-axis positive direction). When the transformation control is applied to the attitude of the front seat 3010F, the distance of moving the front seat 3010F in the frontward direction by controlling the seat slider 3023 may be set to a distance allowing the front seat 3010F to reach a position suitable for manual driving.

### Modified Example 2

Next, Modified Example 2 of the embodiment described above is described. Note that for the sake of convenience of description, portions common to those in the embodiment described above are assigned the same symbols. Description is made focusing mainly on components different from those in the embodiment described above.

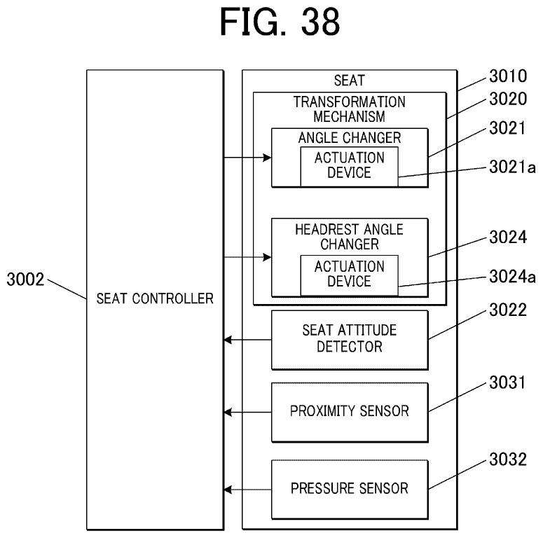

In the present modified example, as shown in FIG. 38, the transformation mechanism 3020 of the seat 3010 further includes a headrest angle changer 3024 (changer).

The headrest angle changer 3024 can be controlled by the seat controller 3002 to change the angle of the headrest 3013 with respect to the seat back 3012.

The headrest angle changer 3024 includes an actuation device 3024a that drives and turns the headrest 3013 with respect to the seat back 3012.

Note that the angle change mode of the headrest 3013 may be a pattern of changing the angle of the pillars 3013a with respect to the seat back frame, or a pattern of changing the angle of the headrest 3013 with respect to the pillars 3013a.

In step T8 for the seat transformation process in the present modified example, the seat controller 3002 controls the angle changer 3021 to tilt the seat back 3012, and controls the headrest angle changer 3024 to change the angle of the headrest 3013.

In step T11 for the seat transformation process in the present modified example, the seat controller 3002 controls the angle changer 3021 to raise the seat back 3012, and controls the headrest angle changer 3024 to change the angle of the headrest 3013.

The angle of the headrest 3013 in steps T8 and T11 is determined based on the angle of the seat back 3012, and may be an angle allowing the seat occupant in the seat 3010 to take a comfortable attitude.

### Advantageous Effects

The vehicle seat (the seat 3010 and the seat controller 3002) in the present embodiment is a vehicle seat including the headrest 3013 and the seat back 3012, further includes: the sensor device 3030 that is provided at least in the headrest 3013 and detects the motion of the head of the seat occupant in the vehicle seat; the recliner mechanism (angle changer 3021) that turns the seat back 3012 in the frontward/rearward direction (X-axis direction) of the vehicle seat; and the controller (seat controller 3002) that controls the recliner mechanism, based on the motion of the head of the seat occupant detected by the sensor device 3030.

Accordingly, based on the motion of the head of the seat occupant in the vehicle seat detected by the sensor device, the recliner mechanism can be controlled. Consequently, when the attitude of the vehicle seat is transformed, the seat can be easily transformed without operating the operation switch.

In the vehicle seat in the present embodiment, the sensor device 3030 includes the proximity sensor 3031 and the pressure sensor 3032.

Consequently, the motion of the head of the seat occupant can be detected by the proximity sensor and the pressure sensor. Accordingly, the recliner mechanism can be more appropriately controlled.

The vehicle seat in the present embodiment includes the first determiner (seat controller 3002) that determines whether the pressure value detected by the pressure sensor 3032 is equal to or higher than the predetermined pressure threshold or not. If the pressure value is determined to be equal to or higher than the pressure threshold by the first determiner, the controller controls the recliner mechanism and turns the seat back 3012 in the rearward direction of the vehicle seat.

Accordingly, when the pressure value detected by the pressure sensor is equal to or higher than the pressure threshold, the seat back can be controlled to be tilted. Consequently, only when the seat occupant presses the head against the headrest, the seat back can be controlled to be tilted.

The vehicle seat in the present embodiment includes the second determiner (seat controller 3002) that determines whether the distance detected by the proximity sensor 3031 is equal to or larger than the predetermined distance threshold or not. If the distance is determined to be equal to or larger than the distance threshold by the second determiner, the controller controls the recliner mechanism and turns the seat back 3012 in the frontward direction of the vehicle seat.

Accordingly, when the distance detected by the proximity sensor is equal to or larger than the distance threshold, the seat back can be controlled to be raised. Consequently, only when the seat occupant intends to rise, the seat back can be controlled to be raised.

The vehicle seat in the present embodiment includes the slide mechanism (seat slider 3023) that slides the vehicle seat in the frontward/rearward direction of the vehicle seat. If the pressure value is determined to be equal to or higher than the pressure threshold by the first determiner, the controller controls the slide mechanism and moves the vehicle seat in the rearward direction of the vehicle seat.

Consequently, when the seat back is tilted, the vehicle seat can be moved in the rearward direction. Accordingly, the seat occupant can stretch their legs.

In the vehicle seat in the present embodiment, it is determined by the second determiner that the distance is equal to or larger than the distance threshold, the controller controls the slide mechanism, and moves the vehicle seat in the frontward direction of the vehicle seat.

Accordingly, when the seat back is raised, the vehicle seat can be moved in the frontward direction. Consequently, the position of the vehicle seat can be placed at a position suitable for manual driving.

In the vehicle seat in the present embodiment, the headrest 3013 includes the pad 3131 that is a cushion material, and a covering material 3132 that covers the pad 3131. The sensor device 3030 is provided in the concave 3131a provided in the surface of the pad 3131 that is in contact with the covering material 3132.

Accordingly, even in a case where the proximity sensor or the pressure sensor does not have a film shape, the sensor can be accommodated in the concave. Consequently, the proximity sensor and the pressure sensor can be appropriately provided in the headrest.

In the vehicle seat in the present embodiment, the headrest 3013 includes the pad 3131 that is a cushion material, and a covering material 3132 that covers the pad 3131. The proximity sensor 3031 is provided in the concave 3131a provided in the surface of the pad 3131 that is in contact with the covering material 3132. The pressure sensor 3032 is provided between the pad 3131 and the covering material 3132.

Accordingly, even in a case where the proximity sensor does not have a film shape, the sensor can be accommodated in the concave. Consequently, the proximity sensor can be appropriately provided in the headrest. In a case where the pressure sensor has a film shape, the pressure sensor can be appropriately provided in the headrest by arranging the pressure sensor between the pad and the covering material.

In the vehicle seat in the present embodiment, the sensor device 3030 is provided in the upper part of the seat back 3012, and detects the motion of shoulders of the seat occupant. The controller controls the recliner mechanism, based on the motions of the head and the shoulders of the seat occupant detected by the sensor device 3030.

Accordingly, based on the motions of the head and shoulders of the seat occupant seated in the vehicle seat detected by the sensor device, the recliner mechanism can be controlled. Consequently, the recliner mechanism can be more appropriately controlled.

In the vehicle seat in the present embodiment, the vehicle (wheeled vehicle VB) that includes the vehicle seat can automatically drive. When the vehicle is automatically driving, the controller controls the recliner mechanism.

Consequently, the recliner mechanism is controlled only when the vehicle is automatically driving.

Consequently, the recliner mechanism can be prevented from being driven in an unintended manner when the vehicle is manually driven.

The vehicle seat in the present embodiment includes the changer (headrest angle changer 3024) that changes the angle of the headrest 3013 with respect to the seat back 3012. The controller controls the changer and changes the angle of the headrest 3013, based on the angle of the seat back 3012.

Accordingly, the angle of the headrest can be changed based on the angle of the seat back. Consequently, the angle of the headrest can be changed to that allowing the seat occupant to take a comfortable attitude.

Note that embodiments to which the present invention is applicable are not limited to the embodiments described above, and alterations can be made, as appropriate, without departing from the spirit of the present invention.

For example, in the embodiment described above, the wheeled vehicle VB is switchable between the automatic drive mode and the manual drive mode. However, there is no limitation to this. The wheeled vehicle VB may be only capable of being driven manually by the driver. In this case, the seat controller 3002 may execute the seat transformation process during manual driving of the wheeled vehicle VB.

The sensor device 3030 may be provided in the seat 3010 at any of locations other than the headrest 3013 and the upper part of the seat back 3012.

(5) Embodiment about vehicle interior device (2)

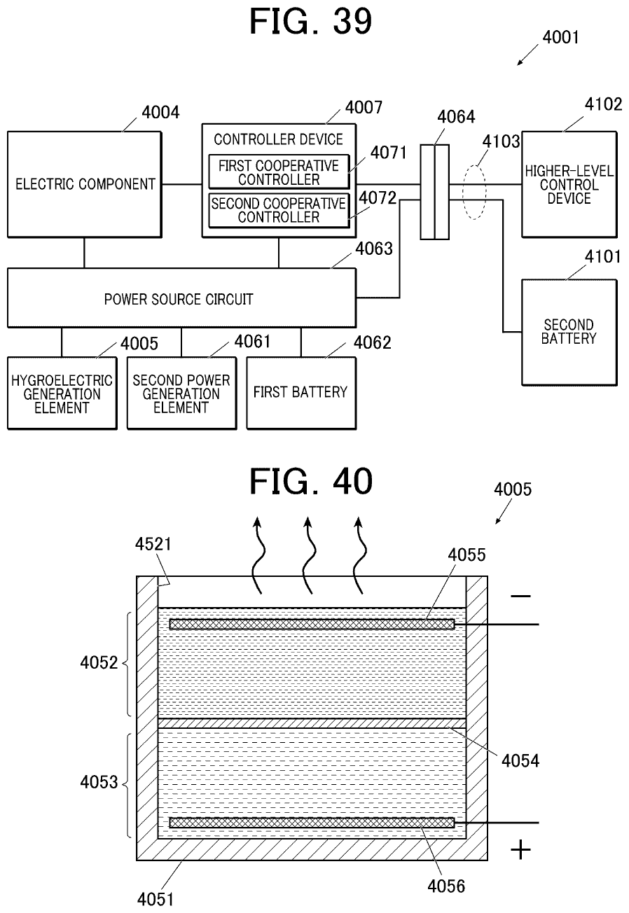

Referring to FIGS. 39 to 45, Embodiment (2) about the vehicle interior device is described.

The present embodiment pertains to the vehicle interior device. There is industrial applicability to this.

### Background Art of Present Embodiment

JP 2017-50958A proposes a power generation device that includes thermoelectric conversion elements constituting Peltier elements woven into coverings of seats of a vehicle, and generates power using the temperature difference.

### Object of Present Embodiment

Unfortunately, the conventional art described above has the structure where the thermoelectric conversion elements are woven into the coverings of the seats of the vehicle. Accordingly, there is a problem that application locations in the vehicle are limited, and the versatility is low.

The conventional art described above has the structure where the thermoelectric conversion elements are woven into the coverings of the seats of the vehicle. Accordingly, there is a problem of increasing the manufacturing cost.

The present embodiment has been achieved in view of the situations described above, and is to improve the versatility of the vehicle interior device.

### Solution to Problem

To solve the problem described above, an invention as recited in Solution 1 is a vehicle interior device, including:
a pad of a seat that has a seating surface where an occupant is seated;
a fan that blows or takes in air through a circulation path formed in the pad; and
a hygroelectric generation element that generates power through humidity variation,
wherein the hygroelectric generation element is provided on the circulation path.

An invention as recited in Solution 2 is the vehicle interior device according to Solution 1,
wherein the circulation path includes a groove formed in a back surface of the pad, and a back surface material that covers the groove, and
the hygroelectric generation element is provided in the groove.

An invention as recited in Solution 3 is the vehicle interior device according to Solution 2,
wherein the back surface material is made of felt.

An invention as recited in Solution 4 is the vehicle interior device according to Solution 2 or 3,
wherein the back surface material has an opening that allows the circulation path to communicate with the fan.

An invention as recited in Solution 5 is the vehicle interior device according to any one of Solutions 2 to 4,
wherein the back surface material has an insertion hole through which wiring of the hygroelectric generation element passes.

An invention as recited in Solution 6 is the vehicle interior device according to Solution 5,
wherein the insertion hole in the back surface material is provided with a seal material with which a gap with the wiring is filled.

An invention as recited in Solution 7 is the vehicle interior device according to Solution 5 or 6,
wherein the hygroelectric generation element is provided at a position overlapping the insertion hole in the back surface material.

An invention as recited in Solution 8 is the vehicle interior device according to any one of Solutions 2 to 7, further including
a support spring arranged on the back surface material on a reverse side of the pad,
wherein the support spring supports the hygroelectric generation element via the back surface material.

An invention as recited in Solution 9 is the vehicle interior device according to any one of Solutions 1 to 8,
wherein the circulation path communicates with a vent hole formed in the seating surface of the pad.

An invention as recited in Solution 10 is the vehicle interior device according to Solution 9,
wherein the circulation path has a branching structure that communicates with a plurality of the vent holes formed in the seating surface of the pad.

An invention as recited in Solution 11 is the vehicle interior device according to Solution 10,
wherein the circulation path includes a plurality of branches that communicate with the respective vent holes, and a collector at which the branches are collected, and
the hygroelectric generation element is arranged at the collector.

### Advantageous Effects of Solutions

According to the invention as recited in Solution 1, the hygroelectric generation element is provided on the circulation path. Consequently, unlike the conventional art, the process of preliminarily weaving the element into the covering of the seat is not required. The element can be installed only assuming that a space where the element is arranged is present. The vehicle interior device that has high arrangement flexibility and high versatility can be provided.

Since the process of preliminarily weaving the hygroelectric generation element into the covering is not required, reduction in manufacturing cost can be easily facilitated.

According to the invention as recited in Solution 2, the circulation path includes the groove formed in the back surface of the pad, and the back surface material, and the hygroelectric generation element is arranged in the groove. Consequently, the difference in touch when seated on the pad between the installation location of the hygroelectric generation element and other locations hardly occurs, and favorable seating comfort can be maintained.

According to the invention as recited in Solution 3, the back surface material is made of felt. Consequently, predetermined forming can be easily made, the hygroelectric generation element can be freely arranged, and the improvement in versatility can be further facilitated.

According to the invention as recited in Solution 4, the back surface material has the opening that allows the circulation path to communicate with the fan. Consequently, a flow due to the fan can be caused in the circulation path, and air having a humidity can be efficiently supplied to the hygroelectric generation element.

According to the invention as recited in Solution 5, the back surface material has the insertion hole through which the wiring of the hygroelectric generation element passes. Consequently, connection from the hygroelectric generation element to an electric component or the like out of the circulation path can be established, and the improvement in versatility can be further facilitated.

According to the invention as recited in Solution 6, the insertion hole of the back surface material is provided with the seal material with which the gap with the wiring is filled. Consequently, leaking through the gap can be prevented, the circulation of air in the circulation path can be highly maintained, and air having a humidity can be more efficiently supplied to the hygroelectric generation element.

According to the invention as recited in Solution 7, the hygroelectric generation element is provided at a position overlapping the insertion hole in the back surface material. Consequently, reduction in length of wiring for the hygroelectric generation element can be facilitated, and power can be efficiently supplied.

By providing the insertion hole in the back surface material, the hygroelectric generation element can be freely arranged. Accordingly, improvement in versatility can be further facilitated.

According to the invention as recited in Solution 8, the support spring supports the hygroelectric generation element via the back surface material. Consequently, deformation, misalignment, gap formation and the like due to the weight of the hygroelectric generation element can be effectively suppressed.

According to the invention as recited in Solution 9, the circulation path communicates with the vent hole formed in the seating surface of the pad. Consequently, air having a high humidity caused by the seat occupant can be efficiently supplied to the hygroelectric generation element, and increase in generated energy by the hygroelectric generation element can be achieved.

According to the invention as recited in Solution 10, the circulation path has a branching structure communicating with the vent holes formed in the seating surface of the pad. Consequently, further increase in generated energy by the hygroelectric generation element can be achieved.

According to the invention as recited in Solution 11, the hygroelectric generation element is arranged at the collector where the branches communicating with the respective vent holes are collected. Consequently, further efficient power generation and further increase in generated energy by the hygroelectric generation element can be achieved.

(Content of Embodiment (2) about Vehicle Interior Device)

Hereinafter, referring to the drawings, Embodiment (2) about the vehicle interior device is described. Although various limitations technically preferable to implement the present invention are imposed on the following embodiments, the technical scope of the present invention is not limited to the following embodiments and illustrated examples.

Embodiment (2) about the vehicle interior device described below is the vehicle interior device that is mounted on the vehicle seat, supplies power by the hygroelectric generation element generating power through humidity variation, and operates a predetermined electric component.

Vehicles provided with the vehicle seats to which the following vehicle interior devices are applied include any vehicles, such as vessels, aircraft, and wheeled vehicles, which travel with people being aboard. With the present embodiment, examples of applying the vehicle interior device 4001 to a wheeled vehicle, in particular, a wheeled vehicle seat 4010 of an automobile are described.

FIG. 39 is a block diagram showing a schematic configuration of the vehicle interior device 4001. As shown in FIG. 39, the vehicle interior device 4001 has a configuration that includes an electric component 4004 used mainly in a vehicle, a hygroelectric generation element 4005 that generates power through humidity variation, a second power generation element 4061 that generates power using energy other than that of humidity, a first battery 4062 that is charged through power generation by the hygroelectric generation element 4005 and the second power generation element 4061, a power source circuit 4063 that controls power supply to the electric component 4004, a controller device 4007 that controls each component of the vehicle interior device 4001, a harness 4103 as wiring, a connector 4064 that connects the harness 4103, and part of the wheeled vehicle seat 4010 described later.

The vehicle interior device 4001 may have a configuration that includes an external second battery 4101 (a vehicle-mounted battery of an automobile), and a higher-level control device 4102 (e.g., an ECU: electronic control unit etc., that is an overall control device of the automobile) performing main control of each component of the automobile, which are connected via the harness 4103.

Note that the vehicle interior device 4001 may have a configuration that obtains power from a plurality of hygroelectric generation elements 4005 or a configuration that supplies power to a plurality of electric components 4004, or both of them.

### (Hygroelectric Generation Element)

The hygroelectric generation element 4005 is not specifically limited only if it generates power through humidity variation. However, in view of performances of the generated current amount and the power generation efficiency, it is preferable to use a humidity variation battery that includes a combination of a deliquescent material and salinity gradient power generation, and has been developed by National Institute of Advanced Industrial Science and Technology. The humidity variation battery is described in detail in https://www.aist.go.jp/aist_j/press release/pr2021/pr20210602/pr20210602.html.

FIG. 40 is a schematic sectional view of the hygroelectric generation element 4005 made up of the humidity variation battery. As shown in the diagram, the hygroelectric generation element 4005 includes a main body container 4051 that includes an open cell 4052 open to the outside at an opening 4521, and a closed cell 4053 sealed to the outside. The open cell 4052 and the closed cell 4053 are partitioned from each other by an ion-exchange membrane 4054.

The open cell 4052 and the closed cell 4053 are filled with an electrolyte containing water and a lithium salt having deliquescence, as a deliquescent inorganic salt aqueous solution. Electrodes 4055 and 4056 are arranged respectively in the open cell 4052 and the closed cell 4053.

According to the configuration described above, when the hygroelectric generation element 4005 is exposed to a low-humidity environment, moisture is evaporated from the open cell 4052 and the concentration increases while the concentration in the closed cell 4053 is not changed because the closed cell 4053 is sealed. Accordingly, the concentration in the open cell 4052 becomes higher than that in the closed cell 4053, and ion movement occurs through the ion-exchange membrane 4054, thus causing a voltage between the electrodes 4055 and 4056.

When the hygroelectric generation element 4005 is exposed to a high-humidity environment, the aqueous solution in the open cell 4052 absorbs moisture in the air because of the deliquescence of the lithium salt, and the concentration decreases. Accordingly, the concentration in the open cell 4052 becomes lower than that in the closed cell 4053, and ion movement occurs in a direction opposite the aforementioned direction through the ion-exchange membrane 4054, thus causing an opposite polarity voltage.

The state of occurrence of the voltage due to ambient humidity variation continues for a certain time period. Accordingly, by arranging the hygroelectric generation element 4005 in an environment other than that at a place where the humidity is always kept constant, preferably, in an environment where the humidity can change in a day, power can be generated both through increase in humidity and decrease in humidity.

Note that the opening 4521 of the open cell 4052 may be covered with a polymer membrane or a hollow fiber membrane that is permeable to water vapor but impermeable to liquid, in order to prevent the electrolyte from leaking.

### (Wheeled Vehicle Seat)

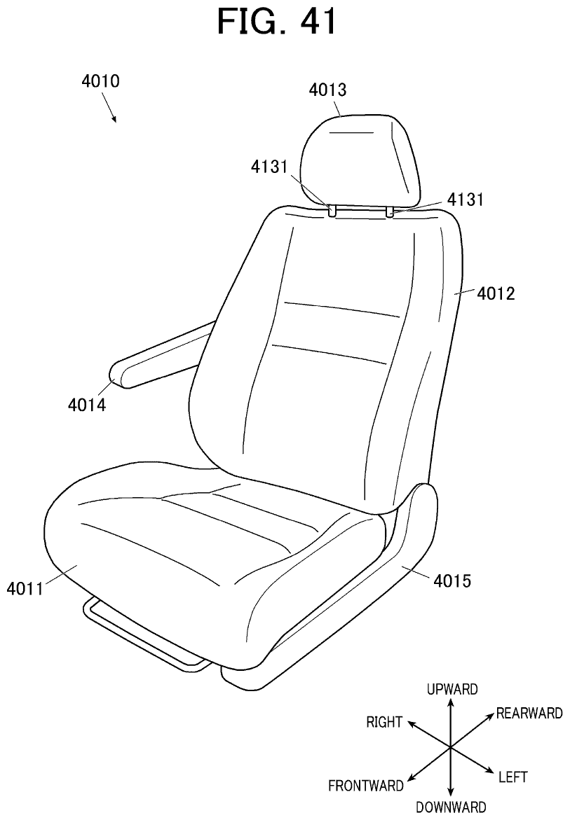

FIG. 41 is a perspective view of a wheeled vehicle seat 4010. As shown in FIG. 41, the wheeled vehicle seat 4010 includes: a seat cushion 4011 that supports the buttocks and thighs of a person; a seat back 4012 that is supported at its lower end by the seat cushion 4011, and serves as a backrest; a headrest 4013 that is provided at an upper end of the seat back 4012, and supports the head of the person; an armrest 4014 provided at a side end of the seat back 4012; and a cushion frame 4015 that supports the seat cushion 4011.

The vehicle interior device 4001 is provided at the seat cushion 4011 of the wheeled vehicle seat 4010, and is configured to include this seat cushion 4011.

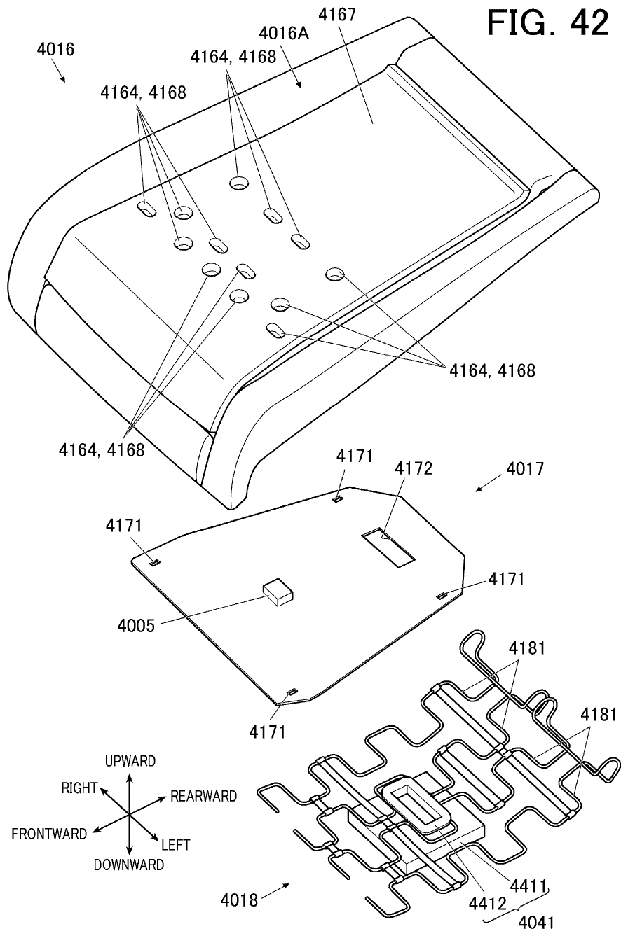

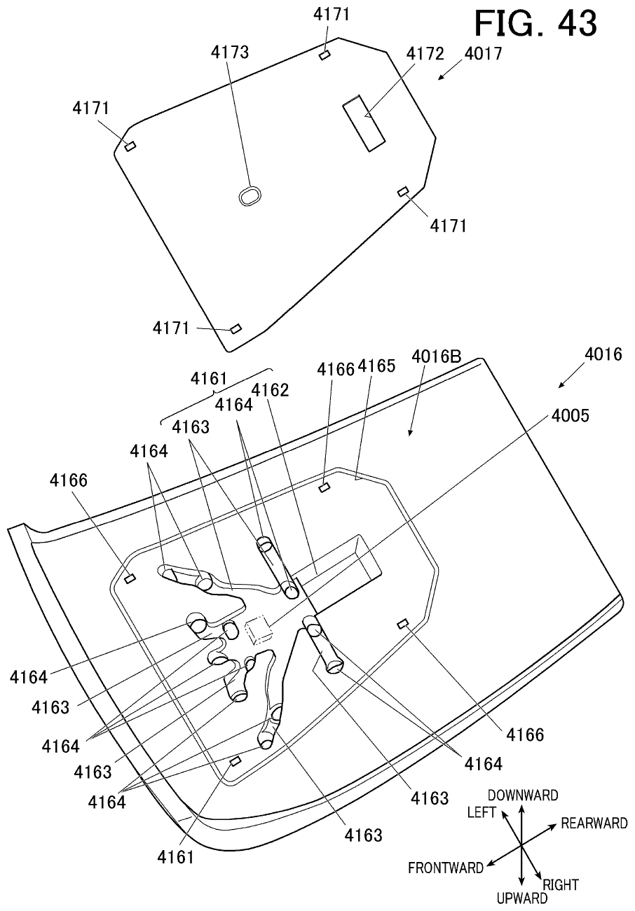

FIG. 42 is an exploded perspective view of part of the configuration of the seat cushion 4011 viewed from diagonally above. FIG. 43 is an exploded perspective view of part of the configuration of the seat cushion 4011 viewed from diagonally below.

As indicated by arrows in FIGS. 42 and 43, in the description of the vehicle interior device 4001, in a case of horizontally installing the wheeled vehicle seat 4010, a vertically upward direction is represented as “upward”, and a vertically downward direction is represented as “downward”. In a state of being seated in the wheeled vehicle seat 4010, a direction in which the front of the seat occupant is oriented is represented as “frontward”, and the opposite direction is represented as “rearward”. In a state where the seat occupant is oriented forward, the left side is represented as “left”, and the right side is represented as “right”. The upward/downward direction, the frontward/rearward direction, and the lateral direction are orthogonal to one another.

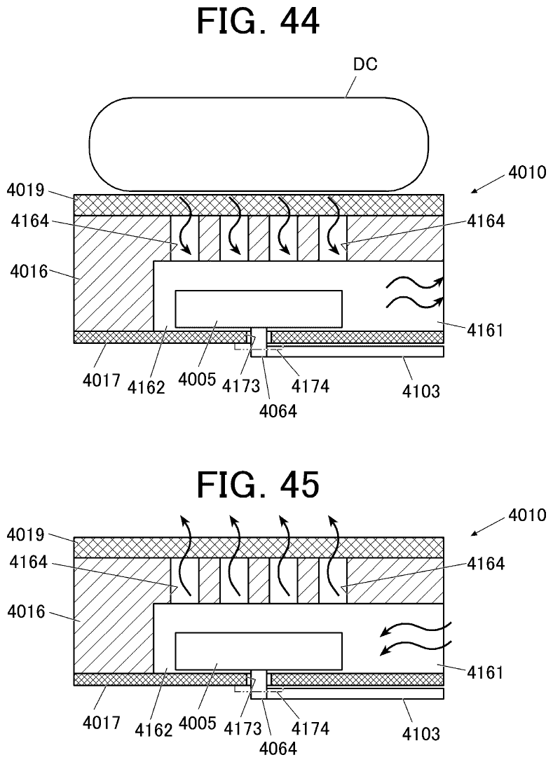

As shown in FIGS. 41 to 43, the seat cushion 4011 includes: a pad 4016 provided with a seating surface 4016A in which a seat occupant as an occupant is seated; felt 4017 that is a back surface material covering a groove 4161 formed in the back surface of the pad 4016; a support spring 4018 arranged for the felt 4017 on the side opposite to the pad 4016; and a covering 4019 that covers the pad 4016 (see FIGS. 44 and 45).

The pad 4016 keeps the shape of the seat, and functions as a cushion material. As shown in FIG. 43, the groove 4161 concave toward the seating surface 4016A of the pad 4016 is formed in the back surface 4016B (lower surface) of the pad 4016. The groove 4161 is covered with the felt 4017 from below, thus constituting a circulation path for air.

Accordingly, a concave 4165 allowing the felt 4017 to fit therein is formed in the back surface 4016B of the pad 4016. The groove 4161 is formed within a range of the concave 4165 in view from below.

Positioning protrusions 4166 for positioning the felt 4017 are provided to protrude below respectively at four corners of the concave 4165 with an arrangement away from the groove 4161.

The groove 4161 includes a collector 4162 positioned substantially at the center of the pad 4016, and branch grooves 4163 as a plurality of branches branching from the collector 4162. The branch grooves 4163 extend from the collector 4162 frontward, to the left and right, diagonally left frontward, and diagonally right frontward. All the branch grooves 4163 join together at the collector 4162. Vent holes 4164 penetrating through the seating surface 4016A of the pad 4016 are formed at a distal end and an intermediate position of each branch groove 4163.

A cover pad 4167 is mounted and equipped over a substantially entire range of the seating surface 4016A of the pad 4016 from which right and left side ends are excluded. The cover pad 4167 is a flexible plate-shape member. Through-holes 4168 are formed at several positions on the cover pad 4167 corresponding to the respective vent holes 4164 of the pad 4016, and do not prevent air from communicating through the vent holes 4164.

As shown in FIGS. 42 and 43, the felt 4017 is a plate-shape member that has a substantially trapezoidal shape in a planar view and is made of a felt material. As described above, the felt 4017 is pasted to the concave 4165 in the back surface 4016B of the pad 4016 in a fitted state.

Positioning holes 4171 are formed in a completely penetrating manner in the felt 4017 at its four corners. To fit the felt 4017 into the concave 4165, the positioning protrusions 4166 on the pad 4016 are inserted into the respective positioning holes 4171, thus allowing the felt 4017 to be appropriately positioned and pasted.

The felt 4017 pasted to the concave 4165 covers the groove 4161 entirely from below. Accordingly, the internal space of the groove 4161 is allowed to serve as a circulation path through which air flows along the collector 4162 and each branch groove 4163.

On the other hand, a rectangular opening 4172 is formed in a completely penetrating manner at a position in the felt 4017 corresponding to the rear end of the collector 4162. The opening 4172 communicates with the rear end of the collector 4162 of the groove 4161 from below the felt 4017. The opening 4172 communicates with a duct 4412 of a fan 4041 attached to the support spring 4018 described later.

An insertion hole 4173 penetrating through the opposite surfaces of the felt 4017 is formed slightly frontward from the center of the felt 4017. The insertion hole 4173 is for connecting the harness 4103 to the hygroelectric generation element 4005 arranged in the groove 4161 of the pad 4016, from the outside of the pad 4016.

The support spring 4018 is a flat-shaped spring attached to the cushion frame 4015 so as to support the felt 4017 from below.

The support spring 4018 includes four unit springs 4181 that are formed by bending elastic but hard wire to form rectangular tooth shapes, and are elongated frontward and rearward. The support spring 4018 is formed to have a planar shape by arranging the four unit springs 4181 in the left/right direction and integrally coupling them to each other.

Substantially at the center of the support spring 4018, the fan 4041, which is one of the electric components 4004, is supported in a hanging manner.

The fan 4041 includes a housing 4411 that stores blades and a motor, and is fixed to the lower surface of the support spring 4018 by, for example, hooks or the like. A rectangular duct 4412 communicating with the inside of the housing 4411 is provided at the upper part of the housing 4411. The duct 4412 extends to the upper surface side of the support spring 4018.

The duct 4412 is arranged to be overlaid with the opening 4172 of the felt 4017 in plan view, and can cause the duct 4412 and the opening 4172 to communicate with each other.

Consequently, when air is taken in or exhausted from or to the opening 4172 through the duct 4412 by driving of the fan 4041, air can be taken in or exhausted through the vent holes 4164 and the through-holes 4168 via the collector 4162 and the branch grooves 4163 of the groove 4161 from or to the outside of the pad 4016 on the upward side.

The pad 4016 is covered with the covering 4019, but the covering 4019 has a structure where at least portions facing the vent holes 4164 and the through-holes 4168 are made of an air permeable fiber material or mesh, or have a large number of pores. Accordingly, air can be favorably taken in or exhausted from or to the outside of the pad 4016 on the upward side through the vent holes 4164 and the through-holes 4168.

FIGS. 44 and 45 are sectional views showing part of the groove 4161 of the pad 4016 taken along the frontward/rearward and upward/downward directions. Note that in these FIGS. 44 and 45, illustration of the cover pad 4167 is omitted.

As shown in in the diagrams, the hygroelectric generation element 4005 described above is arranged in the collector 4162 of the groove 4161 of the pad 4016. More specifically, the hygroelectric generation element 4005 is installed at a position that is on the surface of the felt 4017 closer to the pad 4016 and corresponds to the collector 4162. The hygroelectric generation element 4005 may be installed on the felt 4017 by any of measures for fixation, such as screws or adhesion. Alternatively, a configuration may be adopted where a concave is provided in the groove 4161 of the pad 4016 so as to allow part of the external shape of the hygroelectric generation element 4005 to be fit therein, and the hygroelectric generation element 4005 fit in the concave is held by the felt 4017. Alternatively, a configuration where the hygroelectric generation element 4005 is held in a concave formed in the felt 4017 may be adopted.

In the groove 4161, the hygroelectric generation element 4005 is arranged so that any of vent holes 4164 can be positioned above the opening 4521 of the hygroelectric generation element 4005 to allow the opening 4521 to favorably exposed to air in the collector 4162.

As described above, the insertion hole 4173, through which the harness 4103 of the hygroelectric generation element 4005 is inserted, is formed in the felt 4017. The hygroelectric generation element 4005 is arranged so as to be overlaid on the insertion hole 4173 of the felt 4017 in plan view, and allow the connector 4064 provided at the bottom of the hygroelectric generation element 4005 to correspond to the insertion hole 4173. Accordingly, the harness 4103 can be wired to the outside of the pad 4016 through the insertion hole 4173 with a shortest and no-waste manner, thus negating the need of wiring with a unnecessary length.

A seal material 4174 having airtightness may be provided so as to block a gap formed between the insertion hole 4173 and the connector 4064 or the harness 4103.

### (Electric Component)

The vehicle interior device 4001 includes various devices that operate by electric power, as electric components 4004. Examples of some of the electric components 4004 include the fan 4041 provided in the seat cushion 4011 described above. In addition, what operates at low power, such as a light, switches, a display device, pressure sensors, a wireless communication device, and a heater provided in the vehicle, may be adopted as the electric components 4004, and may be supplied with power from the hygroelectric generation element 4005. These are only examples of some of the electric components 4004. Every power consuming device mountable on a vehicle can be assumed as a target.

### (First Battery)

The first battery 4062 accumulates electric power based on power generation by the hygroelectric generation elements 4005 and the second power generation element 4061, described later. Preferably, the first battery 4062 is what is reusable, such as a secondary battery or a capacitor. The secondary battery may be a nickel-cadmium storage battery, a nickel-hydrogen storage battery, a lithium-ion secondary battery, a lithium-ion polymer secondary battery, a sodium-ion battery, etc.

### (Second Power Generation Element)

The second power generation element 4061 cooperates with each hygroelectric generation element 4005, and serves as a power supply source of the vehicle interior device 4001. In a case where the hygroelectric generation elements 4005 have a sufficient power supply capability for the electric components 4004, the second power generation element 4061 is not necessarily mounted on the vehicle interior device 4001.

The second power generation element 4061 is an element that is for effectively utilizing any type of surplus energy, and belongs to what is called energy harvesting technology. For example, any of power generation elements that can generate power using light energy, such as sunlight, generate power using thermal energy using exhaust heat, generate power using vibration energy, generate power using wind power, generate power using a temperature difference and the like is used as the second power generation element 4061.

### (Power Source Circuit)

The power source circuit 4063 includes circuits and the like that have a charging function of accumulating, in the first battery 4062, electric power generated by power generation by the hygroelectric generation elements 4005 and the second power generation element 4061, a function of supplying power from the hygroelectric generation elements 4005, the second power generation element 4061, or the first battery 4062 to the electric components 4004, with the current and voltage being adjusted, and a function of supplying power from the external second battery 4101 to the electric components 4004.

Each function described above is achieved based on control by the controller device 4007.

### (Controller Device)

The controller device 4007 includes a central processing unit (CPU), a random access memory (RAM), and a read only memory (ROM), and can execute control and processes of each component of the vehicle interior device 4001.

The controller device 4007 mainly performs charging control that charges the first battery 4062 from the hygroelectric generation elements 4005 and the second power generation element 4061 through the power source circuit 4063, power supply control that supplies electric power to the electric components 4004 from the hygroelectric generation elements 4005, the second power generation element 4061, or the first battery 4062 through the power source circuit 4063, and other control.

The controller device 4007 includes a first cooperative controller 4071, and a second cooperative controller 4072, in relation to the control described above. These are functional components achieved by the controller device 4007 executing a predetermined program. Alternatively, these may be configured as hardware, such as a circuit provided along with the controller device 4007.

In principle, during power generation by the hygroelectric generation elements 4005 or the second power generation element 4061, the controller device 4007 controls the power source circuit 4063 so as to charge the first battery 4062 with the power, and supply power from the first battery 4062 to the electric components 4004.

The controller device 4007 then monitors the charged amount of the first battery 4062, and controls the power source circuit 4063 so as to directly supply power from the hygroelectric generation elements 4005 and the second power generation element 4061 to the electric components 4004 in a full-charge case or a little-amount case where the remaining battery life is a predetermined amount or less.

As described above, in the case of direct power supply from the hygroelectric generation elements 4005 and the second power generation element 4061 to the electric components 4004, the first cooperative controller 4071 performs cooperative control by the power source circuit 4063 so that the second power generation element 4061 can make up for a shortage of power supply by the hygroelectric generation elements 4005.

That is, the first cooperative controller 4071 detects, through the power source circuit 4063, the current or voltage to the electric components 4004 in a case of power supply solely by the hygroelectric generation elements 4005, and controls the power source circuit 4063 so as to supply power also from the second power generation element 4061 if the detected value is lower than a prescribed value.

As described above, the second cooperative controller 4072 performs cooperative control by the power source circuit 4063 so as to supplementarily supply shortage power from the external second battery 4101 if the remaining battery life of the first battery 4062 is a little and the power supply by the hygroelectric generation elements 4005 and the second power generation element 4061 is insufficient.

That is, the second cooperative controller 4072 detects, through the power source circuit 4063, the current or voltage to the electric components 4004 in a case of power supply by the hygroelectric generation elements 4005 and the second power generation element 4061 due to a little remaining battery life of the first battery 4062, and controls the power source circuit 4063 so as to supply power also from the second battery 4101 if the detected value is lower than a prescribed value.

### (Power Generating Operation in Hygroelectric Generation Element)

In a state where the fan 4041 is driven in the suction state, as shown in FIG. 44, when a seat occupant DC is seated on the pad 4016 of the wheeled vehicle seat 4010, air that is emitted from the human body and contains moisture enters each branch groove 4163 from each vent hole 4164 and each through-hole 4168 (not shown) through the covering 4019. The air containing moisture is collected into the collector 4162 through each branch groove 4163.

Accordingly, the air containing moisture collected in the collector 4162 enters the hygroelectric generation element 4005 through the opening 4521 of the hygroelectric generation element 4005, and the humidity in the open cell 4052 increases. Accordingly, the potential of one electrode 4055 increases, which generates power.

As shown in FIG. 45, after the seat occupant DC leaves the pad 4016 of the wheeled vehicle seat 4010, air with reduced humidity flows in through each branch groove 4163 from each vent hole 4164 and each through-hole 4168 (not shown), the humidity in the collector 4162 decreases, and the humidity in the open cell 4052 of the hygroelectric generation element 4005 also decreases. Accordingly, the potential of the other electrode 4055 increases, which generates opposite polarity power.

Note that when the seat occupant DC leaves the seat, the fan 4041 is stopped, air does not necessarily flow as indicated by arrows shown in FIG. 45 with respect to all the vent holes 4164 and through-holes 4168. At some vent holes 4164 and through-holes 4168, air can flow in the opposite directions. The arrows shown in FIG. 45 are only one example.

### Technical Effects of Embodiments of Invention

As described above, the vehicle interior device 4001 is provided with the hygroelectric generation element 4005 on the circulation path of air in the pad 4016 of the seat cushion 4011. Accordingly, unlike the conventional case where the element is preliminarily woven into the covering of the seat, the element may be installed in a space secured on the circulation path, which increases the installation flexibility, and can facilitate improvement in versatility.

Since the hygroelectric generation element 4005 is made up of a single element and the process of preliminarily weaving the hygroelectric generation element into the covering is not required, reduction in manufacturing cost can be facilitated.

Furthermore, according to the structure where the hygroelectric generation element 4005 is arranged in the groove 4161 formed in the back surface 4016B of the pad 4016, the component material of the pad 4016 intervenes from the seating surface 4016A of the pad 4016 to the hygroelectric generation element 4005. Consequently, the difference in touch in the seated situation of the wheeled vehicle seat 4010 between the installation location of the hygroelectric generation element 4005 and another location hardly occurs, and favorable seating comfort can be maintained.

In the seat cushion 4011, the back surface material provided on the back surface of the pad 4016 is made of the felt 4017. Consequently, predetermined forming can be easily made, the hygroelectric generation element 4005 can be freely arranged in the range of the groove 4161, and the improvement in versatility can be further facilitated.

The felt 4017 described above has the opening 4172 that allows the inside of the groove 4161 to communicate with the fan 4041. Consequently, an air flow due to the fan 4041 can be caused in the groove 4161, and air having a humidity can be efficiently supplied to the hygroelectric generation element 4005.

The felt 4017 has the insertion hole 4173 through which the harness 4103 of the hygroelectric generation element 4005 is inserted. Consequently, the hygroelectric generation element 4005 can be connected to other components, such as another electric component out of the groove 4161 (out of the pad 4016), the control device 4102, and the second battery 4101. Power supply to each component, another type of power supply control, other type of charging control or the like can be executed. Thus, improvement of versatility of the vehicle interior device 4001 can be further facilitated.

In the case where the seal material 4174 with which the gap with the harness 4103 is filled is provided in the insertion hole 4173 in the felt 4017, leaking through the gap can be prevented, the circulation of air in the groove 4161 can be maintained high, and air having a humidity can be more efficiently supplied to the hygroelectric generation element 4005.

The hygroelectric generation element 4005 is provided at the position overlaid on the insertion hole 4173 of the felt 4017. Accordingly, the harness 4103 is not wired in the groove 4161, the wiring path of the harness 4103 for the hygroelectric generation element 4005 can be shortened, and the harness 4103 itself can be shortened, thus allowing power to be supplied efficiently.

The insertion hole 4173 is allowed to be provided at any location on the felt 4017 to be positioned in the groove 4161. Accordingly, the hygroelectric generation element 4005 can be freely arranged. Consequently, improvement in versatility of the vehicle interior device 4001 can be further facilitated.

In the seat cushion 4011, the support spring 4018 arranged below the felt 4017 supports the hygroelectric generation element 4005 via the felt 4017. Accordingly, transformation and misalignment of the felt 4017, gap formation with the pad 4016 and the like due to the weight of the hygroelectric generation element 4005 can be effectively suppressed.

In the seat cushion 4011, the groove 4161 communicates with the vent holes 4164 formed in the seating surface 4016A of the pad 4016. Consequently, air having a high humidity caused by the seat occupant DC can be efficiently supplied to the hygroelectric generation element 4005, and increase in generated energy and efficiency by the hygroelectric generation element 4005 can be achieved.

Furthermore, the groove 4161 includes the branch grooves 4163 communicating with the vent holes 4164 formed in the seating surface 4016A of the pad 4016. Moreover, the branch grooves 4163 have the structure of being collected at the collector 4162. Accordingly, air having a high humidity caused from the seat occupant DC can be significantly efficiently supplied to the hygroelectric generation element 4005, and further increase in generated energy and efficiency by the hygroelectric generation element 4005 can be achieved.

### (Other Components)

Note that in the embodiment described above, the example of operation of taking in air from the seating surface 4016A of the pad 4016 by the fan 4041 is described. Air may be exhausted to the seating surface 4016A of the pad 4016 by the fan 4041. In this case, it is preferable that the air inlet of the fan 4041 be provided adjacent to the seat occupant DC.

In the case of exhausting air to the seating surface 4016A of the pad 4016 by the fan 4041, for example, it may be configured that a heat source or a cooling source is arranged on the air path from the collector 4162 or the fan 4041 to each vent hole 4164, and warm air or cooling air is supplied to the seat occupant from each vent hole 4164.

With the vehicle interior device 4001, the example where the felt 4017 is adopted as the back surface material of the seat cushion 4011 is described. Alternatively, a back surface material made of another material having a similar function may be adopted.

The vehicle interior device 4001 may supply power to electric components equipped outside of the vehicle cabin.

The power generation scheme of the hygroelectric generation element included in the vehicle interior device 4001 is not limited to that of the hygroelectric generation element 4005 based on the configuration in FIG. 40. Alternatively, a configuration provided with hygroelectric generation element according to another scheme capable of generating power through humidity variation may be adopted.

The second battery 4101, which is the vehicle-mounted battery, may be charged through power generation by the hygroelectric generation elements 4005 or the second power generation element 4061. In this case, the first battery 4062 may be omitted from the vehicle interior device 4001.

### (6) Embodiment about Vehicle Interior Device (3)

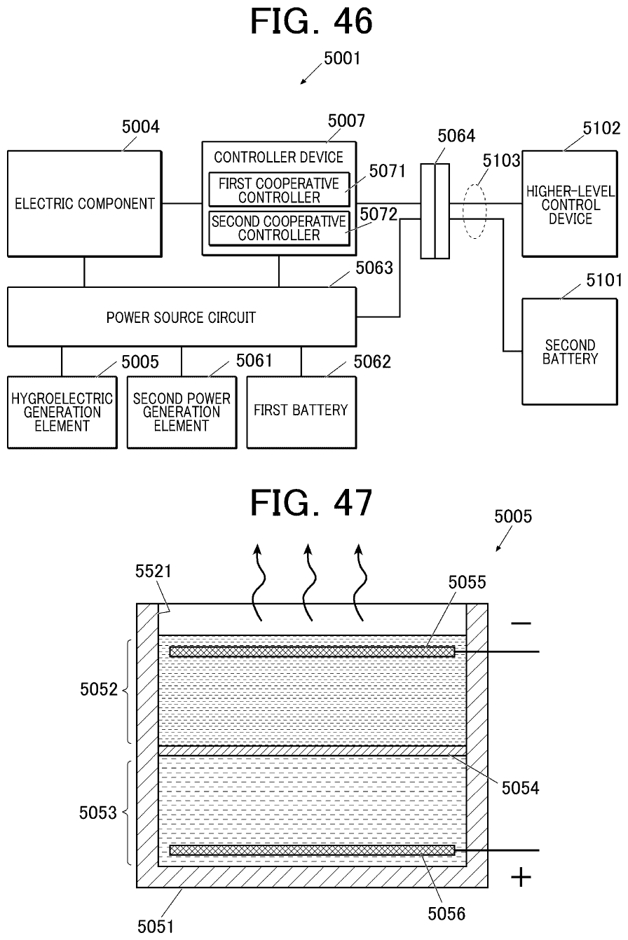

Referring to FIGS. 46 to 50, Embodiment (3) about the vehicle interior device is described.

The present embodiment pertains to the vehicle interior device. There is industrial applicability to this.

### Background Art of Present Embodiment

JP 2017-50958A proposes a power generation device that includes thermoelectric conversion elements constituting Peltier elements woven into coverings of seats of a vehicle, and generates power using the temperature difference.

### Object of Present Embodiment

Unfortunately, the conventional art described above has the structure where the thermoelectric conversion elements are woven into the coverings of the seats of the vehicle. Accordingly, there is a problem that application locations in the vehicle are limited, and the versatility is low.

The conventional art described above has the structure where the thermoelectric conversion elements are woven into the coverings of the seats of the vehicle. Accordingly, there is a problem of increasing the manufacturing cost.

The present embodiment has been achieved in view of the situations described above, and is to improve the versatility of the vehicle interior device.

### Solution to Problem

To solve the problem described above, an invention as recited in Solution 1 is a vehicle interior device, including:
a main board and a design board as vehicle interior materials arranged below a window of a vehicle; and
a hygroelectric generation element that generates power through humidity variation,
wherein the hygroelectric generation element is arranged on a back surface side of the design board.

An invention as recited in Solution 2 is the vehicle interior device according to Solution 1,
wherein the design board has an interior design surface, and an upper surface continuous thereto, and
the hygroelectric generation element is arranged on the back surface side of the design board in a range from the interior design surface to the upper surface.

An invention as recited in Solution 3 is the vehicle interior device according to Solution 1 or 2,
wherein the design board includes a support stage that supports the hygroelectric generation element.

An invention as recited in Solution 4 is the vehicle interior device according to Solution 3,
wherein the support stage of the design board has a concave.

An invention as recited in Solution 5 is the vehicle interior device according to Solution 4,
wherein a plurality of the concaves are arranged apart from each other.

An invention as recited in Solution 6 is the vehicle interior device according to any one of Solutions 1 to 5,
wherein the hygroelectric generation element is arranged between the main board and the design board.

An invention as recited in Solution 7 is the vehicle interior device according to Solution 6,
wherein the main board includes a support stage that supports the hygroelectric generation element.

An invention as recited in Solution 8 is the vehicle interior device according to Solution 7,
wherein the support stage of the main board has a concave.

An invention as recited in Solution 9 is the vehicle interior device according to Solution 1 or 2, further including
an upper board arranged, as the vehicle interior material, between the main board and the design board,
wherein the hygroelectric generation element is held between the design board and the upper board.

An invention as recited in Solution 10 is the vehicle interior device according to any one of Solutions 1 to 9,
wherein the vehicle interior material has a communication hole that allows an outside to communicate with the hygroelectric generation element.

### Advantageous Effects of Solutions

According to the invention as recited in Solution 1, the hygroelectric generation element is provided in the vehicle interior material. Consequently, unlike the conventional art, the process of preliminarily weaving the element into the covering is not required. Only if a space where the element is arranged is present, the element can be installed. The vehicle interior device that has high arrangement flexibility and high versatility can be provided.

The hygroelectric generation element is arranged on the back surface side of the design board among the vehicle interior materials including multiple boards. Accordingly, the space can be easily secured, and the arrangement flexibility can be further improved.

According to the invention as recited in Solution 2, the hygroelectric generation element is arranged on the back surface side of the design board in the range from the interior design surface to the upper surface. Consequently, the hygroelectric generation element can be installed at a location in the vehicle cabin easily touchable by the occupant, or a location easily in contact with the breath of the occupant, the hygroelectric generation element can easily obtain humidity, and highly efficient power generation can be favorably achieved.

According to the invention as recited in Solution 3, the design board includes the support stage for the hygroelectric generation element. Consequently, installation of the hygroelectric generation element can be facilitated, the need for a jig or the like for installation can be negated, the number of components can be reduced, and the hygroelectric generation element can be favorably held.

According to the invention as recited in Solution 4, the support stage of the design board has the concave. Consequently, installation of the hygroelectric generation element can be further facilitated, and the hygroelectric generation element can be more favorably held.

According to the invention as recited in Solution 5, the plurality of concaves arranged apart from each other can be provided. Consequently, the attitude and the orientation of the hygroelectric generation element can be organized, and the element can be more favorably held.

According to the invention as recited in Solution 6, the hygroelectric generation element is arranged between the main board and the design board. Consequently, the space between the main board and the design board can be effectively utilized. Consequently, an installation space for the hygroelectric generation element is not required to be separately secured, and reduction in size of the vehicle interior material can be facilitated.

According to the invention as recited in Solution 7, the main board includes the support stage that supports the hygroelectric generation element. Consequently, installation of the hygroelectric generation element can be facilitated, the need for a jig or the like for installation can be negated, the number of components can be reduced, and the hygroelectric generation element can be favorably held.

According to the invention as recited in Solution 8, the support stage of the main board has the concave. Consequently, installation of the hygroelectric generation element can be further facilitated, and the hygroelectric generation element can be more favorably held.

According to the invention as recited in Solution 9, the hygroelectric generation element is held between the design board and the upper board. Consequently, the space between the design board and the upper board can be effectively utilized. Consequently, an installation space for the hygroelectric generation element is not required to be separately secured, and reduction in size of the vehicle interior material can be facilitated.

Furthermore, the design board and the upper board hold the hygroelectric generation element so as to intervene therebetween. Consequently, installation of the hygroelectric generation element can be facilitated, the need for a jig or the like for installation can be negated, the number of components can be reduced, and the hygroelectric generation element can be favorably held.

According to the invention as recited in Solution 10, the vehicle interior material has the communication hole communicating with the hygroelectric generation element. Thus, the vehicle interior material is provided with the communication hole for guiding air having a high humidity in the vehicle cabin to the hygroelectric generation element, the air having the high humidity can be easily supplied to the hygroelectric generation element, and highly efficient power generation can be favorably achieved.

(Content of Embodiment (3) about Vehicle Interior Device)

Hereinafter, referring to the drawings, Embodiment (3) about the vehicle interior device is described. Although various limitations technically preferable to implement the present invention are applied to the following embodiments, the technical scope of the present invention is not limited to the following embodiments and illustrated examples.

The embodiment of the invention described below is the vehicle interior device that is mounted in the vehicle interior material arranged below the window of the vehicle, supplies power by the hygroelectric generation element generating power through humidity variation, and operates the predetermined electric component.

Vehicles provided with the vehicle interior material to which the following vehicle interior devices are applied include any vehicles, such as vessels, aircraft, and wheeled vehicles, which travel with people being aboard. With the present embodiment, examples of applying the vehicle interior device 5001 to a wheeled vehicle, in particular, a vehicle interior material 5010 of a door of an automobile are described.

FIG. 46 is a block diagram showing a schematic configuration of the vehicle interior device 5001. As shown in FIG. 46, the vehicle interior device 5001 has a configuration that includes an electric component 5004 used mainly in a vehicle, a hygroelectric generation element 5005 that generates power through humidity variation, a second power generation element 5061 that generates power using energy other than that of humidity, a first battery 5062 that is charged through power generation by the hygroelectric generation element 5005 and the second power generation element 5061, a power source circuit 5063 that controls power supply to the electric component 5004, a controller device 5007 that controls each component of the vehicle interior device 5001, a harness 5103 as wiring, a connector 5064 that connects the harness 5103, and part of the vehicle interior material 5010 described later.

The vehicle interior device 5001 may have a configuration that includes an external second battery 5101 (a vehicle-mounted battery of an automobile), and a higher-level control device 5102 (e.g., an ECU: electronic control unit etc., that is an overall control device of the automobile) performing main control of each component of the automobile, which are connected via the harness 5103.

Note that the vehicle interior device 5001 may have a configuration that obtains power from a plurality of hygroelectric generation elements 5005 or a configuration that supplies power to a plurality of electric components 5004, or both of them.

### (Hygroelectric Generation Element)

The hygroelectric generation element 5005 is not specifically limited only if it generates power through humidity variation. However, in view of performances of the generated current amount and the power generation efficiency, it is preferable to use a humidity variation battery that includes a combination of a deliquescent material and salinity gradient power generation, and has been developed by National Institute of Advanced Industrial Science and Technology. The humidity variation battery is described in detail in https://www.aist.go.jp/aist_j/press release/pr2021/pr20210602/pr20210602.html.

FIG. 47 is a schematic sectional view of the hygroelectric generation element 5005 made up of the humidity variation battery. As shown in the diagram, the hygroelectric generation element 5005 includes a main body container 5051 that includes an open cell 5052 open to the outside at an opening 5521, and a closed cell 5053 sealed to the outside. The open cell 5052 and the closed cell 5053 are partitioned from each other by an ion-exchange membrane 5054.

The open cell 5052 and the closed cell 5053 are filled with an electrolyte containing water and a lithium salt having deliquescence, as a deliquescent inorganic salt aqueous solution. Electrodes 5055 and 5056 are arranged respectively in the open cell 5052 and the closed cell 5053.

According to the configuration described above, when the hygroelectric generation element 5005 is exposed to a low-humidity environment, moisture is evaporated from the open cell 5052 and the concentration increases while the concentration in the closed cell 5053 is not changed because the closed cell 5053 is sealed. Accordingly, the concentration in the open cell 5052 becomes higher than that in the closed cell 5053, and ion movement occurs through the ion-exchange membrane 5054, thus causing a voltage between the electrodes 5055 and 5056.

When the hygroelectric generation element 5005 is exposed to a high-humidity environment, the aqueous solution in the open cell 5052 absorbs moisture in the air because of the deliquescence of the lithium salt, and the concentration decreases. Accordingly, the concentration in the open cell 5052 becomes lower than that in the closed cell 5053, and ion movement occurs in a direction opposite the aforementioned direction through the ion-exchange membrane 5054, thus causing an opposite polarity voltage.

The state of occurrence of the voltage due to ambient humidity variation continues for a certain time period. Accordingly, by arranging the hygroelectric generation element 5005 in an environment other than that at a place where the humidity is always kept constant, preferably, in an environment where the humidity can change in a day, power can be generated both through increase in humidity and decrease in humidity.

Note that the opening 5521 of the open cell 5052 may be covered with a polymer membrane or a hollow fiber membrane that is permeable to water vapor but impermeable to liquid, in order to prevent the electrolyte from leaking.

### (Vehicle Interior Material)

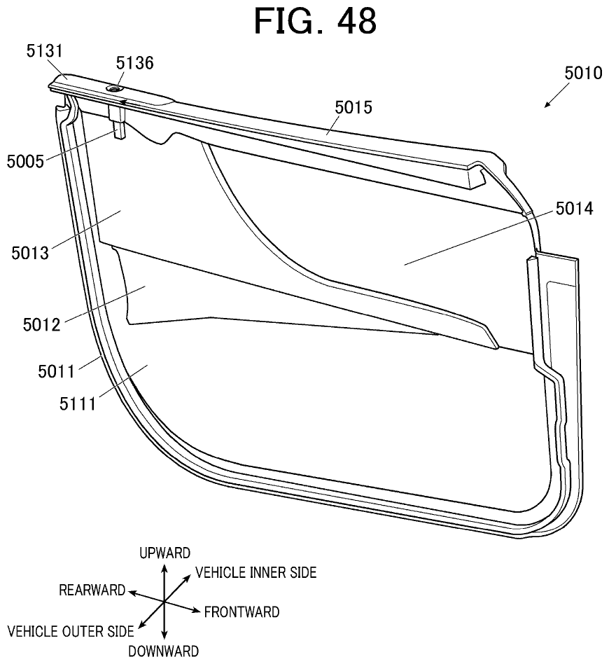

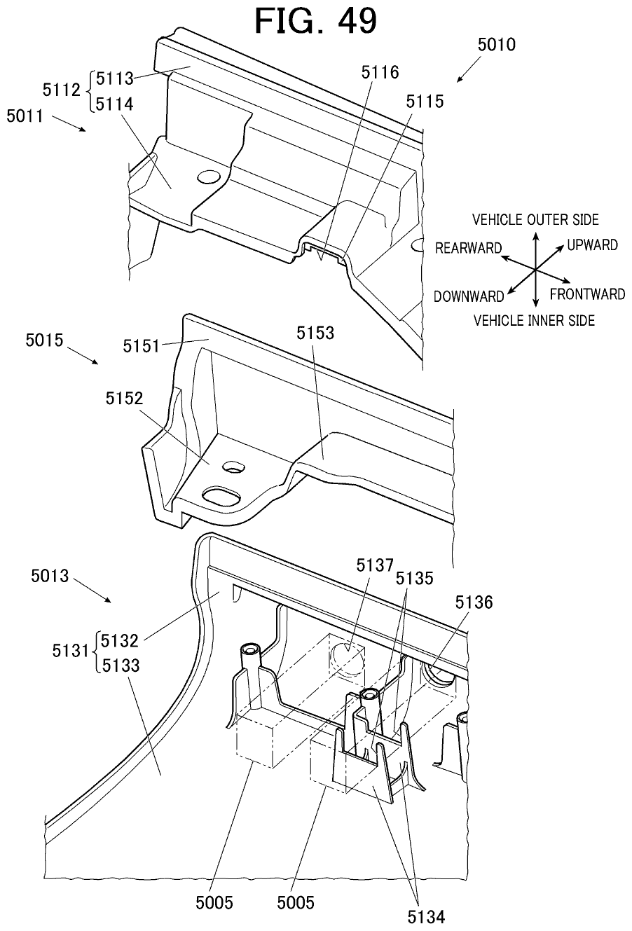

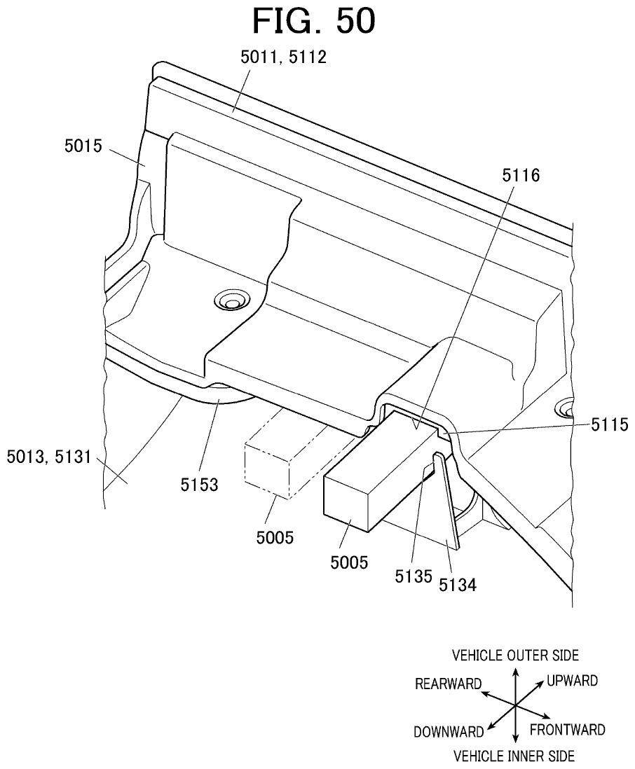

FIG. 48 is a perspective view of the vehicle interior material 5010 viewed from the outside of the vehicle cabin. FIG. 49 is an exploded perspective view of an upper rear part of the vehicle interior material 5010. FIG. 50 is a perspective view of the upper rear part of the vehicle interior material 5010 with the components shown in the exploded manner in FIG. 49 being integrally assembled. Note that as indicated by arrows in FIGS. 48 to 50, in the following description, a state where an automobile to which the vehicle interior material 5010 is attached is horizontally parked is assumed, and the vertically upward direction of the vehicle interior material 5010 is represented as “upward”, and the vertically downward direction of the vehicle interior material 5010 is represented as “downward”. The forward traveling direction of an automobile provided with the vehicle interior material 5010 is represented as “frontward”, and the opposite direction is represented as “rearward”.

Here, an example of the vehicle interior material 5010 of a side door on the right side in a state where the automobile faces frontward is described. Accordingly, in the state where the automobile faces forward, the left is represented as “vehicle inner side”, and the right is represented as “vehicle outer side”. The upward/downward direction, the frontward/rearward direction, and the vehicle cabin inside/outside direction are orthogonal to one another.

Note that in FIGS. 48 to 50, illustration of a reinforcement structure, such as ribs, applied to the surface outside of the vehicle cabin on each component of the vehicle interior material 5010 is omitted.

As described above, the vehicle interior material 5010 constitutes a vehicle inner side portion of the right side door of the automobile. As shown in FIGS. 48 to 50, the vehicle interior material 5010 is the vehicle inner side portion of the side door, and is below a side window.

The vehicle interior material 5010 includes a plurality of board members combined with each other. A main board 5011 serves as a main component. Other boards are fixed to this main board 5011, thus achieving the configuration.

As shown in FIG. 48, in the main board 5011, the vehicle inner side of a lower part 5111 functions as an interior design surface, and the upper part is configured to have a frame shape.

An armrest board 5012, a design board 5013, a middle upper board 5014, an upper board 5015 and the like are attached to the frame-shaped upper part of the main board 5011 by publicly known method, such as screws. These boards 5012 to 5015 each have an interior design surface on the vehicle inner side, and also correspond to a design board. Note that FIGS. 48 to 50 show back surfaces (surfaces on the vehicle outer side) opposite to the interior design surfaces of the boards 5012 to 5015.

As shown in FIG. 49, the main board 5011 includes an upper frame-shaped part 5112 along the frontward/rearward direction at its upper part. The upper frame-shaped part 5112 includes a substantially horizontal top plate 5113, and a side wall 5114 facing the inside of the vehicle cabin.

The upper board 5015 is attached to the main board 5011 so as to cover the upper frame-shaped part 5112 along the entire length from the upper and inner sides of the vehicle cabin. The upper board 5015 includes a substantially flat top plate 5151, and a side wall 5152 facing the inside of the vehicle cabin.

The design board 5013 is positioned adjacent to the upper edge of the lower part 5111 of the main board 5011, and includes an extended part 5131 extending upward, at rear of the design board 5013. As shown in FIG. 49, the extended part 5131 extends so as to cover the rear part of the upper board 5015 from the upper and inner sides of the vehicle cabin.

The extended part 5131 of the design board 5013 includes a substantially flat top plate 5132, and a side wall 5133 facing the inside of the vehicle cabin.

Consequently, the top plate 5151 and the side wall 5152 of the upper board 5015 respectively face the top plate 5113 and the side wall 5114 of the upper frame-shaped part 5112 of the main board 5011 from the upper and inner sides of the vehicle cabin.

Furthermore, the top plate 5132 and the side wall 5133 of the extended part 5131 of the design board 5013 respectively face the top plate 5151 and the side wall 5152 of the upper board 5015 from the upper and inner sides of the vehicle cabin.

Two support stages 5134 for supporting the hygroelectric generation element 5005 described above are aligned separately upward and downward, adjacent to the top plate 5132, on the back surface of the side wall 5133 of the extended part 5131 of the design board 5013.

Each support stage 5134 has a planar shape along the substantially horizontal direction, and is provided to protrude in the vehicle outer side direction. At the protrusion end of each support stage 5134, a rectangularly concaved concave 5135 is formed. The concaves 5135 of the support stages 5134 are formed to be overlaid in plan view.

The support stages 5134 can support the hygroelectric generation element 5005 with the vehicle inner side surface of the element being fit to the respective concaves 5135.

As described above, the side wall 5133 of the extended part 5131 of the design board 5013, and the side wall 5152 of the upper board 5015 face each other. Note that the side wall 5152 of the upper board 5015 has a shape retreated from each support stage 5134 of the extended part 5131 viewed from the outside of the vehicle cabin.

Consequently, each support stage 5134 of the side wall 5133 of the extended part 5131 faces the side wall 5114 of the upper frame-shaped part 5112 of the main board 5011.

A planar-shaped support stage 5115 raised toward the vehicle inner side is provided at a position facing the support stage 5134 of the side wall 5114 of the upper frame-shaped part 5112. Furthermore, a concave 5116 to which the vehicle outer side surface of the hygroelectric generation element 5005 can be fit is formed at the vehicle inner side end of the support stage 5115. Note that similar to the support stages 5134, a plurality of the support stages 5115 may be provided to be separated from each other.

Consequently, as shown in FIG. 50, after the upper board 5015 and the design board 5013 are attached to the main board 5011, the hygroelectric generation element 5005 is fit to the concave 5116 of the support stages 5115 of the main board 5011, and the concaves 5135 of the support stages 5134 of the design board 5013, and is supported from both the sides in the vehicle cabin inside/outside direction.

Note that a configuration may be adopted where a contact body, such as a protrusion, in contact with the lower end of the hygroelectric generation element 5005 from below is provided on the side wall 5114 of the main board 5011 or the side wall 5133 of the design board 5013, cooperates with the top plate 5132 of the design board 5013, and restrains the hygroelectric generation element 5005 also in the upward/downward direction.

Note that the side wall 5152 of the upper board 5015 does not necessarily have the shape retreated from each support stage 5134 of the extended part 5131 viewed from the outside of the vehicle cabin. Alternatively, one or more support stages similar to the support stages 5134 may be provided in the side wall 5152.

Furthermore, the top plate 5113 of the main board 5011 and the top plate 5151 of the upper board 5015 do not cover the upper end of the hygroelectric generation element 5005. A communication hole 5136 completely penetrating through upward and downward is formed in the top plate 5132 of the extended part 5131 of the design board 5013 at a position that the upper end of the hygroelectric generation element 5005 supported by the support stages 5115 and 5134 faces.

The hygroelectric generation element 5005 is supported at arrangement where the opening 5521 (see FIG. 47) faces the communication hole 5136 of the design board 5013. The communication hole 5136 communicates with the inside of the vehicle cabin. Thus, the element is supported so as to allow external air to be introduced into the opening 5521.

The arrangement of the hygroelectric generation element 5005 is not limited to the example described above.

For example, as with the hygroelectric generation element 5005 on the left side of FIGS. 49 and 50, the element may be supported in a state of being held between the upper board 5015 and the design board 5013, which are attached to the main board 5011. In this case, a holder 5153 concave toward the vehicle outer side may be provided in the side wall 5152 of the upper board 5015 so that the hygroelectric generation element 5005 can intervene between the upper board 5015 and the design board 5013 in the vehicle cabin inside/outside direction.

Preferably, in a position on the top plate 5132 of the design board 5013 that the upper end of the hygroelectric generation element 5005 intervening between the upper board 5015 and the design board 5013 faces, a communication hole 5137 that penetrates upward and downward and communicates with the inside of the vehicle cabin is formed.

### (Electric Component)

The vehicle interior device 5001 includes various devices that operate by electric power, as electric components 5004. The configuration includes the electric components 5004, which include not only the light, the switch, and the display device, but also what operates at low power, such as a pressure sensor, a wireless communication device, an air blower, and a heater. Note that these are only examples of some of the electric components 5004. Every power consuming device mountable on a vehicle can be assumed as a target.

The light includes a light source, and a drive circuit therefor. Preferably, the power source is a light emitting device, or an LED.

The switch is, for example, an input electric component that includes a touch panel type display. Icons of switches for performing input operations and the like for opening and closing windows, various setting of an air conditioner, slide mechanisms for seats in the automobile and the like are displayed on the display of the switch. Each icon functions as the corresponding switch through a touch operation. Note that the switch is not limited to a touch panel type display, and may be configured as a switch panel that includes a plurality of analog switches.

The display device displays various types of information. Preferably, this device operates at low power, such as a liquid crystal display.

The pressure sensor is a sensor for detecting that a person is seated in the seat, and includes a pressure-sensing element, or a microswitch. For example, this sensor is arranged in the seat cushion frame or therebelow.

The wireless communication device is a device for wirelessly communicating with an external control device, such as the higher-level control device 5102. For example, the wireless communication device is provided along with another electric component, transmits an output of the other electric component to the external control device, or receives, from the external control device, a control command destined for the other control device, and transmitted information, and inputs them into the other electric component.

The air blower includes a motor, a fan, and a housing. When the motor rotates the fan, the air blower can blow air taken into the housing, in a predetermined direction, thus blowing cooling air to a person.

The heater includes heating wire or a heating element that is energized and generates heat, and can heat a neighboring region of a person by generating heat. A configuration may be adopted that includes an air blower in addition to a heat source, and blows warm air in a predetermined direction.

### (First Battery)

The first battery 5062 accumulates electric power based on power generation by the hygroelectric generation elements 5005 and the second power generation element 5061, described later. Preferably, the first battery 5062 is what is reusable, such as a secondary battery or a capacitor. The secondary battery may be a nickel-cadmium storage battery, a nickel-hydrogen storage battery, a lithium-ion secondary battery, a lithium-ion polymer secondary battery, a sodium-ion battery, etc.

### (Second Power Generation Element)

The second power generation element 5061 cooperates with each hygroelectric generation element 5005, and serves as a power supply source of the vehicle interior device 5001. In a case where the hygroelectric generation elements 5005 have a sufficient power supply capability for the electric components 5004, the second power generation element 5061 is not necessarily mounted on the vehicle interior device 5001.

The second power generation element 5061 is an element that is for effectively utilizing any type of surplus energy, and belongs to what is called energy harvesting technology. For example, any of power generation elements that can generate power using light energy, such as sunlight, generate power using thermal energy using exhaust heat, generate power using vibration energy, generate power using wind power, generate power using a temperature difference and the like is used as the second power generation element 5061.

### (Power Source Circuit)

The power source circuit 5063 includes circuits and the like that have a charging function of accumulating, in the first battery 5062, electric power generated by power generation by the hygroelectric generation elements 5005 and the second power generation element 5061, a function of supplying power from the hygroelectric generation elements 5005, the second power generation element 5061, or the first battery 5062 to the electric components 5004, with the current and voltage being adjusted, and a function of supplying power from the external second battery 5101 to the electric components 5004.

Each function described above is achieved based on control by the controller device 5007.

### (Controller Device)

The controller device 5007 includes a central processing unit (CPU), a random access memory (RAM), and a read only memory (ROM), and can execute control and processes of each component of the vehicle interior device 5001.

The controller device 5007 mainly performs charging control that charges the first battery 5062 from the hygroelectric generation elements 5005 and the second power generation element 5061 through the power source circuit 5063, power supply control that supplies electric power to the electric components 5004 from the hygroelectric generation elements 5005, the second power generation element 5061, or the first battery 5062 through the power source circuit 5063, and other control.

The controller device 5007 includes a first cooperative controller 5071, and a second cooperative controller 5072, in relation to the control described above. These are functional components achieved by the controller device 5007 executing a predetermined program. Alternatively, these may be configured as hardware, such as a circuit provided along with the controller device 5007.

In principle, during power generation by the hygroelectric generation elements 5005 or the second power generation element 5061, the controller device 5007 controls the power source circuit 5063 so as to charge the first battery 5062 with the power, and supply power from the first battery 5062 to the electric components 5004.

The controller device 5007 then monitors the charged amount of the first battery 5062, and controls the power source circuit 5063 so as to directly supply power from the hygroelectric generation elements 5005 and the second power generation element 5061 to the electric components 5004 in a full-charge case or a little-amount case where the remaining battery life is a predetermined amount or less.

As described above, in the case of direct power supply from the hygroelectric generation elements 5005 and the second power generation element 5061 to the electric components 5004, the first cooperative controller 5071 performs cooperative control by the power source circuit 5063 so that the second power generation element 5061 can make up for a shortage of power supply by the hygroelectric generation elements 5005.

That is, the first cooperative controller 5071 detects, through the power source circuit 5063, the current or voltage to the electric components 5004 in a case of power supply solely by the hygroelectric generation elements 5005, and controls the power source circuit 5063 so as to supply power also from the second power generation element 5061 if the detected value is lower than a prescribed value.

As described above, the second cooperative controller 5072 performs cooperative control by the power source circuit 5063 so as to supplementarily supply shortage power from the external second battery 5101 if the remaining battery life of the first battery 5062 is a little and the power supply by the hygroelectric generation elements 5005 and the second power generation element 5061 is insufficient.

That is, the second cooperative controller 5072 detects, through the power source circuit 5063, the current or voltage to the electric components 5004 in a case of power supply by the hygroelectric generation elements 5005 and the second power generation element 5061 due to a little remaining battery life of the first battery 5062, and controls the power source circuit 5063 so as to supply power also from the second battery 5101 if the detected value is lower than a prescribed value.

### (Power Generating Operation in Hygroelectric Generation Element)

In a state where an occupant is present in the vehicle cabin, air containing moisture emitted from the human body passes through the communication hole 5136, and enters the hygroelectric generation element 5005 supported on the back surface side of the design board 5013 through the opening 5521, and the humidity in the open cell 5052 increases. Accordingly, the potential of one electrode 5055 increases, which generates power.

After the occupant leaves the vehicle cabin, air with a low humidity passes through the communication hole 5136, enters the hygroelectric generation element 5005 through the opening 5521, and the humidity of the open cell 5052 of the hygroelectric generation element 5005 decreases accordingly. Thus, the potential of the other electrode 5055 increases, which generates opposite polarity power.

### Technical Effects of Embodiments of Invention

As described above, the vehicle interior device 5001 includes the hygroelectric generation element 5005 in the vehicle interior material 5010. Accordingly, unlike the conventional art, the process of preliminarily weaving the element into the covering is not required. The hygroelectric generation element 5005 can be installed using a gap space of the vehicle interior material 5010. Consequently, the vehicle interior device that has high arrangement flexibility and high versatility can be provided. The hygroelectric generation element 5005 can be arranged substantially without specifically modifying the existing vehicle interior material 5010.

Note that with the embodiment described above, the example where the main board 5011 and the design board 5013 are provided with the support stages 5115 and 5134 is described. Alternatively, without these support stages, the hygroelectric generation element 5005 may be held in an intervening manner at a conventionally present unused space via a spacer.

In particular, in the vehicle interior device 5001, the hygroelectric generation element 5005 is arranged on the back surface side of the design board 5013 in the range from the interior design surface to the upper surface. Consequently, the hygroelectric generation element 5005 can be installed at a location in the vehicle cabin easily touchable by the occupant, or a location easily in contact with the breath of the occupant, the hygroelectric generation element 5005 can easily obtain humidity, and highly efficient power generation can be favorably achieved.

The design board 5013 of the vehicle interior material 5010 includes the support stages 5134. Accordingly, installation of the hygroelectric generation element 5005 can be facilitated, the need for a jig or the like for installation can be negated, the number of components can be reduced, and the hygroelectric generation element 5005 can be favorably held.

By providing the support stages 5115 also for the main board 5011, the installation is further facilitated, and the need of installation components is negated, and further preferable holding of the hygroelectric generation element 5005 can be achieved.

In particular, the support stages 5115 and 5134 are provided with the concaves 5116 and 5135, thus allowing the hygroelectric generation element 5005 to be held at an appropriate position.

The support stage 5134 has the two concaves 5135 arranged apart from each other. Accordingly, the attitude and the orientation of the hygroelectric generation element can be organized, and the element can be more favorably held. Note that the example where the two concaves 5135 are provided is described. Alternatively, three or more concaves 5135 may be provided. The main board 5011 may also be provided with a plurality of support stages or concaves arranged separately from each other.

In the vehicle interior device 5001, the hygroelectric generation element 5005 is arranged between the main board 5011 and the design board 5013. Consequently, the space between the main board 5011 and the design board 5013 can be effectively utilized. Accordingly, an installation space for the hygroelectric generation element 5005 is not required to be separately secured, the reduction in size of the vehicle interior material 5010 can be facilitated, the external shape is not required to be changed, and the design of the design board 5013 can be maintained high.

In the case where the hygroelectric generation element 5005 is held between the design board 5013 and the upper board 5015, the space between the design board 5013 and the upper board 5015 can be effectively utilized. Consequently, an installation space for the hygroelectric generation element 5005 is not required to be separately secured, and reduction in size of the vehicle interior material 5010 can be facilitated. Also in this case, the external shape is not required to be changed, and the design of the design board 5013 and the upper board 5015 can be maintained high.

Furthermore, the design board 5013 and the upper board 5015 hold the hygroelectric generation element 5005 so as to intervene therebetween. Consequently, installation of the hygroelectric generation element 5005 can be facilitated, the need for a jig or the like for installation can be negated, and the number of components can be reduced. The installation structure can be simplified, and production of the design board 5013 and the upper board 5015 can be facilitated.

In the vehicle interior device 5001, the vehicle interior material 5010 has the communication hole 5136 or 5137 communicating with the hygroelectric generation element 5005. Accordingly, air having a high humidity in the vehicle cabin can be guided to the hygroelectric generation element 5005, the air having the high humidity can be easily supplied to the hygroelectric generation element 5005, and highly efficient power generation can be favorably achieved. In particular, by providing the communication hole 5136 or 5137 in the upper part of the vehicle interior material 5010, air having a high humidity can be easily supplied from the location in the vehicle cabin easily touchable by the occupant, or the location easily in contact with the breath of the occupant. Accordingly, highly efficient power generation can be more favorably achieved.

### (Other Components)

In the vehicle interior material 5010 described above, besides the design board 5013, the armrest board 5012, the middle upper board 5014, the upper board 5015 and the like are attached to the main board 5011. Interior design surfaces are provided, on the vehicle inner side, for all of the armrest board 5012, the middle upper board 5014, and the upper board 5015.

Consequently, these armrest board 5012, middle upper board 5014, and upper board 5015 are components corresponding to design boards. Accordingly, the hygroelectric generation element 5005 may be arranged on the back surface side of any of these armrest board 5012, middle upper board 5014, and upper board 5015.

The example where the hygroelectric generation element 5005 is arranged on the back surface side of the upper part of the rear end of the design board 5013 is described. However, the hygroelectric generation element 5005 may be provided on any of the other boards 5011 to 5015 including the design board, as long as the installation is on the back surface side. In this case, in order to provide the communication hole communicating upward of the opening 5521 of the hygroelectric generation element 5005, it is preferable to arrange the hygroelectric generation element 5005 adjacent to a portion of the design board 5013 that has the upper surface, or the vehicle inner side surface of another board.

The example where the support stages provided for the main board 5011 and the design board 5013 have plate shapes has been described, but the support stages may have three-dimensional structures, such as block shapes. The concave provided in the support stage is not limited to a cutout shape one. Any structure allowing the hygroelectric generation element 5005 to be fit can be adopted.

As for the structure of holding the hygroelectric generation element 5005 between the design board 5013 and the upper board 5015, structures for slip resistance (a narrow groove structure, a knurling structure, etc.) may be applied or elastic bodies for slip resistance may be inserted to contact surfaces of the design board 5013 and the hygroelectric generation element 5005, and to contact surfaces of the upper board 5015 and the hygroelectric generation element 5005.

The vehicle interior device 5001 may supply power to electric components equipped outside of the vehicle cabin.

The power generation scheme of the hygroelectric generation element included in the vehicle interior device 5001 is not limited to that of the hygroelectric generation element 5005 based on the configuration in FIG. 47. Alternatively, a configuration provided with hygroelectric generation element according to another scheme capable of generating power through humidity variation may be adopted.

The second battery 5101, which is the vehicle-mounted battery, may be charged through power generation by the hygroelectric generation elements 5005 or the second power generation element 5061. In this case, the first battery 5062 may be omitted from the vehicle interior device 5001.

The vehicle interior material of the door of the automobile is described as the example of the vehicle interior material 5010. However, there is no limitation to this. For example, the hygroelectric generation element 5005 may be arranged at a side wall without any door or another vehicle inner side interior material below a window of the vehicle.

### INDUSTRIAL APPLICABILITY

The vehicle interior device according to the present invention has an industrial applicability to a vehicle interior device that is provided in the vehicle, and generates power.

### REFERENCE SIGNS LIST

1 Vehicle interior device
4 Electric component
41 Light (electric component)
42 Switch (electric component)
43 Display device (electric component)
5 Hygroelectric generation element
51 Main body container
52 Open cell
521 Opening
53 Closed cell
54 Ion-exchange membrane
55, 56 Electrode
57 Harness
7 Controller device
10 Seat
20 Door
30 Vehicle cabin
61 Second power generation element (another power generation element)
62 First battery
63 Power source circuit
101 Second battery
102 Higher-level control device
103 Harness
D Occupant

1. A vehicle seat comprising:
a headrest;
a seat back;
a sensor device provided at least on the headrest and configured to detect a motion of a head of a seat occupant of the vehicle seat;
a recliner mechanism configured to turn the seat back in a frontward-rearward direction of the vehicle seat; and
a hardware processor configured to control the recliner mechanism based on the motion of the head of the seat occupant detected by the sensor device.

2. The vehicle seat according to claim 1, wherein the sensor device includes a proximity sensor and a pressure sensor.

3. The vehicle seat according to claim 2, wherein,
the hardware processor is configured to determine whether a pressure value detected by the pressure sensor is equal to or higher than a predetermined pressure threshold, and
the hardware processor is configured to control the recliner mechanism and turns the seat back in a rearward direction of the vehicle seat in a case in which the hardware processor determines that the pressure value is equal to or higher than the predetermined pressure threshold.

4. The vehicle seat according to claim 3, wherein,
the hardware processor is configured to determine whether a distance detected by the proximity sensor is equal to or larger than a predetermined distance threshold, and
the hardware processor is configured to control the recliner mechanism and turns the seat back in a frontward direction of the vehicle seat in a case in which the hardware processor determines that the distance is equal to or larger than the predetermined distance threshold.

5. The vehicle seat according to claim 4,
further comprising a slide mechanism configured to move the vehicle seat in a frontward-rearward direction of the vehicle seat,
wherein the hardware processor is configured to control the slide mechanism and moves the vehicle seat in a rearward direction of the vehicle seat in a case in which the hardware processor determines that the pressure value is equal to or higher than the predetermined pressure threshold.

6. The vehicle seat according to claim 5, wherein the hardware processor is configured to control the slide mechanism and moves the vehicle seat in a frontward direction of the vehicle seat in a case in which the hardware processor determines that the distance is equal to or larger than the predetermined distance threshold.

7. The vehicle seat according to claim 2, wherein,
the headrest includes a pad that is a cushion material and a covering material that covers the pad, and
the sensor device is provided in a concave provided in a surface of the pad that is in contact with the covering material.

8. The vehicle seat according to claim 2, wherein,
the headrest includes a pad that is a cushion material and a covering material that covers the pad,
the proximity sensor is provided in a concave provided in a surface of the pad that is in contact with the covering material, and
the pressure sensor is provided between the pad and the covering material.

9. The vehicle seat according to claim 1, wherein,
the sensor device is provided in an upper part of the seat back and is configured to detect a motion of a shoulder of the seat occupant, and
the hardware processor is configured to control the recliner mechanism based on the motion of the head and the shoulder of the seat occupant detected by the sensor device.

10. The vehicle seat according to claim 1, wherein,
a vehicle including the vehicle seat is capable of automatic driving, and
the hardware processor is configured to control the recliner mechanism when the vehicle is performing automatic driving.

11. The vehicle seat according to claim 1,
further comprising a changer configured to change an angle of the headrest with respect to the seat back,
wherein the hardware processor is configured to control the changer and changes the angle of the headrest based on an angle of the seat back.
